(19) United States
(12) Patent Application Publication
(10) Pub. No.: US 2026/0024077 A1
(43) Pub. Date: Jan. 22, 2026

(54) Crypto Wallet Configuration Data Retrieval

(71) Applicant: Artema Labs, Inc, Los Angeles, CA (US)

(72) Inventors: Bjorn Markus Jakobsson, Portola Valley, CA (US); Sven Stefan Dufva, Stockholm (SE); Perry Raymond Cook, Jacksonville, OR (US); Keir Finlow-Bates, Eura (FI)

(73) Assignee: Artema Labs, Inc, Los Angeles, CA (US)

(21) Appl. No.: 19/222,876

(22) Filed: May 29, 2025

Related U.S. Application Data
(63) Continuation of application No. 18/155,662, filed on Jan. 17, 2023, now abandoned.
(60) Provisional application No. 63/300,202, filed on Jan. 17, 2022.
(60) Provisional application No. 63/303,569, filed on Jan. 27, 2022.
(60) Provisional application No. 63/311,283, filed on Feb. 17, 2022.
(60) Provisional application No. 63/314,132, filed on Feb. 25, 2022.
(60) Provisional application No. 63/314,424, filed on Feb. 27, 2022.
(60) Provisional application No. 63/370,768, filed on Aug. 8, 2022.

(51) Int. Cl. G06Q 20/36; G06Q 20/38; H04L 67/1097

(52) U.S. Cl. CPC G06Q 20/36; G06Q 20/3829; H04L 67/1097; G06Q 2220/10

(57) ABSTRACT

In various embodiments, a device can be configured to securely implement a wallet capable of displaying data based on a configuration file retrieved from a cloud storage using a seed. In an embodiment, the device can include a display; a network interface; memory; and a processor. The processor can be configured to: obtain a seed value; generate a path value based on the seed value; access a cloud storage location based on the path value; and receive a configuration file from the cloud storage location. The configuration file includes a configuration value. The processor further configured to display a user interface configuration based on the configuration value.

### CROSS-REFERENCE TO RELATED APPLICATIONS

The present application is a continuation of U.S. patent application Ser. No. 18/155,662 entitled “Crypto Wallet Configuration Data Retrieval”, filed Jan. 17, 2023 and published as US-2023-0230066-A1 on Jul. 20, 2023, which claims priority to U.S. Provisional Patent Application No. 63/300,202 filed Jan. 17, 2022 titled “Dependent Wallet Technology,” U.S. Provisional Patent Application No. 63/303,569 filed Jan. 27, 2022 titled “Chameleon User Interface Method,” U.S. Provisional Patent Application No. 63/311,283 filed Feb. 17, 2022 titled “Wallet User Privacy and Permissions Interface,” U.S. Provisional Patent Application No. 63/314,132 filed Feb. 25, 2022 titled “Custodial Wallet Sub-Accounts”, U.S. Provisional Patent Application No. 63/314,424 filed Feb. 27, 2022 titled “Crypto Wallet Improvement Technology,” and U.S. Provisional Patent Application No. 63/370,768 filed Aug. 8, 2022 titled “Profile-Based Wallet Selection and Use,” the disclosures of which are incorporated herein by reference in their entireties.

### FIELD OF THE INVENTION

This invention relates to cryptography. More particularly it relates to accessing content based on tokens and securely modifying access rights.

### BACKGROUND

Cryptography can be used to provide security, privacy and authenticity to transactions. Some cryptographic components, such as digital signatures and encryption functions, are standardized and well-studied with known security characteristics. Cryptography can be used to create immutable ledgers such as (but not limited to) blockchains. Immutable ledgers and blockchains can be based on a variety of cryptographic methods. In some implementations of immutable ledgers and blockchains, mining is used to securely add information. Mining can include computer systems (often referred to as “miners”) generating proofs based on computational challenges. Generally, a proof can be an output of a function that conforms to one or more requirements defined by a challenge. A proof protocol can be a function used to generate a proposed proof. The proof protocol can be iteratively performed until a proof is generated which meets the requirements of the challenge. The requirements of the challenge can be based on a difficulty. Mining can also include the use of computer systems known as “verifiers” that perform processes to check the generated proofs. In many instances, a proof can be easily verified based on providing successful inputs to a verifier. Miners and verifies can be implemented using any one or more of personal computers, application-specific integrated circuits, mobile devices (e.g. a mobile phone or tablet), server computer systems, virtual machines executing on computer systems, and/or any other form of computing device capable of performing computations associated with the performance of a particular mining or verifier function.

Various crypto wallets can generate a series of accounts, each one of these accounts corresponding to one or more different types of resources, such as a first crypto currency and a second crypto currency. However, if a user were to create a new instance of a first wallet, that new wallet instance would not have information about the state of the first wallet (e.g., that it stores ETH, BTC and SOL). Instead, a user may see only some of these resources, as the state indicating what resources exist is missing. Therefore, while the new wallet instance may in principle has access to all the resources, it does not present this to the user. The user would have to manually cause the creation of accounts for the new instance and possibly add specific tokens or cryptocurrency identifiers to see the associated account balance, where such accounts would be determined from the same seed as for the first wallet. This may cause users concerns that resources have been lost, and can be user unfriendly.

### SUMMARY OF THE INVENTION

In various embodiments, a device can be configured to securely implement a wallet capable of displaying data based on a configuration file retrieved from a cloud storage using a seed. In an embodiment, the device can include a display; a network interface; memory; and a processor. The processor can be configured to: obtain a seed value; generate a path value based on the seed value; access a cloud storage location based on the path value; and receive a configuration file from the cloud storage location. The configuration file includes a configuration value. The processor further configured to display a user interface configuration based on the configuration value.

In another embodiment, the processor is further configured to generate the configuration file and store the configuration file at the cloud storage location.

In another further embodiment, the processor is further configured to: generate a cryptographic key based on an input value; and decrypt the configuration file using the cryptographic key.

In still another embodiment, the seed value is based on a user input.

In yet another embodiment, the configuration value can include a second cryptographic key, the second cryptographic key capable of decrypting data stored at the cloud storage location.

In another embodiment again, the processor is further configured to display locally stored content indicators.

In still yet another embodiment, the processor is further configured to: generate a second path value based on the seed value and a second locally stored value; access a second cloud storage location based on the second path value; and receive an error response from the second cloud storage location. The error response indicates no configuration file is available. The cloud storage location is accessed in response to receiving the error response.

In still another further embodiment, the configuration value includes: a public key associated with an NFT; a private key associated with the NFT; content associated with the NFT; and an access control list associated with the NFT.

In still another embodiment again, the configuration value includes: a public key associated with a token; a private key associated with the token; content associated with the token; and an access control list associated with the token.

In yet another further embodiment, the configuration file further includes user generated data associated with the wallet.

In yet another embodiment again, the configuration file is encrypted.

In a further embodiment, the processor is further configured to decrypt the configuration file.

In a yet further embodiment, the decryption uses a key that is based at least in part on the seed value.

In a yet still further embodiment, the configuration file is obfuscated.

In a number of embodiments, a device can be configured to securely implement a wallet capable of establishing access rights based on a configuration file retrieved from a cloud storage using a seed. In an embodiment, the device includes: a network interface; local memory; and a processor. The processor configured to: receive a seed value; generate a first path value based on the seed value and a first locally stored value; access a first cloud storage location based on the first path value; and receive a configuration file from the first cloud storage location. The configuration file includes a configuration value. The processor further configured to establish access rights to content based on the configuration value.

In another embodiment, wherein first access rights are established for a first user input, and second access rights are established for a second user input.

In still another embodiment, wherein the first user input and the second user input are passwords.

In yet another embodiment, the processor is further configured to: generate a second path value based on the seed value and a second locally stored value; access a second cloud storage location based on the second path value; and receive an error response from the second cloud storage location, wherein the error response indicates no configuration file is available, and wherein the first cloud storage location is accessed in response to receiving the error response.

In another embodiment again, the configuration value includes: a public key associated with an NFT; a private key associated with the NFT; content associated with the NFT; and an access control list associated with the NFT.

In a further embodiment, the configuration value includes: a public key associated with a token; a private key associated with the token; content associated with the token; and an access control list associated with the token.

In a still further embodiment, the processor is further configured to generate the configuration file and store the configuration file at the first cloud storage location.

In a yet further embodiment, the configuration file further includes user generated data associated with the wallet.

In various embodiments, a device can be configured to securely implement a wallet capable of establishing access rights based on a configuration file retrieved from a cloud storage using a seed. In an embodiments, the device includes: a network interface; local memory; and a processor. The processor configured to: receive a seed value; generate a new wallet instance based on the seed value; receive a user access level input, the user access level input indicating an access level selected for the new wallet instance; access a cloud storage location based on the seed and retrieve first configuration data; receive an authentication request; and transmit an authentication response. The authentication response determined based on the user access level input. The processor further configured to receive second configuration data from the cloud storage. The second configuration data associated with an access level granted to the new wallet instance.

In another embodiment, the first configuration data includes a first configuration value, and the second configuration data includes a second configuration value.

In yet another embodiment, the second configuration value includes: a public key associated with an NFT; a private key associated with the NFT; content associated with the NFT; and an access control list associated with the NFT.

In still another embodiment, the second configuration value includes: a public key associated with a token; a private key associated with the token; content associated with the token; and an access control list associated with the token.

In another further embodiment, the first configuration data further includes user generated data associated with the wallet.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 conceptually illustrates an example wallet capable of retrieving a configuration value.

FIG. 19 conceptually illustrates an example process for displaying content indicators.

FIG. 20 conceptually illustrates an example configuration value.

FIG. 21 conceptually illustrates an example signaling diagram of an example method for transmitting configuration data from a cloud storage to a wallet instance.

FIG. 22 conceptually illustrates an example process for protecting a token transfer.

FIG. 23 conceptually illustrates an example of two wallets.

FIG. 24 conceptually illustrates an example of a wallet.

FIG. 25 conceptually illustrates an example of the recovery of lost data.

FIG. 26 conceptually illustrates an example method for wallet B to access content of wallet A.

FIG. 27 conceptually illustrates an example signaling diagram of an of a method including pairing.

FIG. 28 conceptually illustrates an example flowchart exemplifying embodiment of a method for enabling display of information to a user in accordance with a user preference with regard to a user interface and/or user experience.

FIG. 29 conceptually illustrates an example device for enabling display of information to a user in accordance with a user preference with regard to a user interface and/or user experience.

FIG. 30 conceptually illustrates an example schematic of a device with a screen for displaying a UI/UX.

FIG. 31 conceptually illustrates an example wallet visual user interface.

FIG. 32 conceptually illustrates an example wallet visual user interface for medical data.

FIG. 33 conceptually illustrates an example wallet visual user interface containing financial information.

FIG. 34 conceptually illustrates an example flowchart exemplifying a method performed by an entity, such as a wallet, for classifying a resource of the wallet, thereby assigning the resource to a partition of the wallet.

FIG. 35 conceptually illustrates an example block diagram of an entity, such as a wallet, configured for classifying a resource of the wallet, thereby assigning the resource to a partition of the wallet.

### DETAILED DESCRIPTION

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

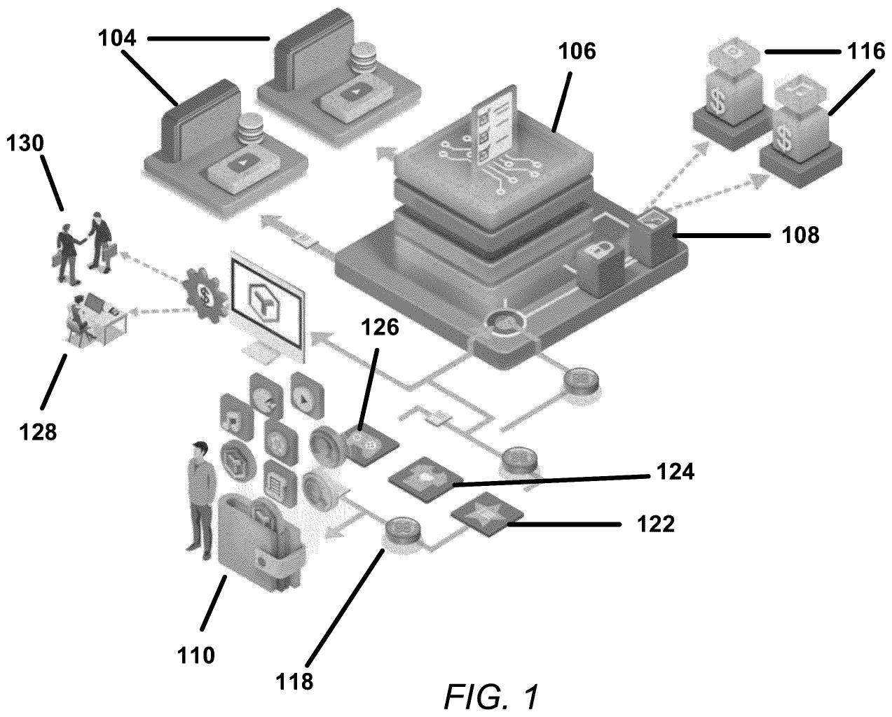

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

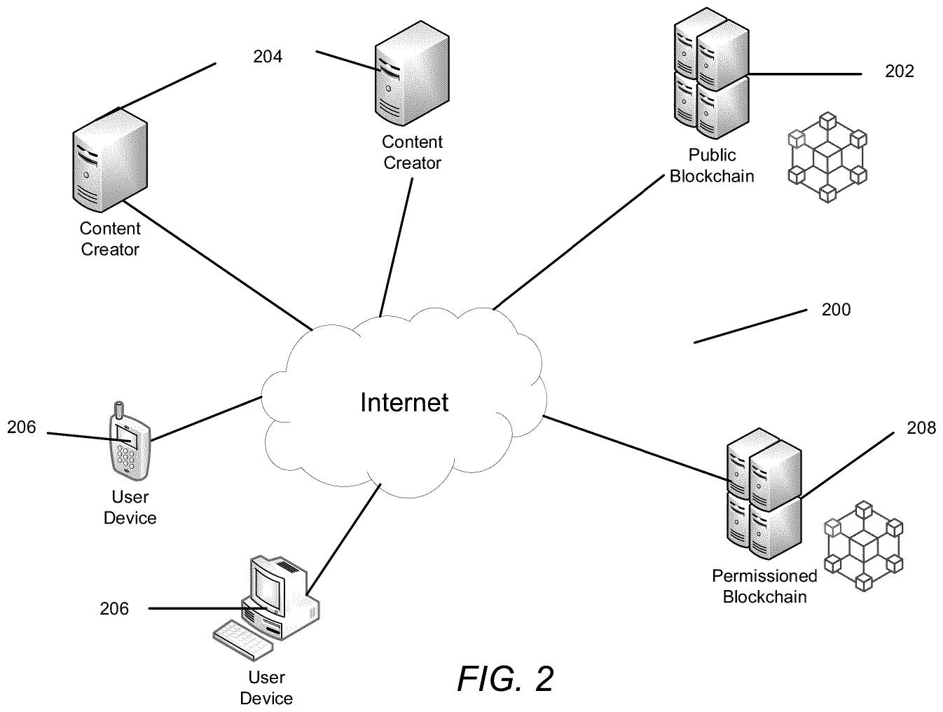

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

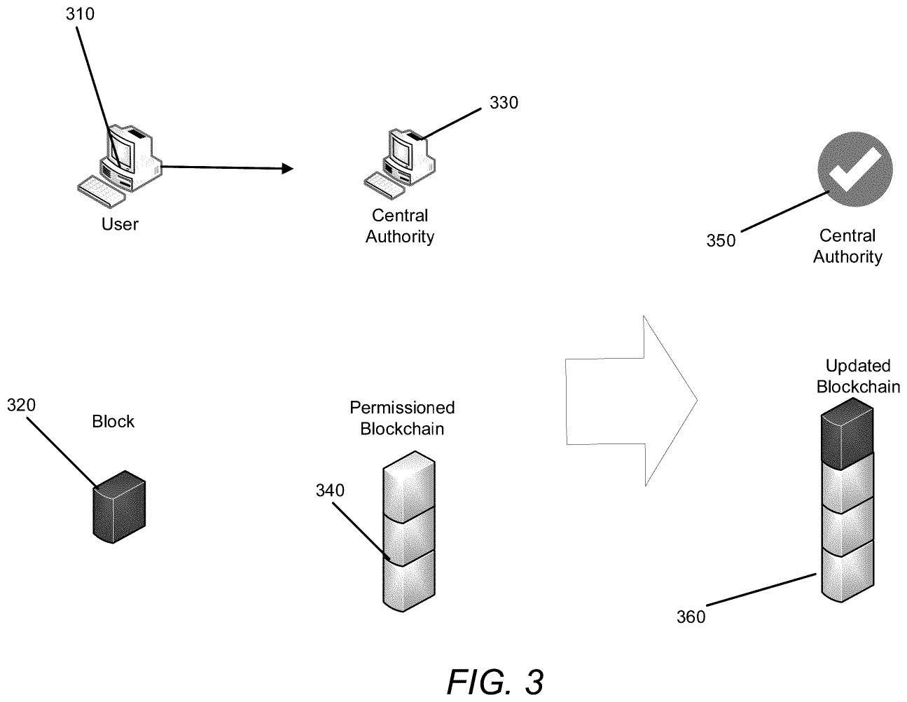

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

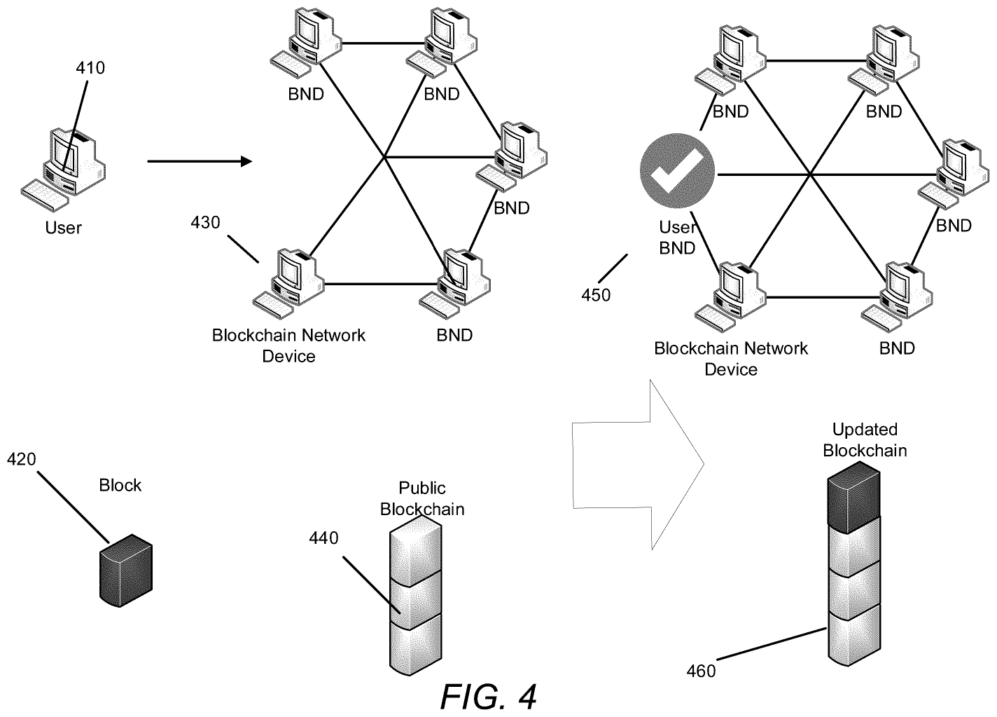

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

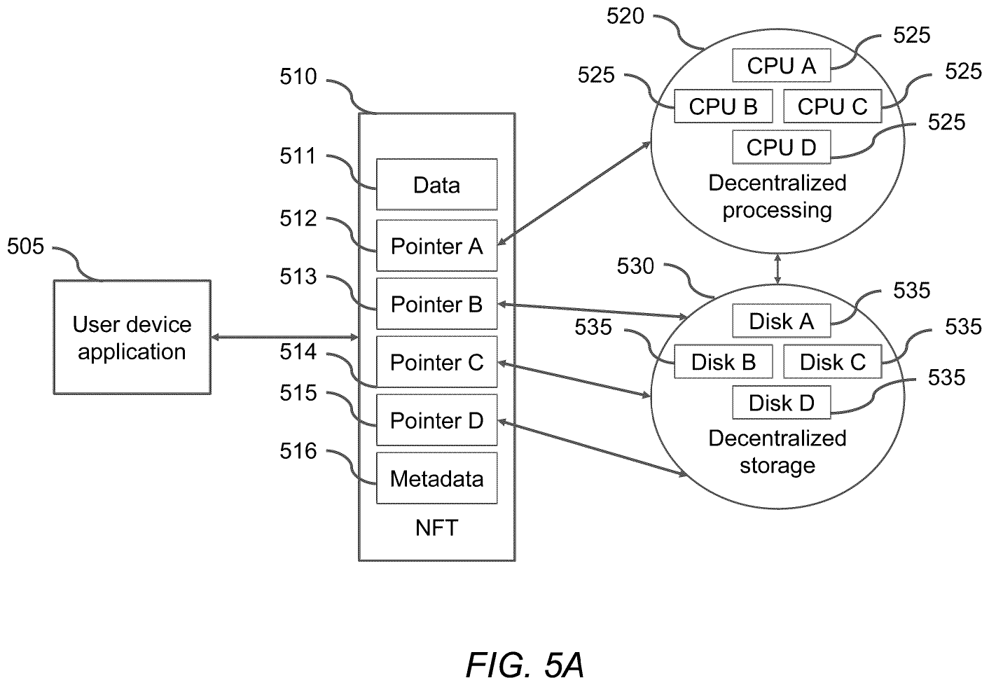

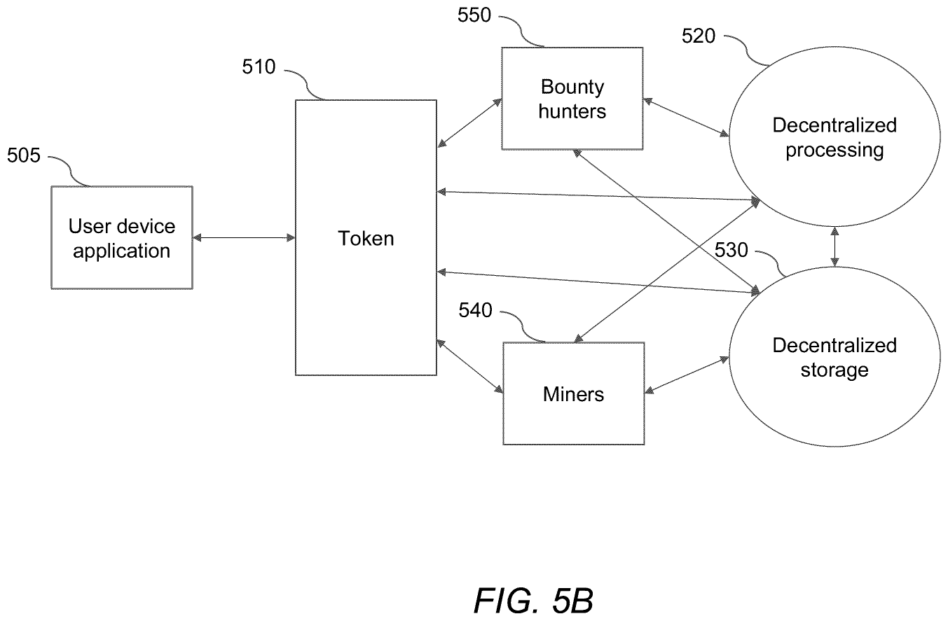

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges, In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

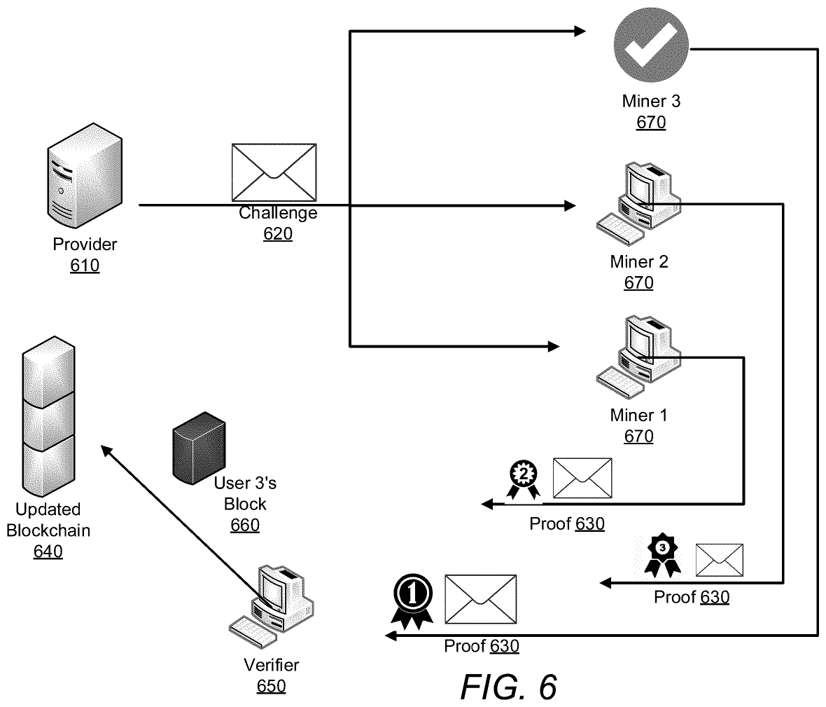

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

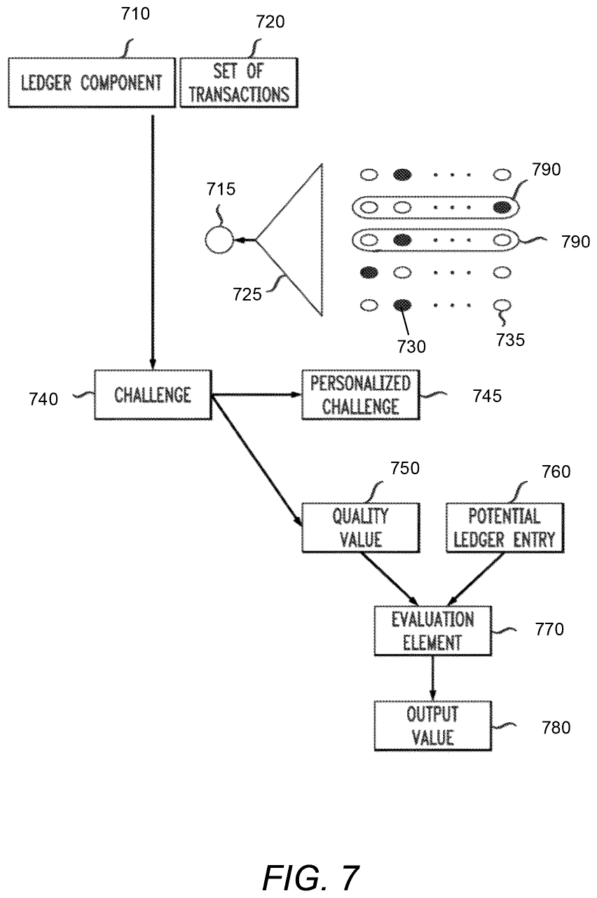

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

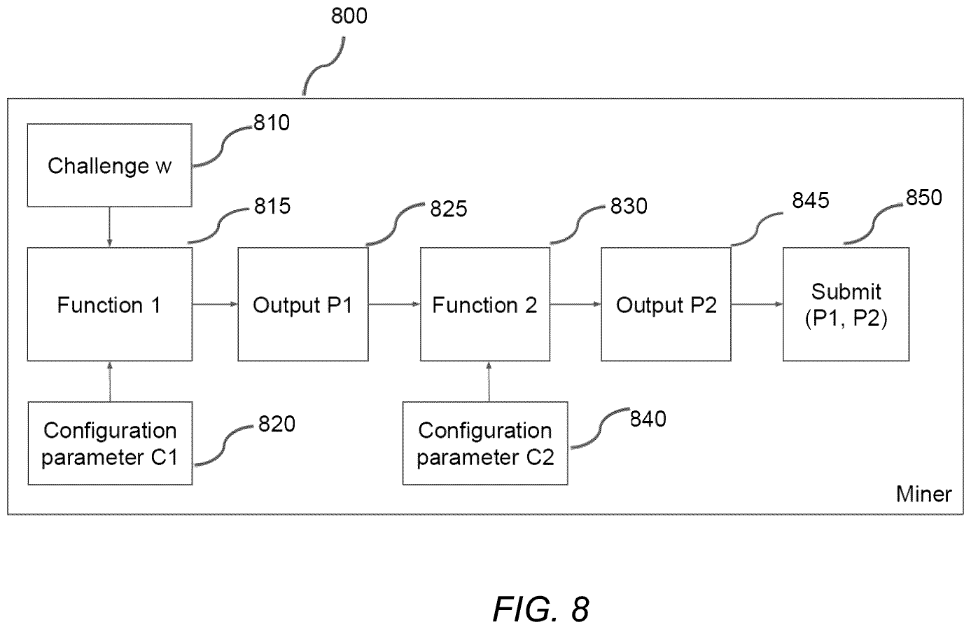

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone(™) or Intel SGX(™) may provide assurances exist of integrity by virtue of incorporating private/isolated processing environments.

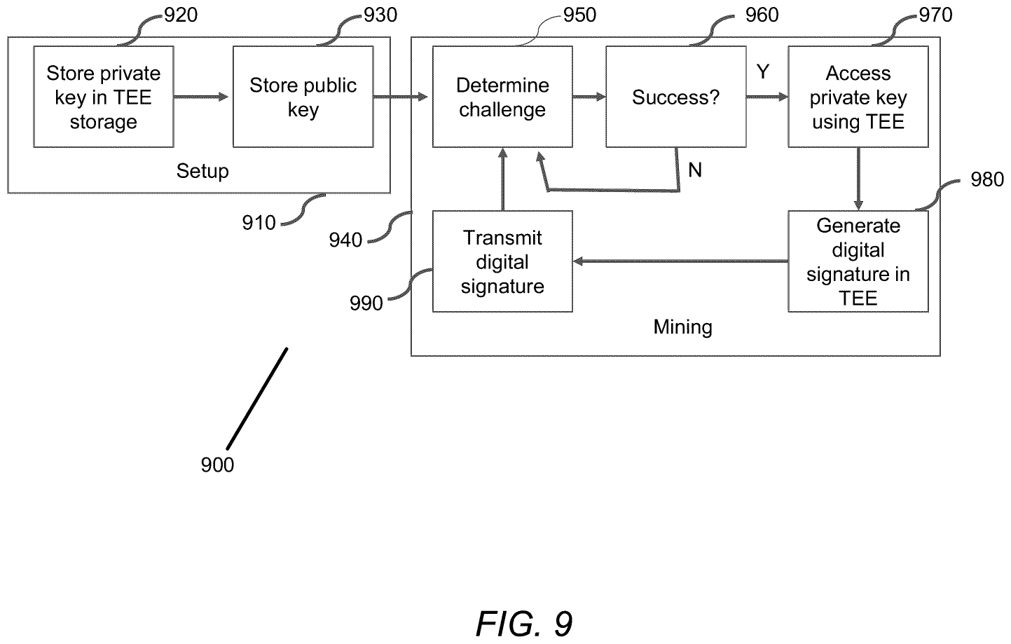

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

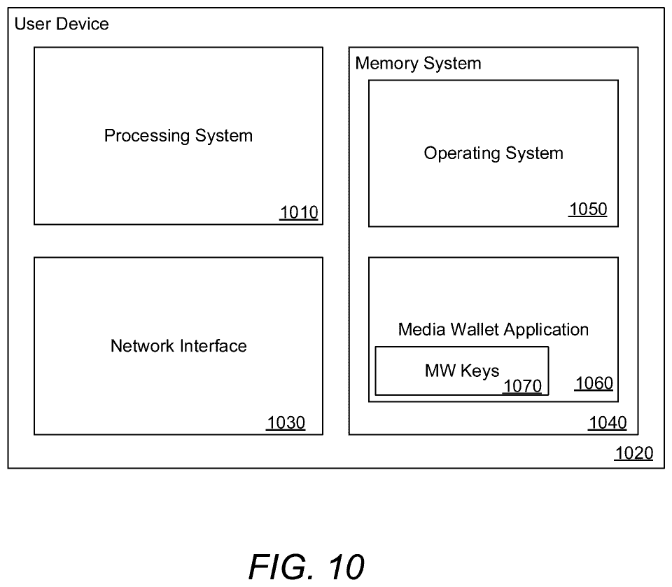

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

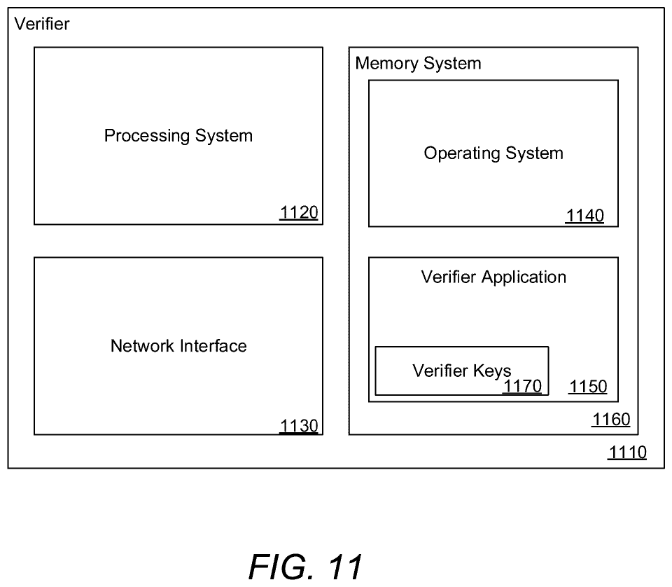

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

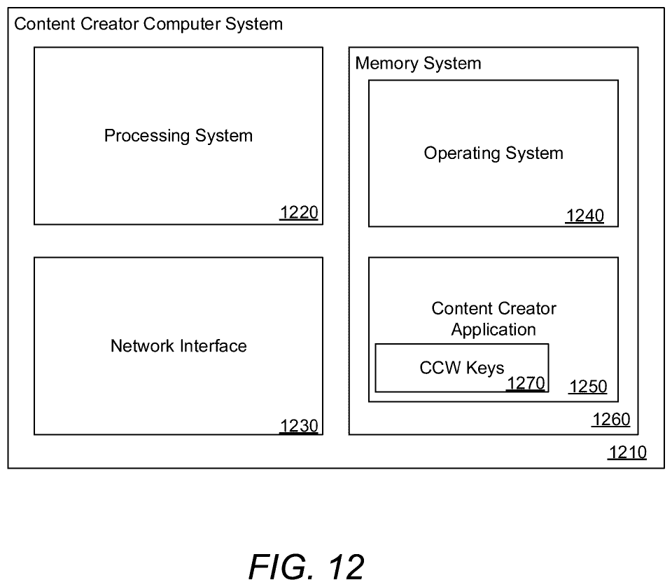

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

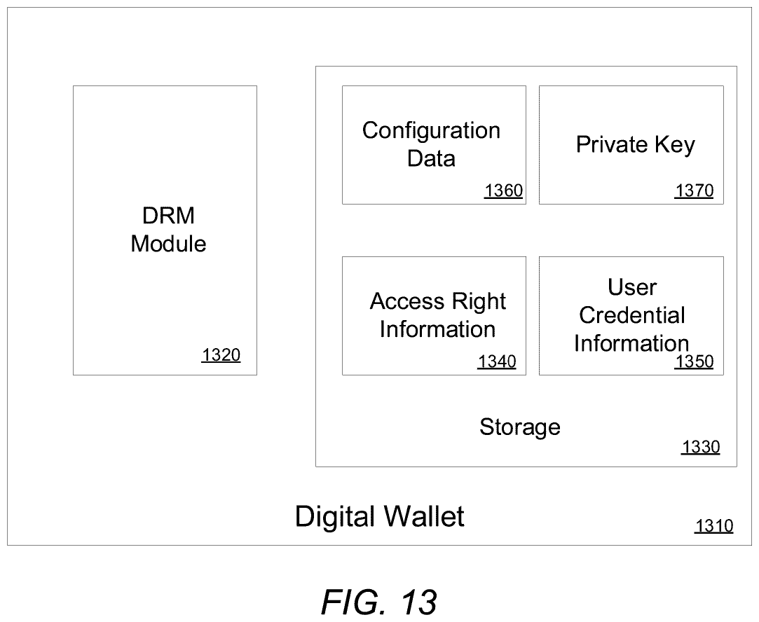

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

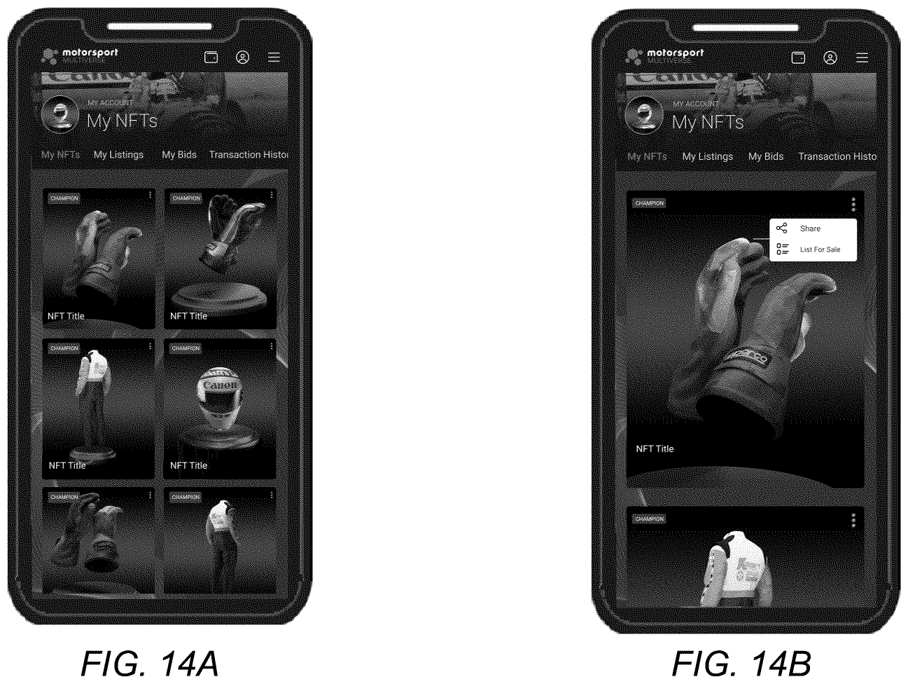

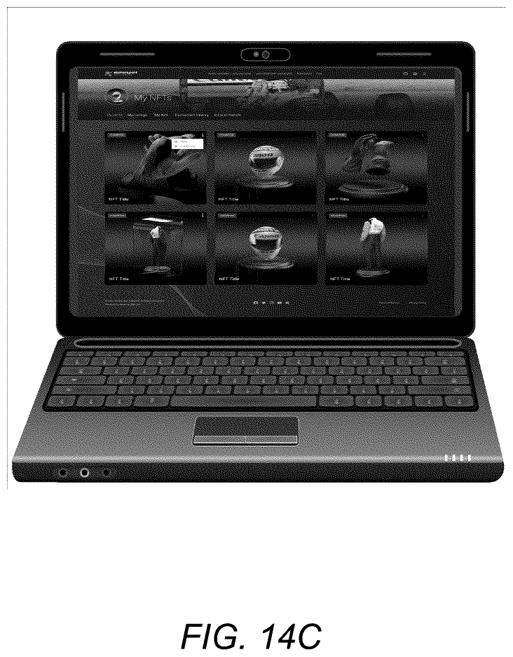

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

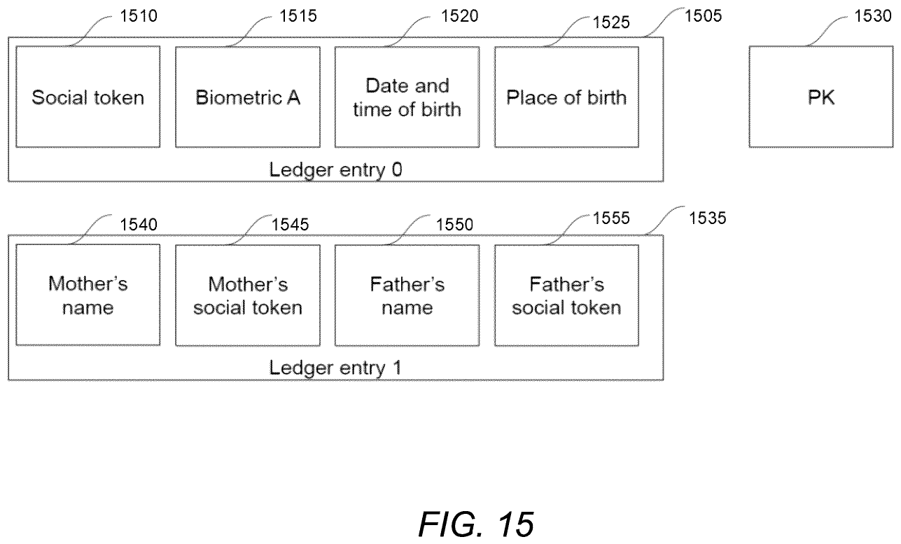

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

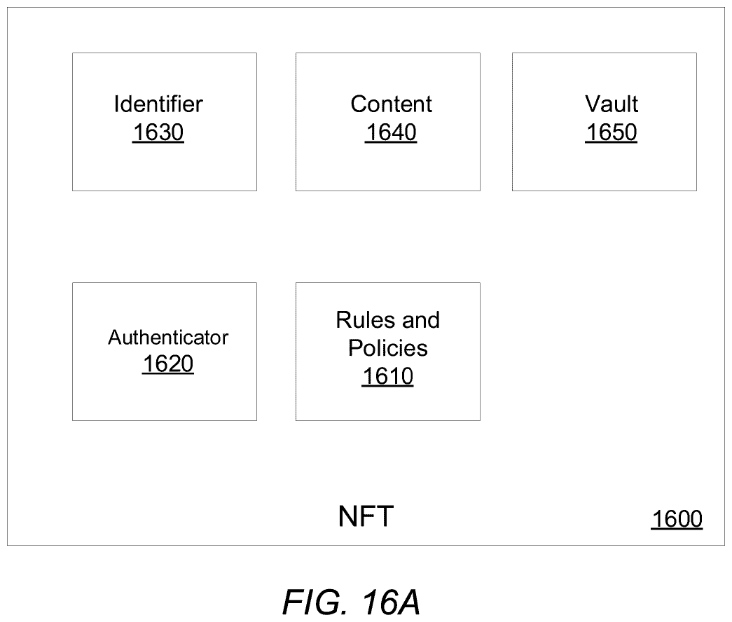

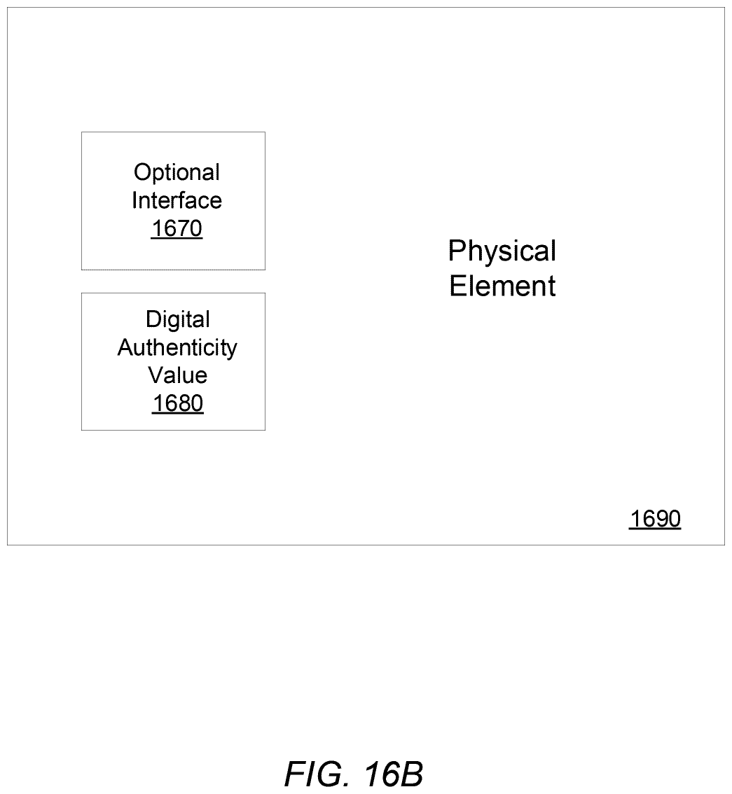

An example NFT which may be associated with specific content in accordance with several embodiments of the invention is illustrated in FIG. 16A. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

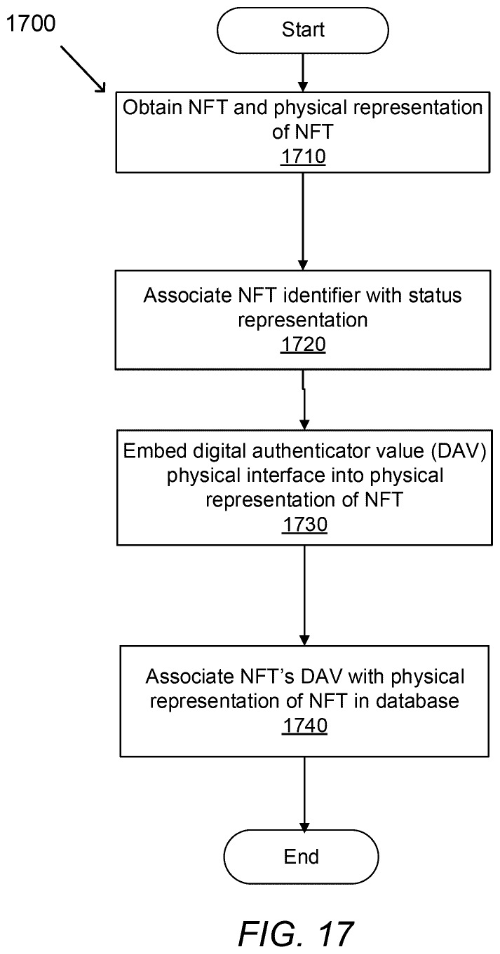

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### Wallet Configuration Data Retrieval

In many embodiments, a configuration file can be stored in plaintext. Configuration files can be stored in an encrypted format (e.g., where the decryption of it is performed by a user device). A decryption key for an encrypted configuration file can be based on a user password, a seed, and/or a combination of these. In some embodiments, a configuration file can be stored in an obfuscated format (e.g., by generating an nonce, then creating two obfuscated files from the file and the nonce, where combining these two obfuscated files renders the plaintext version of the file). Obfuscation can be performed, in several embodiments, using an XOR operation. The nonce used can be a random string of the same length as the configuration file. In numerous embodiments, a nonce can be the input to a stream cipher that generates a pseudo-random bit string of the length of the configuration file.

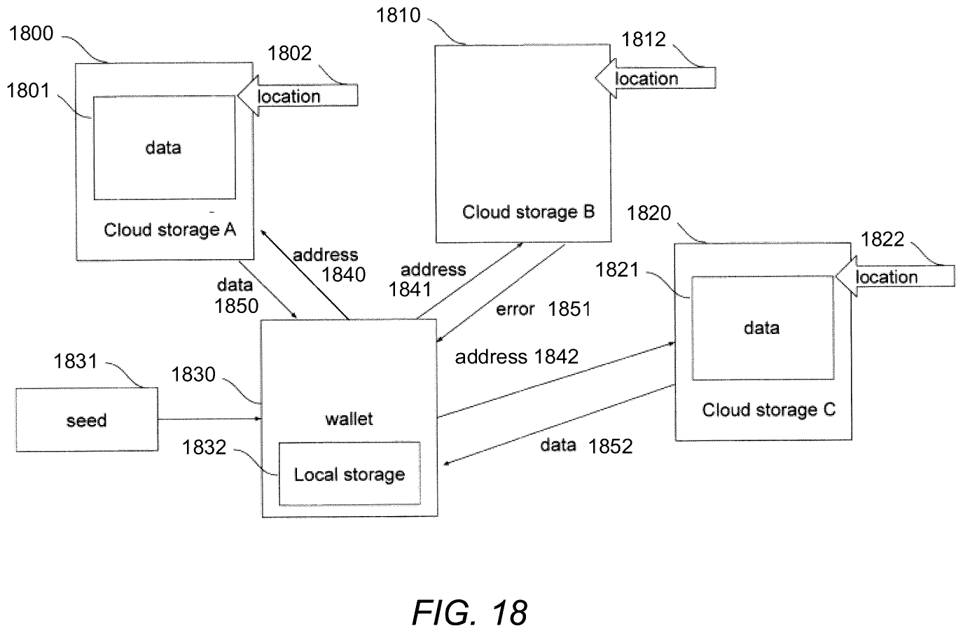

In accordance with various embodiments of the invention, a wallet can generate addresses based on a seed. The addresses can be used to retrieve configuration data (e.g., configuration values). The addresses can be indicative of the data location in an external storage (e.g., a cloud storage). The retrieved data can include user preferences, balances of tokens, NFT information, and/or access rights. The configuration value can be used to set access rights, user preferences, and/or other values for the wallet. The addresses can be used to perform requests for data. An example of a wallet capable of retrieving a configuration value is conceptually illustrated in FIG. 18. A wallet 1800 can receive a seed 1831. The wallet 1800 can generate addresses (e.g., addresses 1840, 1841, and 1842) used to perform requests for data (e.g., data 1850, 1852). In several embodiments, addresses can be virtual addresses in the associated cloud storage system, and/or can be expressed as URLs. The address 1840 can indicate a location 1802 in cloud storage A 1800. Data 1801 can be stored in cloud storage A 1800. The address 1841 can indicate a location 1812 in a cloud storage B 1810, wherein no data is stored. Address 1842 can indicate a location 1822 in a cloud storage C 1820, wherein data 1821 can be stored. In response to the request for address 1840, a wallet 1830 can receive data 1850. In response to the request for address 1841, wallet 1830 can receive an error 1851 message. The error 1851 message can be received when no data is stored at location 1812. The error 1851 message can be a message indicating that no file exists, a time-out error, and/or another notification. When the wallet 1830 receives a time-out error message, it can try again after a time period (e.g., 5 seconds) has elapsed. In response to a request for address 1842, the wallet 1830 can receive data 1852. In several embodiments, wallets may not make all requests for addresses (such as address 1840, address 1841 and/or address 1842) immediately, but can first make a request related to address 1840, and when the wallet 1830 receives an error message and/or a misformed data element, then wallets can proceed to request data from other cloud storages, (e.g., such as cloud storage B 110). A data request can be performed by sending a request for another address (e.g., address 1841). A misformed data element can be one for which a message authentication code is associated, and/or a digital signature is associated, but the authentication code and/or the digital signature is determined not to be valid. The wallet 1830 can store received data such as data 1850 and/or data 1852 in local storage 1832. When data 1850 and data 1852 match each other then only information associated with one of them may be stored in local storage 1832. In a number of embodiments, local storage can store, at least temporarily, errors (e.g., error 1851).

While specific processes and/or systems for a wallet capable of retrieving a configuration value are described above, any of a variety of processes and/or systems can be utilized for a wallet capable of retrieving a configuration value as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a wallet capable of retrieving a configuration value, the techniques disclosed herein may be used in any type of cryptographic systems. The techniques disclosed herein may be used within any of the rich media systems, permissioned blockchains, distributed ledgers, wallets, and processes for configuring wallets as described herein.

In several embodiments, one or more cloud storage locations can include addresses. Addresses can be generated by new wallet instances from a seed. Addresses can point to cloud storage locations (e.g., by providing a URL generated at least in part from the seed). Seeds can, in many embodiments, be represented as one or more QR codes that a user scans (e.g., with a smartphone), and which then are converted to a number representing the seed value. In various embodiments, a given blockchain can be used to store such content. The content can be locatable using a public key generated from a seed. In several embodiments, a location for a wallet state (e.g., configuration value) can be a InterPlanetary File System and/or another decentralized data storage system. A wallet state can in a number of embodiments, include a hardware device, such as a USB memory stick and/or other storage device that may be transferred from computer to computer.

In various embodiments, a user may select, at the configuration of a wallet one or more cloud service provides from a list (e.g., set) of service providers. For example, three cloud service providers from a list of 20 providers can be selected. The wallet can generate addresses for the selected service providers. The addresses can be generated based on a user selection. A new wallet instance can generate addresses for all the providers, only to find out that a number do not have any stored record. The wallet can retrieve a copy of the most recent wallet state from at least one of the service providers that do have an entry. The wallet can store the information locally about what three service providers are used. In various embodiments, when one of the selected providers terminate services, the wallet can detect this by probing the address with regular intervals (e.g., every day). Based on the probing it can be determined that one address that used to have information no longer exists and/or is inaccessible. In accordance with numerous embodiments of the invention, the wallet(s) can, (e.g., in response to this determination), generate another state backup with a second service provider. Second service providers, in some embodiments, be selected by the user and/or by the wallet itself.

State as used herein can include data of a wallet. State can include some or all of a wallet's content. In several embodiments, stored state information can be encrypted using a key that the wallet (and any future wallet instances generated from the same seed as the wallet was generated from) can generate from the seed. The stored state backup can be authenticated (e.g., using a message authentication code (MAC) or a digital signature), with a key generated by the wallet instance from its seed. In many embodiments, the information pertaining to the wallet stored on the cloud server and/or another type of backup storage service can include indications of what types of resources the wallet has access to (e.g., what type of crypto accounts the wallet is associated with). The information can include a list of public keys and/or other identifiers associated with non-fungible tokens that a wallet has access to. In numerous embodiments, access can include ownership access, access in the form of having been lent a token, having rented a token, and other access types and/or descriptions).

In several embodiments, state can include configurations related to user interface (UI) and/or user experience (UX) preferences. Examples of such are disclosed in U.S. Provisional Patent Application No. 63/303,569 filed Jan. 27, 2022 titled “Chameleon User Interface Method” by Markus Jakobsson and Stefan Dufva which is hereby incorporated by reference. In some embodiments, a new wallet instance can generate a cryptographic key based on a second input value obtained from a second user. The new wallet instance can then decrypt at least one response using a cryptographic key, resulting, at least in part, in a configuration value. By at least one response here can be meant retrieving a copy of the most recent state from at least one of service provider. The service provider can be a service provider that does have an entry corresponding to the wallet (e.g., as described above where a number (e.g., 3) of providers of a set (e.g., 20) of providers have a stored record). Wallets can use configuration valued to perform at least one configuration.

In several embodiments when a new wallet instance generates addresses for service providers (e.g., as described above), finds out that none of the service providers have a stored record (e.g., as relates to the new wallet) the wallet can generate a configuration. Configurations can be associated with an input value. Configurations can store a configuration of the at least one cloud storage location indicated at least in part by a path.

The stored state backup (e.g., configuration value, wallet data, stored record, the content of a wallet being backed up) can include user generated data concerning the wallet. User generated data can in some embodiments, include human readable and memorable names for addresses that are generated within the wallet, dates on which particular accounts were first created, notes associated with particular addresses or transactions involving addresses, and/or icons or emojis to use to represent addresses or transactions.

In a number of embodiments, an address of a storage location can be generated by concatenating a domain with a path. A domain can indicate a service provider. A path can indicate a file (e.g., wallet data) stored by the path. Paths can be generated using a pseudo-random generator from a seed and/or a counter. For example, a first address can correspond to storage on the Amazon(™) S3(™). A address can, in many embodiments be generated by generating a unique path as a 256-bit string. The address can be obtained from applying the cryptographic hash function SHA-256 to the seed and a value associated with the cloud storage (e.g., “S3”) concatenated with each other. In some embodiments, the 256-bit string can be expressed in hexadecimal. In many embodiments, an address may be represented as a string (e.g., http://s3.amazonaws.com/[path]/config-record). The path can include a hexadecimal pseudo-random number corresponding to a bucket. An optional filename is config-record is an optional filename. All wallets of a specific type can have common filenames independently of ownership or seed. Note that in these examples the service provider could be any of a number of service providers (e.g., is not limited to Amazon, Google, and/or any other service provider).

In many embodiments, a wallet type can implement a particular digital rights management (DRM) system. Wallets can be compatible with any other wallet, independent of manufacturer, that supports the same DRM system. Wallets of this type, in several embodiments, are compatible in terms of how they store and retrieve configuration data from third party storage (e.g., such as cloud storage). Another collection of wallets can be incompatible with the first wallet type, and may not be able to access backups of state made by these, and/or can be unable to do so automatically without a manual involvement for the setup.

State information, in numerous embodiments, can contain further information indicating which hardware, software, DRM systems, and/or other elements are relevant. In some embodiments, a wallet instantiated on a different platform can use this further information to determine which portions (if any) of the stored state information are relevant to the current installation.

In several embodiments, a second address can similarly correspond to storage on a second cloud storage provider (e.g., Google(™) server). A second address can correspond to a second bucket. The second address can be determined by generating a unique path as a 256-bit string obtained from applying SHA-256 to the same seed value as above (e.g., as used with respect to a first could storage provider) and a second value (e.g., “Google”) associated with the second cloud storage provider concatenated with each other. The second portion, (e.g., “Google(™)”) can, in some embodiments, be the domain of the service, and/or a simple counter. A simple counter can be, for example one where S3(™) corresponds to the counter value 1, and Google(™) to the counter value 2, etc. The list of domains and their associated second portion values can be stored in a list. The list can be part of a wallet. Wallets of the same type can have identical lists. In several embodiments, another wallet of the same type, and/or compatible with such, includes the same list as a first, and accordingly, the same series of paths generated, provided the same input seed. When a user sets up a new wallet instance using the same seed value as a previous wallet was set up, the new wallet instance will generate the same cloud storage addresses. These same cloud storage address specify locations where material indicating configurations may be stored, as disclosed above.

In many embodiments, buckets (e.g., as described above) can be set up by wallets as those wallets are first configured (e.g., as part of the very first setup during which a seed is generated). Setup of buckets can be automated, and/or can be performed when a user provides a payment method for the cloud service providers of choice. In various embodiments, the payment method can be provided via a wallet, after which the wallet completes a registration of a bucket. The bucket can be associated with the seed of the user by the registration.

In many embodiments, two different storage compartments with two different service providers will not be possible to be associated with the same wallet by a third party if the two bucket identifiers are selected as two different, e.g., consecutive, pseudo-random numbers generated from the seed.

In many embodiments, buckets can be associated with a manufacturer of a wallet. A space, in several embodiments, for a configuration file can be prepaid and set up prior to wallet initiation. As the wallet is initially set up, the first configuration file can be generated and stored. In a number of embodiments, the address for this location can be of another format than in the example above. Instead of an address of the example format http://s3.amazonaws.com/[path]/config-record as above, an address can correspond to a format of http://s3.amazonaws.com/manufacturer-buckeUpath/config-record where manufacturer-bucket is a name of a bucket selected by the wallet manufacturer, and which is the same for all compatible wallets, and/or where path remains the hexadecimal descriptor generated from the seed value. Since the bucket is pre-registered, it does not need to be set up by the wallet owner, who will not need to provide payment during initial setup. In various embodiments, storage locations can be manufacturer-managed, such as in this example, and/or can require the wallet owner inputs to set up a space. A user may use a personal storage unit to store configuration data in a number of embodiments.

In some embodiments, a user setting up a new wallet can indicate a source for the storage (e.g., the user clicks on a button indicating “Google(™)”, when Google(™) was previously used to store the profile for the user). This can initiate a process wherein the user provides a username that is made part of the path. In various embodiments, when the username is “wally”, for example, this username may be used to indicate a path, which may start with “/wally/” after the domain name indicating the server, but before the string generated by the pseudo-random generator. A user indicating a service that was not used, and/or a username that was not used will cause an invalid path to be generated, and no result will be found.

In numerous embodiments, a wallet can use a centralized storage system (e.g, such as Google(™) or Amazon(™) S3(™)) as a registry for pointing to files stored on the InterPlanetary File System (IPFS). In several embodiments, wallet metadata can be encrypted using a key generated by the wallet for that purpose. Encrypted wallet metadata can be uploaded to the IPFS. Subsequent to upload of metadata, a wallet can write a list of filenames of uploaded files to a centralized storage system, optionally encrypted.

In several embodiments, a configuration file can include selections of service providers, configuration values to store a UX or UI of preference, personal data, tokens that the user selects to cache on the wallet and use locally without an Internet connection, and/or other information. In several embodiments, when a user updates the data to be mirrored by the configuration file stored on server(s) (e.g., cloud storage) as described above, the user's wallet (or wallets) can automatically update a cloud storage accordingly. Updates can be performed by replacing the previous record and/or to append a new component. In various embodiments, each component can be separately authenticated, and/or some components can be encrypted.

Wallets in numerous embodiments, can periodically verify (e.g., by contacting the cloud storage), whether there have been any updates to the stored state backup (which can be referred to as a configuration file in this disclosure.) When there is such a modification (e.g., as determined by a hash value of the entire contents associated with one container), a wallet can request new elements, and/or can request all data. A container (which can be referred to as a bucket) can correspond to a given path value, as disclosed herein. In some embodiments, cloud storage can store information, the information provided by individual wallets associated with the container. The information can be synchronized between the individual wallets. In many embodiments, a file in the container can store the most recent state of the stored information. This way, a wallet querying for updates can easily determine which elements to request. As a wallet updates the state it can update the file indicating the contents of the most recent state. In several embodiments, wallets can set semaphores in the storage space to make sure that no two wallets write at the same time.

In some embodiments, a new wallet does not need to be synchronized with, paired with, and/or used at the same time as a first wallet, where the new wallet and the first wallet are associated with the same configuration values. The new wallet can be able to, independently of the continued existence and operation of the first wallet, become automatically configured, and/or configured with a limited user involvement, after a seed value has been provided to it. Seed values in many embodiments, can be in the form of one or more pass phrases, and/or can be one or more QR codes that may be stored in a variety of locations.

In accordance with some embodiments of the invention, a new wallet and a first wallet can initially have different access rights, but later, as a result of an action, can be granted the same access rights. This can be true even though the new wallet and first wallet are both governed by the same seed value. This can occur because, in addition to an identifier determined from the seed value, the wallets in various embodiments can have instance identifiers that distinguish them from each other. Such instance identifiers can be generated from other seed values, from distributively stored key data, and/or by other means.

In many embodiments, a user can select different unlocking passwords for different wallets initialized with the same seed. Wallet can use an associated password, or a hash of the password, to determine which retrieved settings data should be applied to the current instance of the wallet for cosmetic and/or usability purposes. In some embodiments, a wallet with a same seed phrase but the second password may display less or different information. Displayed information can include assets held, names associated with specific addresses, and/or chains that are visible, etc.

In several embodiments, access to specific settings information can be restricted by a password for security purposes. In some embodiments, restriction can be performed via encryption/decryption of some settings data using a specific password. Wallets, in various embodiments, can require a seed phrase and/or a specific password to view and/or act on some aspects of a wallet. Seed phrases and passwords can, in some embodiments, be used in the derivation of specific sets of addresses. This can ensure that different instances of the wallet with the same seed, but different passwords, can share a common set of addresses. When wallets share a seed but have different passwords they can include a second set of addresses specific to only that wallet. A user can, in several embodiments, have an emergency password (e.g., that he can give out under duress), that provides access to a limited set of content; as well as an everyday password used to access most but not all resources, and/or yet another credential, which can be used to access very large quantities of crypto currency. By using one credential, the wallet will only display information associated with the related resources, whether NFTs, crypto currencies, or other information, such as personal information, enterprise files, etc. In various embodiments, wallets with different passwords, but common seeds can enable viewing of different content selected from a common set of data.

In many embodiments, at least part of an address indicating the storage location of the configuration data can provided by a user in addition to the user providing the seed value, for at least one of the storage locations (e.g., cloud storage location). In various embodiments, that storage location, can, for example be on a local network, a connected device such as a USB device, a paired device such as a Bluetooth device connected to the wallet using wireless communication, and/or an enterprise storage device. In some embodiments, the identification of the location may be implicit, (e.g., by connecting the wallet to a USB drive); it can be performed by selecting a local storage unit from a collection of connectable drives; it can be implicit by the user logging in to the enterprise network with a valid username and password (e.g., as the location can be provided by the enterprise network). In some embodiments, storage locations can be part of the services offered by email service providers. Email service providers can verify logins associated with the wallet to an email account, and can then provide configuration data and/or information associated with the location at which such configuration data can be requested.

A wallet can be implemented as an app on a mobile device, in the format of a USB token with potential user interfaces such as a biometric sensor, and/or as a combination of software and hardware associated with a laptop and/or desktop computer and/or other means of implementation. Wallets can be implemented in various other ways, using hardware and/or software. Wallets implemented in various embodiments can have user authentication mechanisms, such as a biometric sensor, the possibility for a user to provide a username and password over a wired or wireless connection, and/or other authentication mechanisms.

In several embodiments, users can create several wallets from the same seed, as disclosed in U.S. Provisional Patent Application No. 63/300,202 filed Jan. 17, 2022 titled “Dependent Wallet Technology” by Markus Jakobsson and Stefan Dufva, which is hereby incorporated by reference. Wallets can be derived from exactly the same original information (e.g., the seed), but can still have different access rights. In some embodiments, one wallet, which we can be term the master wallet, can have full access to all tokens, including crypto funds and NFTs, as well as to all other information stored in and/or referenced by the wallet. Other information stored in and/or references by a wallet can include personal information of the user, such as PII, health data, and/or activity records. Another wallet, in various embodiments, can be derived from the same seed but can have a first access type (e.g., read access only) to various data items (e.g., a specific directory of NFTs), and/or a second access type (e.g., append-access) to second various data items (e.g., to health data and activity records) and/or no first access type (e.g., read access) to these. This can be achieved by each wallet having an additional identifier, such as “1”, “2” and “3”, “master”, “Joe's iPhone” and/or “Gloria's laptop” for example.

In several embodiments, each device of a set of devices can be associated with one identifier that is used by the wallet and one that is displayed to the user. The identifier displayed to the user can, in accordance with embodiments of the invention, be modified without impacting the access rights of the associated wallet. Different wallets can have different access rights, and/or can be associated with identifier-specific configuration files. Configuration files can be stored in the same buckets as other information, and/or in separate buckets. The storage location of configuration files can be determined based on seeds and/or from configuration files associated identifiers.

When a wallet, in accordance with many embodiments of the invention, is first instantiated (e.g., when a user gets a replacement wallet serving the role of the previous wallet with a previous identifier), the user performing a configuration can input a seed. Inputting a seed can cause a configuration file to be loaded from a storage (e.g., cloud storage). The configuration file can include an identification of what wallet identifiers there are. The configuration file can include a record used to verify that a user has the right to select one of the wallet identifiers. The record can be a salted and hashed password, a biometric template, and/or a reference to a biometric token in various embodiments. When a user successfully authenticates, a wallet being instantiated can select an according identifier and ascribe that identity to itself. The wallet can load and/or otherwise access the associated data in the configuration file(s) stored in the selected location to ascribe the identity. In various embodiments, the access granted can be determined by the seed and/or the selected identifier. Configurations can be performed based on the access granted. Such configurations can include access to selected files, and/or a lack of access to other files. In some embodiments, a first file (e.g., a first NFT) may be granted read access to, but a second file (e.g., a second NFT) may not be granted any access at all to. In this case, only the first NFT will be rendered to the user. The first NFT can correspond to a first public key and an associated private key. The private key can be made accessible only to wallet instances with the right to sell the NFT. Content associated with the NFT can be encrypted using a symmetric key that is stored only by wallet instances with read access to the NFT content. The second NFT can associated with a second public key and an associated second private key. A wallet instance that should not have access to this second NFT can lack access to an appropriate decryption key.

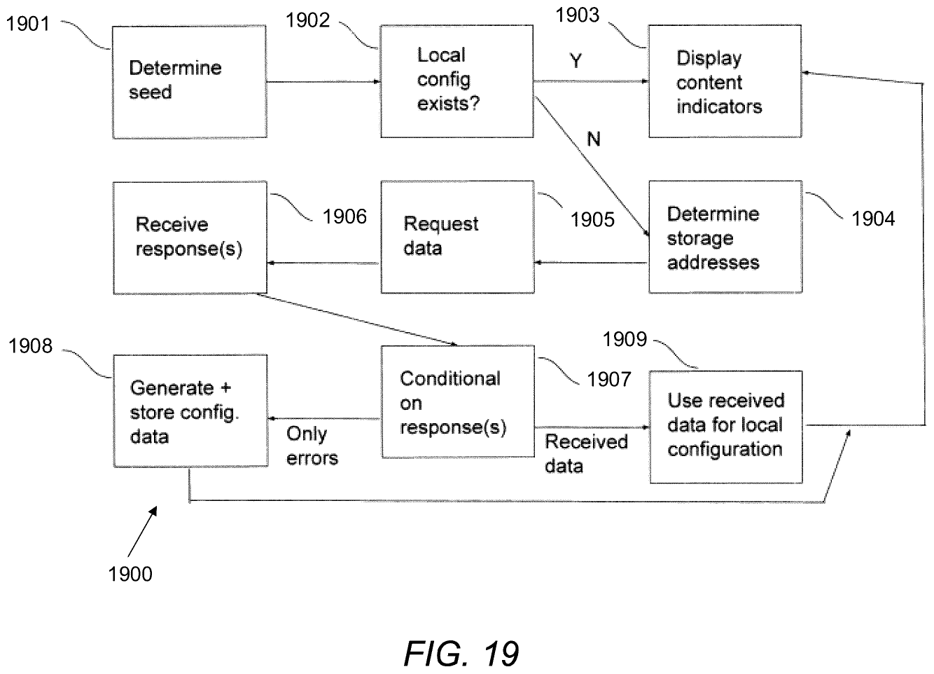

In various embodiments content indicators can be displayed based on data for a local configuration. An example process for displaying content indicators is conceptually illustrated in FIG. 19. A process 1900 can include determining (1901) a seed. Seeds can be determined by receive seeds from users (e.g., if a user has already generated a seed and has stored the seed. Seeds can be in the form of a sequence of words, a hexadecimal string, a QR code, and/or one or more of such values. In several embodiments, seeds can be generated using pseudo-random function generator (PRFG) (e.g., based on one or more user inputs, based on unpredictable activity, and/or a combination of such). User inputs can be received as a series of keystrokes with their associated timings, and/or a series of accelerometer sensor values when a user moves a wallet (e.g., wallet 1830) or a connected element with an accelerometer sensor in various embodiments. In several embodiments, an input to a PRFG can be the timing of one or more disk accesses, the timings of bus activity, and/or other timings. In various embodiments, a wallet can store a seed (e.g., wrapped using a credential, a password or a biometric input, of a user). Seeds can be stored in local storage. The process 1900 can determine (1902) whether a local configuration has already been made (e.g., whether an associated wallet already locally stores one or more configuration values). Configuration values can identify user preferences. User preferences can be related to user interfaces and/or to user privacy choices. Configuration values can indicate addresses where configuration files are stored (e.g., in an encrypted and authenticated form on one or more cloud storage services). When a local configuration of the wallet exists, then the process 1900 can display 1903 one or more content indicators to a user. When there is no evidence of a local configuration (e.g., the wallet local storage is blank but for its operating system, native applications, a generated seed value, etc.) then the process 1900 can determine (1904) one or more storage addresses (e.g., such as address 1840, address 1841 and/or address 1842) based on a seed (e.g., seed 1831). The process 1900 can request (1905) data. Data requests can be made to one or more storage providers (e.g., cloud storage A 1800, cloud storage B 1810, and/or cloud storage C 1820), using the addresses determined in 1904. Responses can be received (1906) by the process 1900. Responses can be data (e.g., data 1850) and/or errors (e.g., error 151). Errors can, in many embodiments, indicate that there is no data saved corresponding to the requested address or that there is a time-out. The process 1900 can evaluate (1907) the response and conditional on the responses received, proceed either to 1908 or 1909. When there were no responses with data, but only errors, then processing continues to 1908, otherwise to 1909. The process 1900 can generate (1908) a set of configurations. Configuration generation can, in many embodiments, require user inputs. Configurations can be stored in local storage, in one or more external storages, and/or at the previously calculated addresses (e.g., address 1840, address 1841, and/or address 1842). Configurations can then be applied (e.g., used to influence what is rendered and/or how it is rendered) as described with respect to 1903. The process 1900 can use (1909) received data to perform local configurations (e.g., by storing configuration data received as part of data 1850 in local storage 1832), and apply these configurations as described with respect to 1908.

While specific processes and/or systems for a process for displaying content indicators are described above, any of a variety of processes and/or systems can be utilized for a process for displaying content indicators as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a process for displaying content indicators, the techniques disclosed herein may be used in any type of cryptographic systems. The techniques disclosed herein may be used within any of the rich media systems, permissioned blockchains, distributed ledgers, wallets, and processes for configuring wallets as described herein.

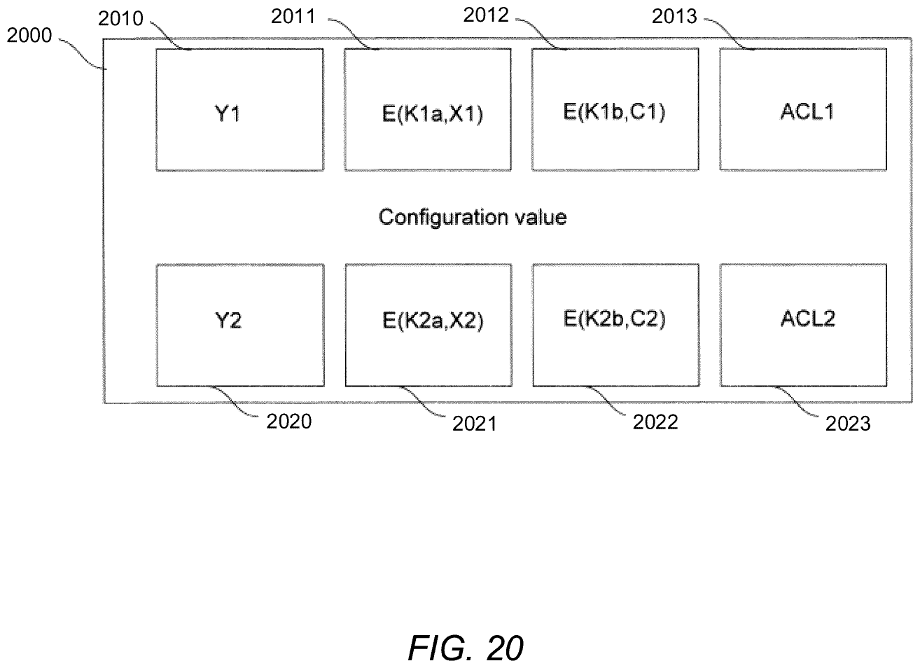

In various embodiments, a configuration value can include references to one or more public keys. An example of a configuration value is conceptually illustrated in FIG. 20. A configuration value 2000 is a configuration value that has be decrypted using a key derived from a wallet seed (not shown). The configuration value 2000 can be stored on a wallet. The wallet can be wallet “1” or wallet “2.” The wallet can be associated with a given seed. Y1 2010 can be a first public key, X1 can be a corresponding private key, and C1 can be a corresponding content element.

In some embodiments, Y1 can be a public key associated with the ownership of an NFT. X1 can be a private key that is used to transfer ownership of this NFT, and C1 can be the content of the NFT. The NFT can include audio, video, text, etc., as well as policies and/or other elements.

In accordance with many embodiments of the invention, Y1 can be a public key of a crypto fund. X1 can be a corresponding private key used to transfer ownership of the cryptofunds, whether in part or fully. The value C1 can indicate a remaining value of the crypto coin.

The configuration value 2000 can include a value 2011. The value 2011 can include an encryption, (e.g., using symmetric cryptography), of private key X1 using symmetric key K1a. A wallet instance with access to K1a can, in several embodiments, be capable of transferring ownership of the token (whether coin or NFT) associated with public key Y1 2010 (e.g., by generating a digital signature using private key X1 after decrypting value 2011 using symmetric key K1a). Similarly, using value 2012 and/or symmetric key K1 b, the value C1 can be decrypted by a wallet instance with access to K1b. In some embodiments, K1b can be the same as K1a, or it can be a different key (e.g., a key selected in an independent manner). The value ACL1 2013 can indicate an access control list associated with the values X1 and C1. Access control lists can include handles associated with keys K1 a and/or K1 b. The handles can be indicators of what keys are needed to decrypt values 2011 and/or 2012. In various embodiments, a wallet that has access to K1 a can recognize that the handle of K1 a is listed in the ACL1 2013. Based on this recognition the wallet can decrypt value 2011 using K1 a. Similarly, another token can be represented by public key Y2 2020; encrypted private key X2 2021; encrypted content C2, 2022; and/or access control list ACL2 2023.

In various embodiments, a wallet, Wallet “1” can be associated with a given seed can have access to keys K1 a, K1 b and K2a. That access can allow it to access C1 and/or C2, and can allow it to transfer ownership of the token associated with Y1 2010. The indicated access ca n not allow it to transfer ownership of the token associated with Y2 2020. Similarly, a wallet, wallet “2” can be associated with the same seed may have access to keys K1 a and K2b. That can allow it to transfer ownership of the token associated with Y1 2010, but not of the token associated with Y2 2020. It can allow it to access the content C2 but not the content C1.

In several embodiments, additional access rights, not shown in FIG. 20, can specify whether a wallet has write access, and if so, whether it can delete/overwrite data, or just append data. Write access can be managed using additional configuration data included in a configuration value (e.g., configuration value 2000). Write access can be stored in the form of access control lists (whether associated with keys or not) and policies determining what a digital rights management (DRM) module associated with a wallet may and may not do. Digital rights management modules are disclosed in U.S. Provisional Patent Application No. 63/315,143 filed Mar. 1, 2022 titled “Wallet with Modular Rights Management” by Markus Jakobsson and Keir Finlow-Bates which is hereby incorporated by reference. In several embodiments, a file can be created for each wallet instance. The file for each wallet instance can include keys, such as K1 a and K1 b, for the wallet instance. A wallet instance can only access or decrypt that file if it has an appropriate unique identifier, an access right, and/or has performed the verification of its identifier. In several embodiments, a machine-readable identifier is a key used to decrypt a wallet instance file.

While specific processes and/or systems for a configuration value are described above, any of a variety of processes and/or systems can be utilized for a configuration value as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a configuration value, the techniques disclosed herein may be used in any type of cryptographic systems. The techniques disclosed herein may be used within any of the rich media systems, permissioned blockchains, distributed ledgers, wallets, and processes for configuring wallets as described herein.

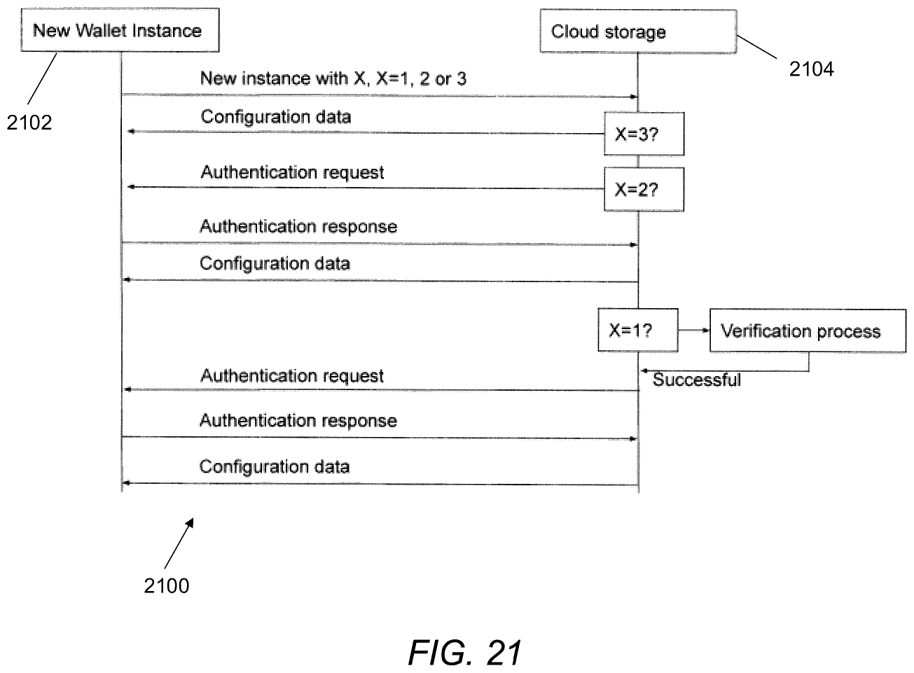

In various embodiments, a wallet can receive configuration data from a cloud storage based on an authentication process. A signaling diagram of an example method for transmitting configuration data from a cloud storage to a wallet instance is conceptually illustrated in FIG. 21. A process can instantiate a new wallet instance 2102. The wallet instance 2102 can communicate with a cloud storage 2104. The wallet instance 2102 can transmit a signal and/or message to the cloud storage 2104. The signal and/or message can include an indication, X, of the wallet 2102 access rights. In the depicted example, there can be three different access levels, 1, 2 and 3 wherein 3 is the lowest access level and 1 is the highest access level. In some embodiments, the content of a level can be associated with an access level.

The cloud storage 2104 can receives the signal or message and can check what access right level the new wallet instance has, and/or the content of funds associated with the respective access levels. An indicator can include a digital signature that is verified before access is granted. Depending on the access level rights, the cloud storage 2104 can perform different actions. In this example, if the new instance wallet 2102 has an access right level of 3, the cloud storage may return configuration data to the new instance wallet, thereby the new wallet instance gets configuration data giving the new instance wallet access to a first level (e.g., limited quantities of funds and/or selected tokens, relatively low and/or limited actions being available to be taken. When the access level is 2, (e.g., X=2), then the cloud storage 2104 can require an authentication of the new wallet instance. The access level 2 may permit greater uses with respect to the content of the wallet as compared with level 3. This is illustrated by the cloud storage 2104 transmitting an authentication request to which the new wallet instance responds. Upon successful authentication, the cloud storage can transmit configuration data to the new wallet instance. Using the configuration data, the new wallet instance can have access to content, funds and/or actions. When the access level is the highest (e.g., X=1), then cloud storage 2104 can perform a verification process before sending the configuration data to the new wallet instance. Such verifications may be performed for other levels as well, but the type of verification may depend on the access level.

While specific processes and/or systems for a method for transmitting configuration data from a cloud storage to a wallet instance are described above, any of a variety of processes and/or systems can be utilized for a method for transmitting configuration data from a cloud storage to a wallet instance as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a method for transmitting configuration data from a cloud storage to a wallet instance, the techniques disclosed herein may be used in any type of cryptographic systems. The techniques disclosed herein may be used within any of the rich media systems, permissioned blockchains, distributed ledgers, wallets, and processes for configuring wallets as described herein.

In accordance with some embodiments of the invention, when a wallet instance is created, there can be multiple instances that have been pre-configured (e.g., instance “1”, “2” and “3”). The instances can be ordered in terms of access rights (e.g., most access rights first). In various embodiments, a master wallet can correspond to instance “1”, and a wallet instance with least access rights ca correspond to “3”. Information about what options are available can be stored in a configuration file on external storage, such as cloud storage. This information can be loaded as the un-configured wallet instance is started up. In various embodiments, before an instance number has been associated with a wallet that is starting up, a user can be asked what instance he or she wants to start, selecting from a list of available instances, where these may be represented using the numbers “1”, “2” and “3” and/or by other names and/or descriptions.

An instance, in numerous embodiments, can be associated with a requirement for the user to perform an action. A user can be allowed to choose “3” without performing any such associated action in some embodiments. When choosing “2”, the user can be required to authenticate using a biometric whose corresponding template can be included in configuration data. Configuration data can be encrypted using a key derived from a seed. Configuration data can, after being downloaded from the cloud storage, be decrypted with the seed and/or an associated key. When choosing “1”, (which in this example corresponds to the master wallet), a verification can be performed when this is allowed. In accordance with several embodiments of the invention, when there is no other functional “1” instance, and this is verified, then the instance being started up can be allowed to be configured as a master. In several embodiments, initiating a master wallet can have requirements on the user, such as authenticating.

Verification, in many embodiments, can be performed by a wallet instance being configured. The verification can include causing a message to be sent to a registered contact address indicated in configuration data that was downloaded. The message can be sent to an email address and/or as an SMS. The message can include a notification (e.g., “Somebody is trying to set up a new master wallet for the wallet called ‘Bob-wallet’. If you do not want that to be allowed, click within 72 hours and the request will be blocked). In some embodiments, when a user logs in to the master instance of ‘Bob-wallet’ within a timeframe and indicates that a clone is not allowed the verification can fail. In several embodiments, a message may request that a user responds by replying to the message to block the request. In various embodiments, when a response is received to any such notification message within the indicated time limit, the request will be stopped, otherwise it can be allowed to proceed.

The passing of messages can be performed by a wallet, by a service communicatively coupled with the wallet being started, and/or using a service that the user operating the wallet has access to (e.g., using a web interface). The duration within which the user needs to respond can be a user configurable value that is stored in the configuration data downloaded from the cloud storage and/or other external storage. A timeframe can be one week, for example. This type of verification can be associated with multiple wallet instances (e.g., such as both “1” and “3” as described elsewhere herein).

A new instance, such as an instance “4” can, in several embodiments, be created by a wallet instance that is the master, or which has been granted the right by the master to do so. Such rights can be indicated in the instance-specific data stored in an external storage (e.g., cloud storage). When a new instance is created, an instance file or portion of an instance file for it can be created in an external storage (e.g., cloud storage). Instance-specific configuration data can be stored in the created instance file or portion of an instance file.

In several embodiments, a location of a storage in a cloud storage system can be generated from a unique value different from the seed described above (e.g., such as a unique username). A username can be an email address. A location of a storage in a cloud storage system can be encoded as a QR code. A scanned QR code can allow a device, such as the wallet and/or a device associated with the wallet, to generate the location. A record (e.g., a configuration value) stored in the cloud database, indicated using this unique value, can be downloaded to a wallet. The downloading wallet can obtain a key that is capable of decryption of the downloaded record. The key can be derived from a seed value, as disclosed herein, and/or from another value with sufficient entropy to render brute-force attacks unlikely to succeed. In various embodiments, the key can be derived using biometric methods. Biometric methods are described in Fabian Monrose, Michael K. Reiter, Q. (Peter) Li, Susanne Wetzel. “Using Voice to Generate Cryptographic Keys,” which is hereby incorporated by reference. Biometric methods are described in 2001: A Speaker Odyssey. The Speech Recognition Workshop, Crete, Greece, June, 2001, which is hereby incorporated by reference. In some embodiments, a key can be derived as disclosed in U.S. Provisional Patent Application No. 63/273,921 filed Oct. 30, 2021 titled “Biometric Authentication using Privacy-Protecting Tokens” by Markus Jakobsson, which is hereby incorporated by reference. In accordance with many embodiments of the invention, a key can be used to decrypt at least a portion of the received encrypted record, after which configuration data can be accessed.

Configuration data can include seed values that can be used for the generation of other cryptographic key material. Configuration data can include the various types of information disclosed elsewhere in this disclosure. In some embodiments, the plaintext configuration data, any seed or any keys derived from a seed, and/or any sensitive information, can be stored in a secure storage area of the wallet. In some embodiments, data stored on wallets can be configured to automatically erased when an event occurs (e.g., such as the completion of the setup of the wallet; an identification of a potentially dangerous event, an identification of a malware event; and/or an indication from a user of the wallet to power the wallet down). In various embodiments, an event can be an anomalous event (e.g., such as an event that involves an invalid login attempt to the wallet, a GPS location that is not previously associated with the wallet, etc.).

In some embodiments, a computer program is provided. The computer program can include computer readable code means, which when run in a processing unit included in an arrangement in a node as described in this disclosure can causes the node to perform the method as described herein. In an embodiment, a computer program product comprising the computer program can be provided. A processing unit can be included of the arrangement in the node (e.g., with a DSP). A processing unit can be a single unit or a plurality of units to perform different actions of procedures described herein. The arrangement in the node can include an input unit for receiving signals from other entities or arrangements, and/or an output unit for providing signal(s) to other entities and/or arrangements. An input unit and an output unit can be arranged as an integrated entity or as one or more interfaces. An arrangement in a node can include at least one computer program product in the form of a non-volatile memory (e.g., an EEPROM, a flash memory and/or a hard drive). A computer program product can include a computer program. A computer program can include code means, which when executed in the processing unit in the arrangement in the node can cause the node to perform the actions described herein. The processor can be a single Central Processing Unit, CPU, or can include two or more processing units. A processor can include, in various embodiments, general purpose microprocessors; instruction set processors and/or related chips sets and/or special purpose microprocessors such as Application Specific Integrated Circuits, ASICs. Processors can include board memory for caching purposes. Computer programs can be carried by a computer program product connected to processors. Computer program products can include computer readable medium on which the computer programs can be stored. In some embodiments, a computer program product can be a flash memory, a Random-Access Memory RAM, Read-Only Memory, ROM, and/or an EEPROM. In several embodiments, computer program modules as described above can be distributed on different computer program products in the form of memories within nodes.

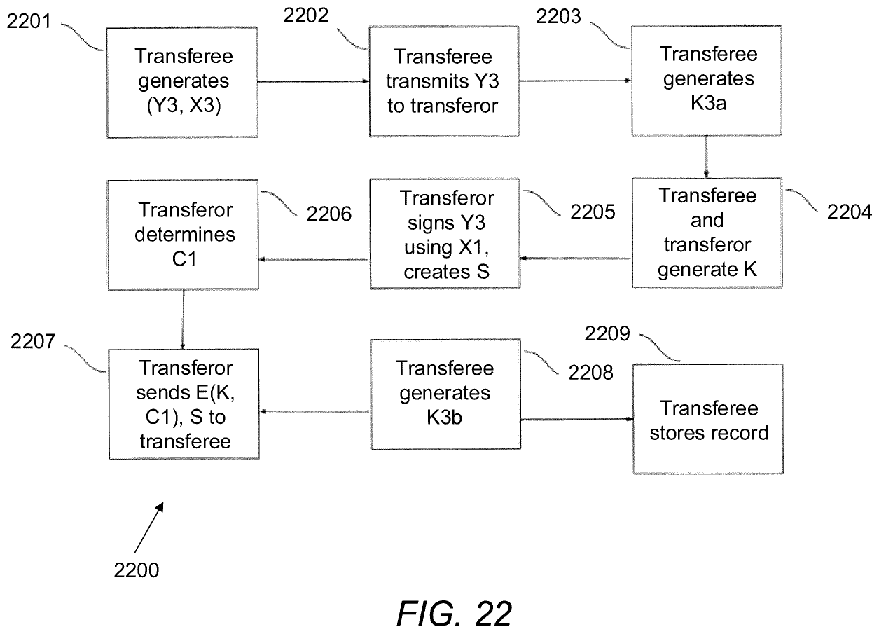

In many embodiments, a token sale can be secured using configuration values. A process for protecting a token transfer is conceptually illustrated in FIG. 22. A transferee can generate 2201 a public key Y3 and private key X3 pair. The transferee can transmit 2202 the public key Y3 to a transferor. The transferee can generate 2203 a symmetric key K3a to be used to protect X3. The transferor and the transferee can generate 2204 a shared symmetric key K (e.g., using key transport and/or using key establishment). In various embodiments, both the transferor and the transferee can store K temporarily. The transferor can transfer 2205 the ownership of the token. The ownership of the token can correspond to a top row of a configuration value (e.g., configuration value 2000). The transfer can be performed by the transferor signing Y3 using X1, resulting in a digital signature S that can be publicly verified using the public key Y1 and the data describing a new token ownership, (e.g., Y3), as well as data related to the token, (e.g., content data C1). The transferor can determine (2206) C1 (e.g., by decrypting element 2012 using key K1 b). The transferor can send (2207) an encryption of C1 using the shared key K to the transferee, as well as the digital signature. The transferee can decrypt this ciphertext E(K, C1) to determine C1, which the transferee can refer to as C3. The transferee can generate (2208) a protected private key X3 by encrypting X3 using the key K3a and/or K3b. The buyer can encrypt content C3 using key K3b. The transferee can store (2209) a record. The record can be (Y3, E(K3a, X3), E(K3b,C), ACL3), where ACL3 specifies the access control associated with the use of K3a and K3b. The storage of the record for the transferee can be similar to the storage of the record shown as shown in FIG. 20. In various embodiments, when the ownership transfer has completed, the transferee can remove the record from storage.

While specific processes and/or systems for a process for protecting a token transfer are described above, any of a variety of processes and/or systems can be utilized for a process for protecting a token transfer as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to a process for protecting a token transfer, the techniques disclosed herein may be used in any type of cryptographic systems. The techniques disclosed herein may be used within any of the rich media systems, permissioned blockchains, distributed ledgers, wallets, and processes for configuring wallets as described herein.

### Dependent Wallet Technology

The disclosed technology introduces methods to synchronize one or more dependent wallets, or alternatively we describe dependent wallets as low-security wallets, with a high-security wallet, and to provide limited access to some elements stored in or by the high-security wallet by the one or more low-security wallets. For example, an application wallet running on a smartphone or a wearable computer may be granted read-only access to a set of content elements the user, using a user interface associated with the high-security wallet, where read-only access does not permit the user to transfer ownership of the the assets using the one or more low-security wallets. Wallets may have multiple security designations, from very low to very high, e.g., based on hardware implementation, policies on what software may be installed and by whom, risk exposure, and more. For example, a first device whose hardware implements address space layout randomization (ASLR) has a higher security than a device that does not, as using ASLR makes buffer overflow attacks significantly less likely to succeed. A device that only allows a small set of employer-approved apps to be installed, based, e.g., on a mobile device management (MDM) policy, is typically more secure than one that allows a user to install any app in the iTunes (™) app store or Google Play(™) appstore, which in turn is more secure than a device where an app sent in an email message can be installed by the user. Furthermore, a device that the user locks into a safe and only uses on a malware free computer is more secure than a device the user carries with himself anywhere he goes, allows to be discoverable, and pairs with multiple devices. A user may specify what access rights to various files and services that can be initiated from various devices of such types.

Another aspect of the disclosed technology is an upgrading mechanism by which a user of the low-security wallet may increase his or her access rights to elements associated with the high-security wallet by performing a potentially very cumbersome authentication process. One example of such an authentication process is a biometric authentication process involving multiple aspects to proceed, such as multiple fingerprints, an iris scan, a face scan or a voice frequency scan. This protects the assets associated with the high-value wallet from theft, e.g., by malware or a burglar, while at the same time providing the user with a backup access method, should the high-security wallet be lost or broken. Authentication biometrics may be implemented using NFTs as described in U.S. Provisional Patent Application No. 63/213,251 filed Jun. 22, 2021 titled “Token Creation and Management Structure” by Markus Jakobsson and Stephen C. Gerber. In one embodiment, a low-security wallet cannot gain access to the assets of the high-security wallet, but can be used to instantiate a new high-security wallet, using information associated with the low-security wallet.

In some embodiments, some authentication attempts succeed only if (a) the user passes the test, and (b) a user of an associated device does not deny a request to access within a specified time limit. For example, consider two associated devices, device A and device B. Device A is considered a more secure device than device B, and has full access rights to all content associated with an account, where an account could correspond to a public key, a username, a phone number or another unique identifier. Device B can play some of the content, or assets, associated with the account, but cannot erase, burn, transfer, or sell any of the content, usually in the form of fungible and non-fungible tokens. This type of access, using device B, may require the user to authenticate with a password, a fingerprint, or a face biometric verification. Device B can also be used to configure a new device, which we may refer to as device C, where device C has full access rights to all the content. Such an action requires a more arduous authentication than what is described above for “normal” use. For example, before the configuration of device C can start, the user may have to successfully authenticate to device B using at least two of three available techniques, where examples of such techniques may comprise a password, a fingerprint, or a face biometric verification. Once that is done, device B transmits a notification to a service provider that attempts to contact device A, e.g., using push notification. The service provider may acknowledge receipt of the notification from device B. The service provider, in its message to device A, will ask whether device C may be created as a clone of device A, and ask that the user of device A approves or denies this request within 24 hours. This may be transmitted in another notification, to wallet A, which we refer to as the controlling wallet. In cases where the controlling wallet does not have communication means, or its user has indicated that he or she wants notifications sent elsewhere, e.g., to an email account or by SMS, such notifications may be sent instead or in addition. If no response is received within the 24 hours, or if device A approves the request associated with the notification, then the service provider transmits a go-ahead message to device B, where the go-ahead message may comprise a data element that enables the creation of the requested access control state for device C. If device A denies the request within the stated 24 hours, then the service provider does not send the go-ahead message. This is a non-limiting example of a policy that can be used to enable different access control levels, e.g., immediate play access to some content without any delay and regular authentication, or the right to clone a full access device after a delay and more demanding authentication. The capability to the latter would only be available to devices, such as device B, that are already associated with the account that device A has full access to. A user of device A, if becoming aware of the loss or compromise of device B, can exclude device B from the rights to instantiate a new device, such as device C, by requesting that device B be taken off a list of devices associated with the account, thereby disabling this feature for users of device B. Such as list can be stored with the service provider, or in a public record, e.g., on the blockchain. Lists can express what devices have rights, e.g., a form of whitelist. They may also store what devices no longer have rights, e.g., a form of blacklist. The latter is a form revocation list, similar in principle to a certificate revocation list (CRL). Since device (or wallet) A and device (or wallet B) are already paired, no random user can just request to either access device or wallet A or instantiate the new device or wallet C. Due to the pairing, a first strong level of security is established wherein the user of device/wallet A enables the user of device/wallet B to “access” some of the content of device/wallet A to a certain extent as described above. Further, as the user of device A is notified in one or several ways, the user of device A is given the possibility to deny the request from the user of device B even if the device A is broken. The user of device A may receive a notification by means of an SMS and an email, thus the user of device A is enabled to be informed that the user of device B wishes to e.g., clone device A. Should the device A be broken, this is an opportunity for the user thereof to actually recover device A. Assuming the device or wallet A is broken and cannot respond, then the service provider will interpret this as the user of device A accepts the request from the user of device B. Again, since this requires device A and B to be paired, no stranger or unknown user may possibly steal the content of device or wallet A. A user of a device or wallet, such as wallet A, may indicate that some other devices/wallets may request to be upgraded to full access of all content of wallet A, whereas other devices/wallets do not have this capability. This can be managed, e.g., by a whitelist of wallets that have the capability. This can be stored with a service provider, or in a public storage such as on the blockchain. Changes to this list can be made, e.g., by wallet A and other wallets with full access rights to the content of wallet A, but not by wallets without such access.

Here, an account corresponds loosely to a set of resources associated with a wallet. For example, if wallet A has access to three NFTs and one cryptofund element, then these are in the “account” of wallet A, as they are accessible to wallet A. Wallet A may have been granted play-only access to some content, such as an NFT with an associated movie, by a user corresponding to wallet C. That associated NFT is also in the account of wallet A. Wallet A may be able to grant access rights to some, but not necessarily all, of the content associated with the account of wallet A. In this example, wallet A may be able to grant wallet B access to the three NFTs and the cryptofund element, but not to the NFT from wallet C, as the user of wallet C may have specified that access is limited to wallets it designates, including wallet A.

In one embodiment, one or more low-security wallets collect usage information related to the wallet and optionally to other applications as well, such as a browser or an application using GPS data. Such usage data may be synchronized with a main repository, which may be located with the high-security wallet of the user. The usage data may be used to identify needs and preferences; collect DRM related information for content creators, related to the use of the content they created; determine conversion data for advertisements; and data for health trackers associated with the user. Such data may be synchronized to one or more repositories, and later used to generate one or more user profiles; transmit usage data to content providers and advertisers; automatically fill templates on behalf of the user, and more. The use of templates for privacy-preserving advertisements was disclosed in U.S. Provisional Patent Application No. 63/256,597 filed Oct. 17, 2021 titled “Token Surveys and Privacy Control Techniques” by Markus Jakobsson and Stephen C. Gerber.

Just like a user can be associated with multiple low-security wallets, he or she can be associated with multiple high-security wallets. Wallets can be configured in a hierarchical manner, where access rights are increasingly constrained the lower down in the hierarchy one goes. Wallets can also be configured so that two or more wallets can have the same access rights. Wallets associated with different users can also be associated with each other, e.g., for family members, friends or colleagues to access content with constrained access rights, where the constraints can be controlled by one or more users of one or more wallets.

A user may, using a user interface (UI) such as a graphical user interface (GUI) associated with a high-security wallet, pair one or more other wallets. After two wallets are paired, a user can grant access to one or more items to one of the wallets from the other, using the UI. This may correspond to an indication of one or more elements, such as NFTs, or one or more types, such as elements with audio, or one or more directories. This can be done using an area-based indication of functionality, as disclosed in U.S. Provisional Patent Application No. 63/280,184 filed Nov. 17, 2021 titled “Wallet User Interface for Management of Interaction” by Markus Jakobsson. Other practical UIs are disclosed in U.S. Provisional Patent Application No. 63/293,739 filed Dec. 24, 2021 titled “Graphical User Interface for Complex Token Development and Simulation” by Markus Jakobsson, Stephen C. Gerber, Ajay Kapur and Rebecca Fiebrink. A user may also configure how synchronization of usage information should be performed, e.g., what devices send what types of usage information to what repositories; whether such synchronization is performed while a user device has WiFi access, 5G access, etc.

One way of pairing two wallets is to physically associate them with each other, e.g., place the two wallets on top of each other and swing them back and forth together. Built-in accelerometers will detect the same trace of movements and determine that they are associated with each other. In addition, one or both of the wallets may require a log-in by an associated user. If a wallet is used to store data for multiple users, the choice of what credentials are entered may determine what profiles of the wallets are associated with each other. After two wallets have been associated with each other or two profiles have been associated with each other, a user may provide one or more configurations governing how content accessible by one of the wallets should be made accessible to the other. A wallet with full access rights to an account, such as device D, may pair with another wallet, e.g., one associated with device E, by a user authenticating to device D and requesting pairing with device E. The user would then provide some information about device E in an user interface of device D, e.g., its serial number, which may be expressed as a QR code, a number, or a barcode. The pairing method and the required type of authentication may depend on the level of access rights granted by the user to the new device, e.g. Device E; for example, the higher the level of access is to be granted, the more demanding the level of the authentication may be. Additional policies, such as the time-based challenge disclosed above, may also be used. The policies for the type of authentication and any additional requirements may be set by a user with full access to an account, an admin, or by an organization issuing wallets or devices to its users.

Another way of pairing two wallets may be to log in on both, and then to cause one to display a QR code that is then scanned by the other. Yet another way to pair two wallets is to keep them in proximity of each other, as determined, for example, by the successful transmission of handshake signals over Bluetooth Low Energy (BLE) radios of the two wallets. Here, the handshakes may require a very rapid turnaround between a challenge and a response in order to cause two distant wallets connected by a network to fail to perform the required handshake without causing time-outs.

One aspect of pairing two wallets may be to perform a distance-bounding handshake between the two to make sure that they are on the same local network, such as a Bluetooth network expressed by a master and its slaves, as opposed to being connected to each other over the Internet. Some distance-bounding protocols were described by Brands and Chaum in their 1993 publication titled “Distance-Bounding Protocols”. Versions of these protocols have been proposed and can be used instead. A distance bounding protocol can be used to make sure that two wallets are co-located, in addition to requiring additional conditions to be satisfied, such as conditions related to authentication or approval, as described above.

Yet another way of pairing two wallets is to configure at least one of the wallets, e.g. a first wallet with a secret pairing/configuration password which is different from a possible log-on password which log-on password is used to log on to the first wallet. A user may then pair the two wallets (the first wallet and a second wallet) by logging in to the first wallet by means of the second wallet, this requires that it is possible to log on to a wallet using another wallet. Once the user has logged on to the first wallet using the second wallet, e.g., using a password or biometric data, the user may enter the secret pairing/configuration password of the first wallet, whereby the first and the second wallet become paired. The advantage of this example is that the two wallets need not be physically co-located.

Two wallets may also be paired by entering an address of one of the wallets, such as wallet B, into wallet A. This enables wallet A to provide access rights to wallet B, e.g., by transmitting keys to wallet B that enable access; by conveying an access control list (ACL) to a third party service, and wherein the ACL identifies wallet B and is digitally signed by wallet A. A person of skill in the art will recognize that many variants on the pairing mechanisms are possible, and can be used in isolation or combination. Alternatively, or additionally, a user (let's name her Belinda) may be associated with wallet A by the user or owner of wallet A entering credentials of Belinda into wallet A, optionally together with access rights of Belinda. This enables Belinda to access content of wallet A, whether using a UI associated with wallet A or using the UI of another wallet. Thus, this disclosure also encompasses associating a user with a wallet. Consequently, when it is stated in this disclosure that wallet A is or may be paired with another wallet, this encompasses wallet A being associated with a user that accesses via such another wallet. In this disclosure pairing, synchronising and associating are used synonymously, in the sense of an action taken between two entities in order to establish a first level of security. When in this disclosure it is stated that two wallets are paired, this may also encompass associating a person and a resource. Pairing and associating may, technically, be performed in different ways, but both cause the establishment of a relationship.

Instead of, or in addition to, a pairing/configuration password, the user may first access the second wallet by any type of authentication procedure, then log on the second wallet using any type of authentication procedure. Once this is done, the user is thus logged on to the first wallet using the second wallet. The wallets may be configured such that the user cannot access any or only a very limited amount or type of information of the first wallet. In order to access more, or all, of the first wallet the user may need to identify himself or herself by some biometric data entered into the second wallet, e.g. voice, fingerprint, face recognition. Once such biometric data, or a function thereof, has been sent to the first wallet, the two wallets become paired.

The temporary password can be generated by a third party service, e.g., in the form of a code that is sent to a user's phone and optionally one of the wallets, and entered by the user on the wallets that did not receive it from the third-party service. An example password in this context is a 6-digit numerical code. In yet another embodiment, the two wallets are set in a pairing mode, e.g., by the user selecting such a mode in a user interface (UI) and then exposing both the wallets to the same input, e.g., a sound stream, the scanning of a QR code, or more. The two inputs may be of different types, e.g, one can be motion based and the other sound based; these two are accepted as being consistent if they have a common Fast Fourier Transform (FFT) characteristics, e.g., a greater FFT similarity than a pre-set threshold, in a pre-selected frequency range. For example, one of the wallets may determine sounds and the other motions. The two can be determined to be consistent if one wallet device is used to tap on the other wallet device, generating an accelerometer trace for one of them and a sound trace for the other.

If a wallet is not yet configured to be associated with a user, the pairing action, such as described above, with another wallet that has a registered owner, can be used to also configure the new wallet with the same ownership information, which may comprise the same access credentials, access to the same account (although potentially with different access control levels), and an association to one and the same repository. This is a practical way of rapidly creating backups, introduce new devices to a personal network, etc. To the extent that the two wallets do not have the same sensors or capabilities, alternative configurations may be performed. For example, a first wallet may not have any sensor, but be possible to connect to a keyboard to input a password, whereas another wallet may have a biometric sensor enabling fingerprint scanning. When these two wallets are paired, the same credentials used for access controls cannot be used for both. After the two are paired, they may request a user to provide authentication information. Alternatively, such information can also be provided prior to the pairing.

A wallet B that has been paired with a wallet A can be granted access to some of the content of wallet A. One example of content may be an NFT. The NFT may comprise an encrypted content portion, encrypted using key K1, and for which key K2 needs to be used to decrypt. Here, K1 and K2 may be the same or different from each other. The transfer of ownership rights can require access to a key K3, which may be different from both K1 and K2. By giving wallet B access to K2 but not K3, wallet A can give access to content to wallet B, but not enable wallet B to transfer the ownership rights of the NFT. The NFT may be kept on the blockchain, but may also be stored in wallet A, wallet B, or other locations, to facilitate access when such entities do not have Internet access, for example. There may be multiple encrypted elements associated with a token, such as an NFT, where different keys are needed to access the corresponding functionality.

The upgrading of a wallet, such as wallet B, to full access rights from only partial access rights, can be done in a variety of ways. One of the ways involves cryptographic secret sharing, where wallet B is provided at least a portion of a key after being paired with wallet A, and a remaining one or more portions is kept safely by a service provider used for upgrading of wallets. This upgrading may comprise the increase of access rights to some content. It may also comprise the reduction of access controls. Some access controls may be increased and others may be reduced, while yet others may remain the same. The service provider may be a distributed entity. After a successful upgrade request, e.g., one that results in a time-out or approval, the service provider transmits the one or more portions of the key to wallet B, which then can reassemble all received and kept key portions and generate the secret key or private key associated with full access. This can also be done to upgrade wallet B from a low access right to a slightly higher access right, but not full access rights. Different access right levels may be indicated by possession of different keys, which may be granted access to in the way described above, or alternative ways.

An alternative manner of managing the upgrading of a wallet to higher access rights is to store, on wallet B, encrypted data, where this data may be private keys needed for access, as well as other information useful to access data. However, wallet B does not have the key needed to decrypt this ciphertext, but this is stored with the service provider, which again may be distributed. The key may be specific to wallet B and the upgrading of the same. By the service provider transmitting the key, whether in full or in portions, to wallet B, wallet B is given access.

Yet another approach of assigning and controlling rights is to place a description of the rights in the form of one or more rules and/or policies in a digital rights management (DRM) container, where wallet A and wallet B have access to the DRM container using a DRM engine associated with these wallets. The DRM engine may be part of a trusted execution environment (TEE). Wallet A and wallet B would be associated with different identifiers, such as unique public keys. These public keys are associated with various rights in the container, as part of the rules and policies. The DRM engine would cause a verification of the identity of the wallet, a comparison to the access control list (ACL) expressed by the rules and policies, after which the permitted actions would be allowed while non-permitted actions, if requested, are denied. This approach can be combined with the approach in which private keys governing rights are used, as disclosed above. Such a combination obtains the benefits of both of the solutions, where the control using private keys distributed in accordance of rights create security without a reliance on a TEE while the use of the DRM enables more detailed policies, such as limits on the number of times an element may be used within a given time period.

Some of the portions of a key, as described above, may be derived from authentication data associated with the user associated with wallet B. This may comprise key elements derived from passwords, biometric data, and more. U.S. Provisional Patent Application No. 63/273,921 filed Oct. 30, 2021 titled “Biometric Authentication using Privacy-Protecting Tokens”, by Markus Jakobsson, discloses such methods, which can readily be incorporated in the content described herein.

A wallet can also be downgraded in terms of access rights. One such way is to remove all access rights, e.g., by placing the identifier associated with the wallet, e.g., wallet B, on a revocation list, or by removing it from a whitelist associated with sharing of access rights by wallet A. It is also possible to reduce but not remove access rights. One way to do that is to first remove access rights and then grant a more limited set of access rights, in the same way as limited access rights may be granted after pairing.

A user can utilize the GUI of one wallet, e.g., a wallet with high access rights, to modify the access rights of other wallets to selected content elements, content directories or content types, whether owned by the same user or by associated users. The user can also apply digital rights management (DRM) policies, e.g., specifying when particular content elements can be used by various users or wallets, how many times, and any relationships between access rights. For example, one user may be allowed to access either content element A or content element B, but once one of these has been accessed, the other one cannot be accessed by this user. This is a useful type of access control in the content of gamification of content. Other such policies can be formulated by a user with access rights to the creation of or modification of such policies.

Wallets may be arranged in a hierarchical manner, based on the role of the user instead of, or in addition to, the security of the device. For example, a wallet associated with a parent may keep a large number of content elements, and a user of this parental wallet may selectively grant a user of another wallet, which we refer to as the child wallet, access to elements. This access may be full, or it may be partial. Full access includes all the rights associated with the parental wallet, and partial rights correspond to a lesser degree of rights, e.g., not the right to sell the element or to otherwise transfer ownership of it, but still the right to render or use the item. A user of the parental wallet, e.g., a parent, may grant time-based access to elements, base access on conditions such as the total screen time per day, whether an action has been completed, etc.

In one embodiment, a wallet is provided with access rights to one or more elements associated with another wallet. With the access rights that are provided are associated a reporting requirement that causes the wallet provided access to generate a log comprising access information and transmit this log to a designated party, which may be the provider of the access rights or a service provider associated with this party. The logs may be anonymized in that they do not disclose what particular item was accessed, but only that one of the elements that was granted access to was used. It may also not be anonymized, and comprise information about the element used; what portion, if applicable was rendered or otherwise used; any actions that were taken on the content, such as turning on subtitles or watching it in slow motion. Insights related to the usage of the content may be provided to the party providing access. The logs may be provided to a service provider that is associated with the content provider, where the service provider generates insights for a content creator, content distributor or content curator associated with the content. Such insights may comprise identifying information related to what user(s) accessed the content, but may also be anonymized and instead provide general demographics associated with the users of the content, when known or estimated by the system, and if requested by the recipient of the insight data.

In one embodiment, one of the wallets may reside on a device that also serves as a component of a distributed ledger technology system. For example, a proof-of-space blockchain is suitable for operation on a smartphone whereby the smartphone participates in the consensus mechanism of the blockchain network itself. A user operating both the blockchain and the wallet may determine that the smartphone is either an ideal situation for a wallet with or without transaction privileges depending upon their risk appetite versus having a wallet interact directly with a blockchain node on a single device where such a direct interaction may improve security.

In a typical embodiment, most of the content associated with a wallet is stored on one or more blockchains. The wallet may have addresses associated with the contents, e.g., a list of what content it is associated with, and where it is located. The wallet also has at least one key, such as a private key, which is used to access the content, e.g., transfer ownership rights to the content. Additional keys can be held by the wallet, e.g., for decrypting content or portions of it. In addition, a wallet may store content on the wallet itself as well, e.g., locally made copies of data stored on one or more blockchains. One reason to do this is to be able to access the content without having to rely on being able to access the blockchain on which the content is also stored. If wallet A shares access to some of the content associated with it to wallet B, wallet B may store other portions locally than what wallet A does, including all of the content accessible to wallet B, none, or somewhere inbetween. In addition, wallet A and/or wallet B may also store locally data that is not already stored on the blockchain, e.g., configuration data, personal data, parameters used to determine how to render content, data corresponding to a user's preferences, etc. Wallet B may receive access rights to content from multiple wallets, which do not have to be associated with each other. For example, wallet A may be paired with wallet B and then share access to content with wallet B; independently of this, wallet D may be paired with wallet B, and share content with wallet B. Wallet B may share some content with yet another wallet, after pairing with it. Content that wallet A has shared with wallet B can only be shared by wallet B to another wallet if the permissions governing the content shared by wallet A allows such re-sharing. Such permissions may be expressed in the form of policies, which may be evaluated using DRM environments, which may run in TEEs.

A user of a wallet, such as wallet A, can access a list of what wallets have access rights to content, what the access rights are, what the content is, and what the recent usage of content has been. For example, using a user interface (UI) associated with wallet A, a user logged in to wallet A may determine that NFT A is only accessible from wallet A, and wallet A has full access rights, whereas NFT B is accessible both by wallet A and wallet B. Wallet A has full access rights to NFT B, and wallet B, and any user thereof, has play-only access to the content of NFT B. NFT C is owned by a third wallet, wallet C, and wallet B has play-only rights to it, where these play-only rights are limited to one play per 24 h period. NFT D is owned by wallet A, and accessible by user Alice using wallet B, user Bob using wallet B, and user Cindy using any wallet that can verify that it is Cindy that is accessing, e.g., based on a biometric token associated with Cindy and that is matched by an input provided by the user. Dave may be a user of wallet B, but he has no access rights to NFT D. Thus, the access rights may specify a wallet, a user account or a token tied to a user identity, etc. The access rights may have an extent, e.g., “cannot provide access rights to other users”, “can transfer ownership rights”, “can be upgraded to full access under specified conditions”, etc. The access rights can be visually expressed, e.g., as disclosed in U.S. Provisional Patent Application No. 63/280,184 filed Nov. 17, 2021 titled “Wallet User Interface for Management of Interaction” by Markus Jakobsson, wherein different areas of the screen may be associated with different access rights, different users, different wallets, or a combination of such properties.

The methods described herein may be implemented as respective computer programs being executed by processing means in respective physical entities that perform the respective methods.

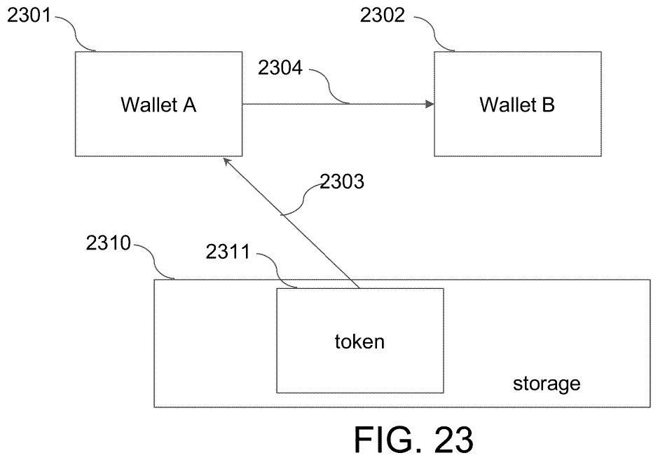

FIG. 23 illustrates two wallets, wallet A 2301 and wallet B 2302. Wallet A 2301 has access rights to token 2311 stored in storage 2310, which may be a blockchain. The access rights are indicated by connection 2303. Wallet A 2301 grants access rights to wallet B 2302, to one or more resources such as token 2311, after having been paired with wallet B 2302. The granting of access rights is indicated by connection 2304.

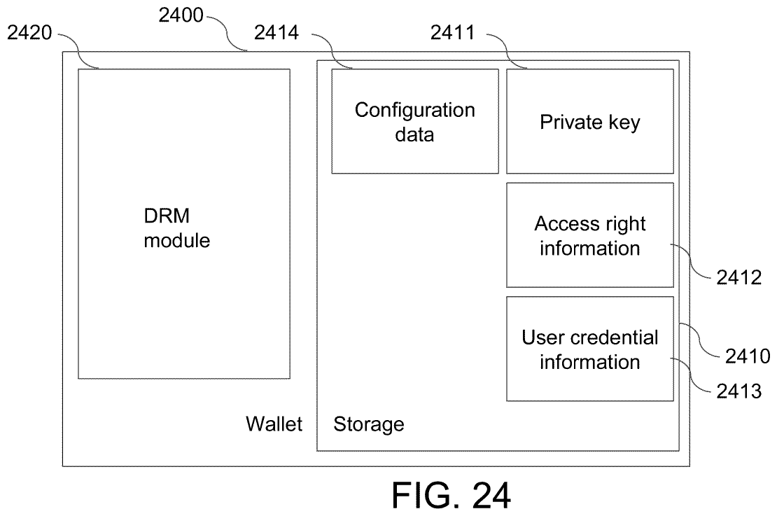

FIG. 24 illustrates a wallet 2400, such as wallet A 2301 or wallet B 2302. Wallet 2400 comprises or is associated with storage 2410, comprising at least one private key 2411, access right information 2412, user credential information 2413 and configuration data 2414. The private key 2411 is used to perform actions on resources, such as token 2311. Example actions comprise decrypting content associated with token 2311; proving access rights, to a digital rights management module, to data associated with token 2311; initiating a transfer of ownership of token 2311; granting access to another wallet (not shown) to token 2311, etc. Access right information 2412 may be a list of elements that the wallet 2400 has access to, e.g., token 2311, and a description of the type of access, e.g., the right to transfer ownership of token 2311, the right to play content associated with token 2311, the right to use token 2311, etc. These different rights can be governed by different cryptographic keys used to initiate actions, e.g., decrypt, digitally sign, perform zero-knowledge proofs, etc. The available rights may also be determined by a digital rights management (DRM) module 2420 of wallet 2400, in which case access right information 2412 may be digitally signed, e.g., by the party granting access rights to wallet 2400. That digital signature may be verified by the DRM module 2420 before initiating an action corresponding to the access being requested. User credential information 2413 may comprise hashed passwords, PINs, biometric credentials, etc. They may be stored in a manner that are only accessible to approved devices, e.g., encrypted using a key whose corresponding decryption key is held by trusted hardware of such devices. In one embodiment, the encryption key is the same as the decryption key, i.e., constitutes a symmetric encryption key. Such information may be stored in a trusted execution environment (TEE; not shown). In other embodiments, asymmetric cryptography is used, and the encryption key is different from the decryption key. The user credential information 2413 is used to authenticate a user wishing to use the wallet 2400. Configuration data 2414 may comprise parameters and variables used to indicate user preferences, including aspects of the user interface presented to the user when the user engages with wallet 2400, and a state, e.g., data that indicates what items may be played halfway, what items are listed as being for sale, etc. DRM module 220 may comprise code and parameters used for performing sensitive transactions for the wallet, and may require the use of the TEE to execute. The TEE may be associated with keys used to enable the DRM module 2420 to perform actions on data stored in storage 2410 of wallet 2400. An example of a TEE is ARM(™)'s TrustZone(™).

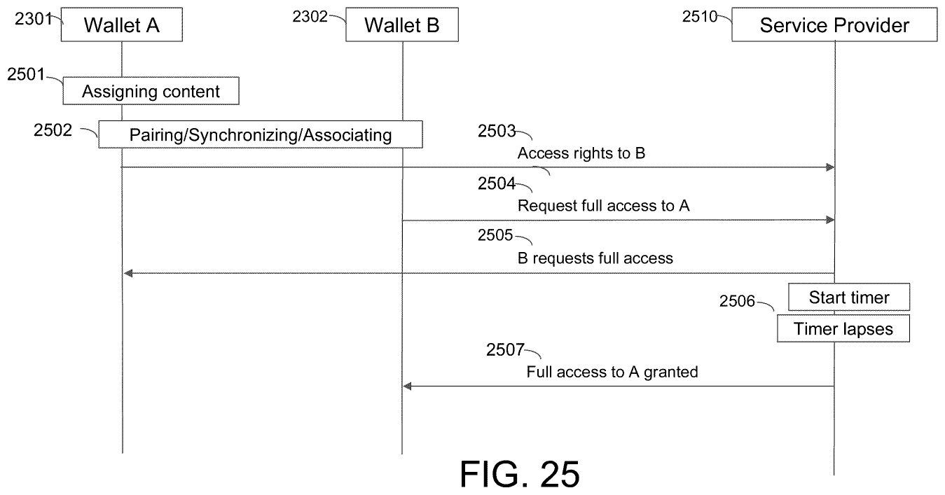

FIG. 25 illustrates the recovery of lost data. In step 2501, a user assigns content to wallet A, e.g., by purchasing, minting or mining. Wallet A has full access to these contents. In step 2502, the user pairs wallet A and wallet B, this is described in detail herein and is also referred to as associate wallet and wallet B. In step 2503, the user uses an interface associated with wallet A to grant access to content of wallet A to wallet B. The granting of access of wallet A to wallet B may comprise sending a signal to a service provider and/or sending the signal directly to wallet B. This access may be partial, e.g., not allowing any transfers of ownership, but only giving read access to contents as described and exemplified herein. In step 2504, the user, using a user interface associated with wallet B, requests full access to the content. This causes a request to be sent over a communication channel associated with wallet A, as indicated in step 2505. In step 2506, it is determined that there is a timeout or an approval for wallet B to gain full access. In FIG. 25, only a timeout is illustrated, however, this may alternatively be a signal/message sent from wallet A to the service provider indicating approval. In step 2507, wallet B is given full access to the contents previously associated with wallet A.

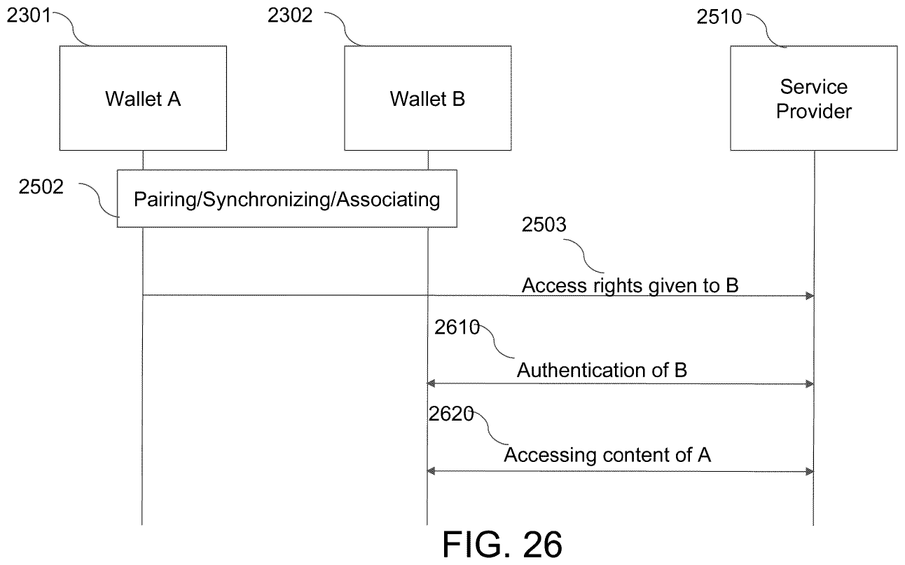

FIG. 26 illustrates an example of a method for wallet B to access content of wallet A. FIG. 26 is a signalling diagram between wallet A 101, wallet B 102 and service provider 2510. Just as described in FIG. 25, wallet A and wallet B are paired in step 2502. This creates a first strong level of security as only a wallet that is paired with A may possibly be given access to the content of wallet A. It may also be indicated whether wallet B is eligible for getting upgraded access to content. Only wallets for this is indicated can later request full access to the content. A user of wallet A may indicate that wallet B, also owned by the same user, may have this capability, but may indicate that wallet C, which is owned by an acquaintance, does not. The user of wallet A is still willing to share play-only access rights to some content to the acquaintance, though.

Once wallet B is paired with wallet A, wallet A indicates, to the service provider, what access rights it assigns or gives to wallet B with regards to the content of wallet A, step 2503. When a user of wallet B wishes to access any content of wallet A, wallet B may first have to be authenticated by the service provider, step 2610. The authentication of wallet B is described and exemplified above. It is pointed out that this may also be needed in FIG. 25, but has been left out in order to not make FIG. 25 too cluttered. When wallet B has successfully authenticated itself to the service provider, wallet B may access the content of wallet A, step 2620, in accordance with the access rights given in step 2503.

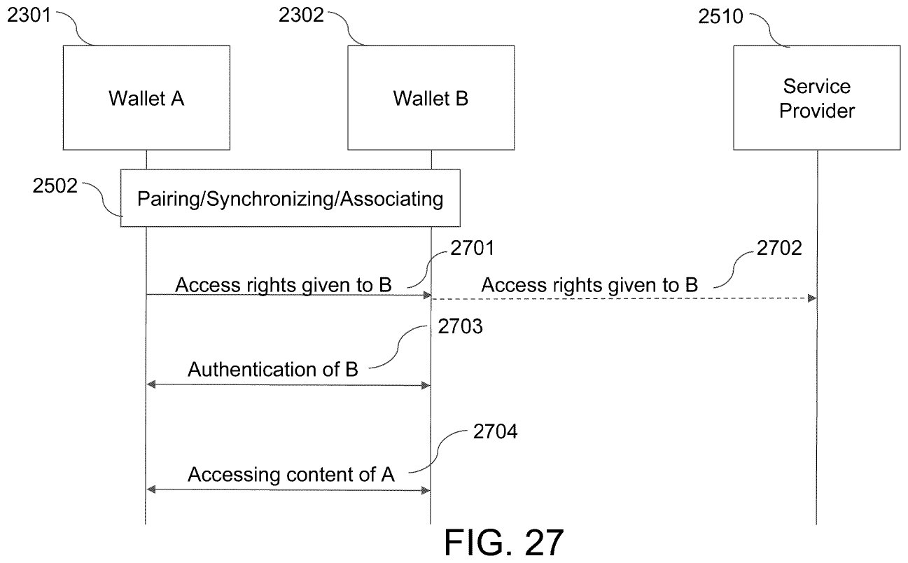

FIG. 27 is a signalling diagram of an example of the method disclosed herein. In this example, wallet A and wallet B first perform a pairing in step 2202 as described above. In step 2701, wallet A informs wallet B of access rights that have been assigned to wallet B. This is done by sending a signal comprising such information to wallet B. FIG. 27 also illustrates an option that either wallet A or wallet B may inform a service provider on the access rights having been granted to wallet B from wallet A, step 2702. In step 2703 a user of wallet B wants to access content of wallet A so the user performs an authentication process as described above in order to gain access to the content of wallet A. Once such access is granted, the user of wallet B may access content of wallet A in step 2704.

### Chameleon User Interface Method

The disclosed technology may be implemented as a wallet that is used to store configurations related to one or more experiences. Example experiences include but are not limited to the UXes of an in-car infotainment system; a thermostat of a hotel room; a touch-screen based menu in a restaurant; a direction providing system in a train station in a foreign country, etc. The wallet may be implemented as an application running on a mobile device, such as a cell phone or a pair of augmented reality {AR) glasses with processing capabilities.

A first user system may be represented by a touch screen, or by a panel with switches and levers, for example. It may have an audio feedback element in which the changing of a setting causes a sound to be perceived by the user. It may have textual or graphical indicators, and these may be associated with a language, and/or with a measurement system such as the imperial or the metric system. Its visual elements may appear at a particular size and in a particular colour palette or level of contrast. Interactions with this interface may entail direct interaction with onscreen widgets such as buttons or icons, or direct interaction with physical inputs such as buttons or knobs, or gestural interactions such as swiping “up” on a screen to see a main menu and swiping “left” to go “back,” or voice interactions that entail particular conventions such as phrasings or that are accessible in a particular language and accent, or other forms of interaction. The system is also associated with a set of capabilities, corresponding to the available controls that it governs, and with a layout specifying the relative location of various aspects. The type of the system is associated with the capabilities it has; for example, a thermostat may enable the setting of temperatures whereas an audio system may enable the setting of audio sources and volumes. There may be temporal aspects, e.g., one display being replaced by another display on a touch screen in response to the receipt of an input by a user. The described system may enable the sizing of interfaces, such as font sizes, such that an aging user does not struggle when attempting to view options on an interface. A user with a preference for one font over another may set that preference.

A second user system may be represented by a touch screen or another reconfigurable system, such as a virtual reality (VR) rendering system. The second user system has a type and an associated set of capabilities.

A translator system, which may be part of the first user system, the second user system, or a third-party element such as a wallet. The translator system identifies the presence of a user; determines the presence of one or more second user systems (which we will also refer to as the whitelabelled systems) and determines whether the user has a UI/UX preference of relevance to the capabilities of the one or more second systems, where such preferences may be expressed in the form of one or more first system configurations associated with the user. The translator then conveys information to the second system to cause it to be reconfigured in accordance.

with the preferred first system of the user, which we also refer to as the preferred system. Alternatively, the translator conveys information to an output system associated with the user, such as a headset or a pair of ARNR glasses, to present a UI and UX associated with the capabilities of the whitelabelled system, configured in accordance with the preferred first system most closely matching these capabilities. The translator system causes the whitelabelled system to act in a manner similar to a chameleon: it takes on properties, including visual properties, of another system, associated with the observer.

In one example situation, there is no one-to-one mapping between the whitelabelled system and a preferred system. The translator system determines whether any of the candidate preferred systems that partially map to the whitelabelled system, and then determines which one if multiple candidates remain. The determination may be based on asking the user to state a preference, which can be saved for future use, or it can be based on the preferences stated by a majority of other users of a type that the user previously has configured her system to use as a guide if there is need for tie breaking. Another approach for determining the best match uses a machine learning (ML) module that compares the available capabilities of the whitelabelled system and the candidate systems along with the associated usage scenarios, e.g., to select the best match based on a similar usage scenario.

A selected preferred system and the associated whitelabelled system may not have the same capabilities. For example, the whitelabelled system may not have a feature that the preferred system has, e.g., a seat cooling capability. The controls for seat cooling can still be rendered to the user, potentially in a manner that indicates that this feature is not present, such as being greyed out as opposed to being in color. The whitelabelled system may also have features that are not present in the preferred system. These can be presented in a manner that is logically consistent with the preferred UI/UX, e.g., as determined by an administrator, an ML module, by the common choice of users indicating a preference, etc. These features can also be hidden if the user has configured the system to not show new features. Hidden features can still be accessed, e.g., by the selection on the presented UI of an option to show hidden features, which can be toggled back and forth. Thus, the presented UI may have controls, such as this toggle, that are not present in the preferred system.

The disclosed system enables one user to access features using a native UX/UI, e.g., the UX/UI that would be presented in the absence of the disclosed technology, but which also enables another user to access features using a non-native UX/UI, e.g., one associated with the preferred system. In some instances, this is provided for free, whereas in other instances, it requires a subscription. This subscription may correspond to the rights to use the intellectual property, e.g., user interfaces, of the preferred system on hardware that does not correspond to such a manufacturer, and would be paid to a party associated with these rights. The payment can be made either on a per-use basis, e.g., by the user wishing to use his or her preferred user experience, or by a party associated with the whitelabelled system. Payments can also be made a priori, e.g., in the form of a life-time right to use a particular interface on a given whitelabelled system. The preferred system may not correspond to any hardware manufacturer at all, but may be developed independently by a third party provider focusing on UI/UX, who may introduce the system to consumers and delight them enough for the consumers to set it as their preferred system. Some providers may set the royalty for their UI/UX very low, or at zero, but require to receive profile or usage data from the consumer as a form of payment, or for the consumer to periodically watch advertisements. Thus, the royalty is only one monetizing aspect of the arrangement. The wallet may control the disclosure of data, the timing of advertisements, and more, in a manner that protects the user while agreeing to the terms of use associated with the selected preferred system.

The rights to use a given UI/UX may be controlled by a digital rights management element associated with one or more of the components, such as the translator or the whitelabelled system. Rights may be expressed in the form of non-fungible tokens (NFTs) or other policy-holding containers, where these rights may be stored by a wallet on a cell phone, e.g., in a partition or space associated with user preferences, where this space may be access controlled to limit the manners in which it can be read from or written to so that the user does not have his or her preferences tampered with, e.g., by malware or by a malicious process that switches users over to a preferred system associated with a malicious party that wishes to receive royalty payments for the use of its UI/UX or wish to modify the user experience of the victim user to include advertisements that the user has not agreed to view.

The rights to perform a translation to impose on a whitelabelled interface a preferred interface, along with a specification of how to perform the mapping, may be expressed in an NFT. For example, the mapping may be expressed as one or more rules, and the rights to use a particular mapping may be expressed in a ORM-protected policy. This policy may identify the conditions of use, including on what types of devices a mapping may be performed, whether a fee needs to be paid, and if so, to what entity. The NFT may also comprise or reference graphical and audio elements that are used to configure the whitelabelled interface to appear in a manner expressed by the NFT. Such an NFT may be evaluated by the wallet in order for the wallet to direct a device associated with the whitelabelled interface in terms of what mappings to perform. Alternatively, the wallet may convey the NFT to the whitelabelled interface for the latter to evaluate the NFT and perform the associated mappings. At the same time, one or both of the wallet and the entity associated with the whitelabelled interface may perform logging of the events associated with the translation, where such log entries may be used for bookkeeping purposes; to determine what translations are most popular and/or appropriate in a given setting, and to determine the fit between the context and the mapping, e.g., by determining the duration during which the modified interface is used, and whether this is anomalous. In some instances, the usage requires the presence of the wallet or another indicator of user presence. In some instances, one NFT used to convey mapping can only be used in one location at a given time, or may only be used concurrently up to a threshold number of times. Some NFTs may have limits on how often or how long a given interface may be used, e.g., a trial version may only be used for a duration of one day or only for non-interrupted periods of up to 30 minutes. Such limitations may be expressed in rules or policies associated with the NFT, and may be verified to be in compliance by the wallet, the whitelabelled interface entity, or a third party entity collecting logs from the usage of the NFT.

In one embodiment, a mobile device of a user is used as an interface in the presence of a whitelabelled system that does not have the capabilities to render the preferred system interface properly, or in response to a user setting a preference indicating that he or she wishes to use the mobile device as an interface. In one example, a rental car has a QR code visible next to the steering wheel, allowing the user to scan the QR code and render one or more controls associated with the rental car on the phone, and where these systems are rendered in a manner that is consistent with a user selection. For example, the user may drive a 1995 Ford Taurus(™) at home, and may be renting a 2019 Kia Soul (™). He may prefer to render the heating and cooling controls in the rental car as if they were his home car. In one situation, he may prefer to render the interface on his phone rather than on the touch screen of the rental car, and in another, he may prefer to use the rental car touch screen. Another user may be used to driving a 2019 Kia Soul (™) and then borrow the first user's 1995 Ford Taurus (™) Since the latter does not have a touch screen, this user has the option of using the native controls in the borrowed car or, if the car is configured to have a car-to-device interface allowing receipt of signals from a mobile phone, the user can use his phone to control the borrowed car's heating and cooling system, in a manner consistent with the car he is used to driving. Similarly, the user's preferences for GPS mapping addresses, contacts in their mobile device, calendar or event information may be useful for configuration of a vehicle's interface and preference control among the various features of the vehicle. A user's wallet may contain data that indicates preferences such as for what restaurants, and these preferences can be expressed on a GPS map as an area is being rendered. For example, a restaurant that the user is likely to enjoy may be highlighted, based on reviews of these restaurants and reviews of the restaurants the user has experienced and/or reviewed. A prediction can be made using a machine learning (ML) component trained on past user preferences, whether expressed in form of repeat visits, reviews, or in other ways. Repeat visits can be determined by the wallet, e.g., by determining SSID hotspots, GPS locations, etc.

A user staying in a hotel may have his or her temperature preferences stored in his or her wallet, allowing the wallet to convey these to a local thermostat. The user's thermostat UI/UX preferences may be conveyed as well, making the thermostat appear like, behave like, or otherwise correspond to the user's preferences, as indicated by the configurations stored in the user's wallet.

The user's wallet is a representative of the user, and observes the user's preferences and settings. For example, if the user engages with a thermostat, whether with or without the use of the translation technologies disclosed herein, then for compatible thermostats, the wallet connects and obtains information about the settings of the user, and stores these. Here, a secondary system, such as a thermostat, is compatible with the wallet if it allows the latter to connect and enables the exchange of information. This way, a wallet can become a rich repository of user preferences. After a consistent profile can be established, the wallet may start suggesting to apply stored or interpolated settings to systems in the surroundings of the wallet. The wallet may determine that a user has multiple personae, such as the preferences when he or she appears to be alone vs. the preferences when he or she is in a work environment; with a known other user; with an unknown other user, etc. Here, another user is known, for example, if the other user's wallet is repeatedly recognized to be present by a first user's wallet, or if the two pair their wallets, associate their wallets to their social media profiles and then connect over social media, etc. For example, a user may like to play rock music very loud when alone, but instead play soft jazz music at a low volume when around colleagues. The wallet may set the volume of a nearby speaker, and suggest a genre to the user.

The profile the wallet generates for a user can be used to determine user preferences, and to select advertisements. For example, shopping carts in a grocery store may determine, e.g., using NFC or Bluetooth Low Energy (BLE) technology that a user wallet is in its presence in a consistent manner, i.e., is likely associated with a user of the cart and not another shopper passing the user. A processor associated with the cart causes a connection with the wallet, using a radio, and queries the wallet for a preference, e.g., among ten different product types, receiving a response corresponding to the wallet's recommendation of what the user may prefer. The selected advertisement may be shown on a small screen attached to the handlebar of the cart. The advertisement may play in a loop until the user indicates whether he is interested in a discount for the product or not. The set of advertisements that can be selected from, by the wallet, may depend on the location of the cart, e.g., products in the aisle where the cart is located can be conveyed to the wallet to choose from. As a user enters another aisle, another request may be sent to the wallet, and another selection made. A user that employs his wallet to store or convey a shopping list can be given discounts and/or directions to store locations after receiving a copy of the shopping list. Further, if a user employs his or her wallet to store a shopping list, a display on the shopping cart or on the user's device, e.g., his or her cell phone, may display a route through the store for the user to take in order to quickly find all the items on the shopping list. Additionally, or alternatively, the route may be displayed such that the user may pass other items in different isles that the user relatively often also buys based on information of a user profile stored in the wallet. Further, those other items may be derived from information, e.g., using ML or AI, that other users, buying similar or the same items that the user has on his or her shopping list, bought. In another example, one or more items (e.g., juice, diapers, toilet paper) on the shopping list may be associated with a specific brand that the user usually purchases. Advertisements may then be presented to the user with offers on other brands, e.g., store specific brands that will generate a greater profit for the store, for the items on the shopping list. In this manner the user may purchase e.g., a packet of juice of another brand than normally and by doing so, the store may earn more money and should the packet of juice of this other brand be less expensive than that of the brand the user normally purchases, also the user may benefit economically from purchasing the brand that is being advertised.

A user may enter a location in a car navigation system, e.g., using a translated interface. The wallet may receive a copy of the address, and determine that it corresponds to a business that will be closed by the time the user arrives at the location. The business may be a steak restaurant, for example. The wallet may determine, based on the user's stored preferences, and potentially based on whether the user is alone or in the company of others, what restaurant the user may prefer and which is in the same general area, and then convey this suggestion to the navigation system that may present the information to the user, e.g., the first restaurant being closed and the proposed restaurant being open. The user can then opt to keep the old navigation request, i.e., to the restaurant that will be closed when the user gets there, or switch to the proposed alternative. Multiple alternatives may be given, and some of these may correspond to promoted businesses. Some of the alternatives may have specials or coupons, and this information can be conveyed to the user in the navigation system interface or in an interface associated with the wallet. A user may own NFTs or other content, which may be stored or referenced by his or her wallet, where the NFTs or content provide the user with a discount, special offer, etc. This information can also be provided to the user in the interface.

The user may enter the address of the steak restaurant in the navigation interface, or select it using a voice-driven interface associated with her wallet, for example. Whether the steak restaurant is open or not, the user may be told that a block away there is a competing steak restaurant that has given the user a 10% discount NFT that the user stored in her wallet, asking the user if she wants to go to the alternative restaurant instead of the user-requested restaurant.

In one embodiment, one user is associated with multiple wallets, which may be associated with different form factors, different security levels or different primary uses. Examples of form factors include a smart watch or a smartphone. Example security levels may be associated with the risk associated with the device, e.g., a low risk for devices that do not allow apps to be downloaded, or only in a restricted manner, whereas high risk devices will allow users to install apps without the same restrictions, which may be dictated by an employer. Example primary usage scenarios include a music player or an enterprise laptop used for text editing. Two or more wallets associated with one and the same user may synchronize at least some of their data with each other. A user may express preferences to whitelabelled systems using any one of these wallets. The wallets would know that they are associated with the same user, e.g., based on being paired. Pairing is disclosed in U.S. Provisional Patent Application No. 63/300,202 filed Jan. 17, 2022 titled “Dependent Wallet Technology” by Markus Jakobsson and Stefan Dufva.

In one embodiment, user interfaces that we may refer to as generic user interfaces may be created by content creators, and tested, as other content can be tested, on one or more target groups as disclosed in U.S. Provisional Patent Application No. 63/304,759 filed Jan. 31, 2022 titled “AI-Guided Content Style Feedback” by Markus Jakobsson, Rebecca Fiebrink, and Stefan Dufva. The most favored version determined by such a system may be marketed to users of one or more target groups. Different demographic groups may be provided different versions, where two versions may differ in terms of the skin, the functionality, the layout, the capabilities, or any combination of these aspects.

The generic user interfaces may be marketed as potential preferred systems, allowing end users to purchase or subscribe to the right to use the associated interfaces by means to the translation methods disclosed herein, and variants of these.

Some preferred systems may be free for users, but require usage log information to be generated and reported to the creator of the associated user interfaces, in lieu of or in addition to payments, where payments may be purchases, subscriptions or other methods of licensing the rights. The reporting of use may be partially or fully anonymized, or not anonymized at all. An example of a partially anonymized form of reporting is to provide a location of use and a demographic profile associated with the user or a wallet, but not a username or other unique identifier. Users may be provided with different licensing plans, where two licensing plans may have different anonymization methods, if any, different costs of use, and more. Some licensing plans may require per-use payments whereas others may have a flat rate, for example.

Reporting of preferences, configurations, usage statistics and more associated with translations and content use involving a first wallet associated with a user may be provided to a second wallet associated with the same or related user. For example, a user may use his or her smartphone or smartwatch to cause the translation of user interfaces, and have information associated with usage reported to his or her wallet on a home laptop, which may also collect usage information from a 1V remote controller associated with the user or any other device used to initiate or perform the translation of user interfaces or user experiences. The reporting of usage information enables optimization, e.g., of subscription plans. It also enables provision of recommendations based on the frequency or type of use, e.g., replacing a password-entry aspect of a preferred system with a biometric authentication method as the primary user authentication method. This can be proposed for users that appear to make many mistakes entering the password, or who use the system so rarely that they are at risk of forgetting their passwords.

In some embodiments, multiple users are associated with one device comprising a wallet. By detecting the identity of the user, code associated with the wallet may select one out of several associated wallets to be given access to. These wallets may correspond to different access rights of the associated users, as disclosed in U.S. Provisional Patent Application No. 63/300,202 filed Jan. 17, 2022 titled “Dependent Wallet Technology” Markus Jakobsson and Stefan Dufva. The wallets may also cause different selections of translations, as different users of the same device may have different preferences. A user may identify himself or herself to the device and/or code associated with the wallet by use of a username and password, a PIN, biometrics, etc. The identification may be done, for example, by detecting a facial likeness between a user and a previously registered user. The selected wallet reflects one of a multitude of profiles, each user corresponding to one or more profiles. A user may have one profile corresponding to her preferences when being with friends, and another when being at work. The user may indicate, when accessing the wallet, what the persona is, or this may be determined automatically, e.g., based on location, background sounds, applications being used, user interface types being started, etc. When a wallet is being used for a translation, a reporting of its use may be performed as described above, and may indicate the persona of the user associated with the use. Additionally, or alternatively, in an example where the wallet is comprised in a handheld device such as as smartphone, the wallet may automatically detect different known or unknown WiFi-networks the device is currently connected to and thus automatically determine to some degree, when the WiFi-network is a known one, that the user is at work, at home, at a friend's house etc.

The rendering of a user interface may depend on a determination of the presence of a user and a determination of the likely identity of the user. For example, a terminal, such as a touch screen of a thermostat, may determine that there is a user present, e.g., using a motion sensor, and determine, based on a built-in or associated camera face capture technique that it is a user we refer to as Bob who is in front of the terminal, and may then render the user interface associated with Bob. If a person is detected but no determination can be made of who it is, then the terminal may request identification or may render the most recently rendered UI or the most commonly rendered UI for the specific terminal. Identification may be performed in many ways. For example, the terminal may be associated with a Bluetooth Low Energy (BLE) transmitter that detects a smartphone associated with a user Cindy, thereby determining that the user in proximity is likely to be Cindy. If there are two or more radio-enabled devices in the presence, one that is normally more strongly tied to a specific user (such as an Oura(™) ring) may be given higher priority when determining identity than one that has a weaker association to identity (such as a remote control or a shared tablet computer.) Tie-breaking can also be performed using additional sensors (such as a camera). If a set of connected sensors determine the identity of a user in one location, then in another, and then in a third, then a fourth location that is on the typical path from the first, second and third location may be associated with the same user as soon as a user is detected, and even if there is not positive determination of identity.

Thus, the determination of the persona, or identity, of the user may be probabilistic and based on a series of related observations from one or more sensors. In a similar example, a user Mona gets into the driver seat of her family car. With her is her husband Martin who gets into the passenger seat. The car may detect the presence of both Mona and Martin and, assuming they have different UI preferences, the car may display Mona's preferred UI on one or all displays of the car. Assume the car has an infotainment system with an interactive touch screen at the passenger seat, then the screen of the infotainment system may display the UI preferences of Martin as he is in the passenger seat.

A terminal may be associated with multiple functionalities. For example, one terminal may be primarily used for controlling the lights in a room, but can also be used to control the temperature in a room, e.g., work as a panel for a thermostat. This ability to take on multiple functionalities may be a property of the preferred user interface, as selected or configured by a user. It may also be a property of the terminal used. A user may know that performing a circular swipe on a terminal enables a selection of the available control interfaces, e.g., from a menu, where the items on the menu may be represented using text or graphical icons, for example, and where the ordering of selectable user interface functionalities may be fixed, configurable by a user, or determined based on what interface uses are most frequent for a given user in a given location, e.g., rendering common options first or in the most prominent manner.

The system may generate a log of user locations and user actions. This may be transmitted to a wallet associated with the user, and used to optimize the user experience. For example, if a user always turns on the lights when entering a given room, except when there is a sleeping person present in that room, then the system may determine, based on historical uses, that the user wants to switch the lights on when entering a room and do so automatically for the user, after detecting his or her presence. A user may be offered to opt in or opt out to this automation service, whether on a per-terminal basis, per-user basis, or using another rule.

A wallet may collect usage information to enable improved user experiences for the user of the wallet, while protecting user data from local network nodes such as sensors, terminals and other functional infrastructure components. The wallet may present, to a terminal, a request indicating what user interface to use, but without disclosing the user identity. Thus, instead of the system configuring itself to adapt to the perceived and expressed needs of a user, the wallet may determine the likely preferences, perform configuration, and convey selections, e.g., of preferred user interfaces and other configuration values, to infrastructure nodes. These infrastructure nodes may be stateless in the sense that they do not need an awareness of the user's past behavior and preferences; instead, they receive selections from the user's wallet, whether selected by the wallet on behalf of the user or selected by the user. This way, the disclosed system can protect the user's privacy. At the same time, infrastructure nodes or associated service providers may request usage information, demographic information, and more, whether as a condition for service, to comply with a pricing plan for service; or in order to improve their offerings, and potentially on a voluntary opt-in basis. This flexibility is a great improvement associated with the disclosed technology in comparison to existing technology and its underlying paradigms.

A user may have the option to determine to what level personal information is to be revealed, by means of his/her wallet. In one example, the wallet only provides non-personal parameters to the translator, wherein the identity of the user is protected. This may be fully adequate in many situations and circumstances. In other situations or circumstances, personal parameters (representing personal information) may be needed in order to provide a better UI experience by the user. The user may indicate to what level personal parameters may be disclosed to the translator, e.g., the user may first indicate no personal parameters and discovers that the UI experience is not satisfactory. If so, the user may indicate that a first low level of personal parameters may be disclosed to the translator. If the UI experience is still not satisfactory, then the user may indicate a second, higher, level of personal parameters may be disclosed until the user decides that the UI and/or UE is good enough. The user may also be provided with examples or demonstrations that illustrate the differences in UI/UX based on the levels of provision of personal data, where the examples or demonstrations may be in the form of illustrative screenshots with markups explaining features, or video clips that may be narrated.

For example, two privacy settings and their impact on UI/UX may be presented next to each other.

In another example, the user checks into a hotel and may (as described above) control e.g., a thermostat of the hotel room or a television set. The user may indicate that no personal parameters may be disclosed for one or more items of the hotel room or that different personal parameters may be disclosed for different items of the hotel room. The user may have the option of disclosing more personal parameters than actually needed for a satisfactory UI/UX, for the benefit of cost reduction, promotion, ad campaigns, etc.

In an embodiment, this disclosure relates to a method, which may be performed by a device or a processing arrangement in the device, e.g., a translator as described above. The translator may be one physical device or it may be distributed into several devices and/or nodes. Merely as some illustrative and non-limiting examples, the translator may be comprised in a user device, a node in a network, in a cloud server, a target device e.g., such as referred to herein as a whitelabled system, a wallet, or any any combination thereof.

In an example, the method comprising obtaining information pertaining to preferences of a user with regards to user interface and/or user experience. The information may thus pertain to a user preferred UI/UX as described above. Merely as an illustrative and non-limiting example, the information may be obtained from a wallet of the user as described herein.

The method may also comprise obtaining information about a whitelableled system, the information pertaining to e.g., functions, options, interaction possibilities, user interface etc. of the whitelabeled system. This may be done in several ways. Merely as illustrative and

non-limiting examples, the device may query the whitelableled system about information about its capabilities regarding UI/UX, the device may query the whiltelabeled system about specific UI/UX information based on the information obtained about the user, the device may receive this type of information automatically e.g., when connecting to the same WiFi-network or when connecting by means of any short range communication techniques such as Bluetooth.

The method may also comprise matching/translating/processing the information obtained from the whitelabled system in order to present the obtained information to the user in accordance with the obtained pertaining to preferences of a user with regards to UI and/or UX. In an example, this may be done using ML or AI, as well as other data processing actions.

The method may also comprise rendering the presentation of the matched/translated/processed information to the user. The information may be presented to the user e.g., on an interface of a device of the user or on an interface of the whitelabeled system. Different examples of this are disclosed in this disclosure.

User interface descriptions may comprise data; code; references to data; references to code; policies; ORM protection containers; personalized configuration data; smart contracts, e.g., carrying royalty policies and information, as applicable; and more. Such information, or parts thereof, may be encapsulated in the form of encryption layers. An NFT can be minted that either references or contains such data, or parts thereof. Whether expressed as an NFT or not, it can be stored in wallets. The rights may be specific to a user, which can be determined by tying rights to authentication data, such as biometric tokens. Biometric tokens are disclosed in U.S. Provisional Patent Application No. 63/273,921 filed Oct. 30, 2021 titled “Biometric Authentication using Privacy-Protecting Tokens” by Markus Jakobsson. Rights can be specific to a wallet or a device, or may be lended or made available from one wallet to another, if the policies associated with the user interface descriptions allow it. Techniques to share access to NFTs and other content are disclosed in U.S. Provisional Patent Application No. 63/300,202 filed Jan. 17, 2022 titled “Dependent Wallet Technology” by Markus Jakobsson and Stefan Dufva.

The user interfaces described herein may be used to provide uniform access of users to their wallets, including across multiple wallets used by one and the same person. Two different users accessing the same wallet may prefer different user interfaces. These user interfaces of the wallets can be configured based on the identity of the user accessing the wallet, e.g., as determined by the selection of a username or a persona and a subsequent successful login, e.g., using a password, second-factor authentication (2FA), or biometric authentication.

Biometric authentication in the context of wallets is disclosed, e.g., in U.S. Provisional Patent Application No. 63/273,921 filed Oct. 30, 2021 titled “Biometric Authentication using Privacy-Protecting Tokens” by Markus Jakobsson. The use of multiple associated wallets is disclosed in U.S. Provisional Patent Application No. 63/300,202 filed Jan. 17, 2022 titled “Dependent Wallet Technology” by Markus Jakobsson and Stefan Dufva.

In one embodiment, a computer program is provided. The computer program comprises computer readable code means, which when run in a processing unit comprised in an arrangement in a device as described in this disclosure causes the device to perform the method as described herein. In an embodiment, a computer program product comprising the computer program is provided. A processing unit may be comprised of the arrangement in the device, e.g., with a DSP. The processing unit may be a single unit or a plurality of units to perform different actions of procedures described herein. The arrangement in the device may also comprise an input unit for receiving signals from other entities or arrangements, and an output unit for providing signal(s) to other entities or arrangements. The input unit and the output unit may be arranged as an integrated entity or as one or more interfaces. Furthermore, the arrangement in the device may comprise at least one computer program product in the form of a non-volatile memory, e.g. an EEPROM, a flash memory and a hard drive. The computer program product comprises a computer program, which comprises code means, which when executed in the processing unit in the arrangement in the device causes the device to perform the actions described herein. The processor may be a single Central Processing Unit, CPU, but could also comprise two or more processing units. For example, the processor may include general purpose microprocessors; instruction set processors and/or related chips sets and/or special purpose microprocessors such as Application Specific Integrated Circuits, ASICs. The processor may also comprise board memory for caching purposes. The computer program may be carried by a computer program product connected to the processor. The computer program product may comprise a computer readable medium on which the computer program is stored. For example, the computer program product may be a flash memory, a Random-Access Memory RAM, Read-Only Memory, ROM, or an EEPROM, and the computer program modules described above could in alternative embodiments be distributed on different computer program products in the form of memories within the device.

In some mobile apps and consumer appliances, the GUI screen layout can be configured from a server. Upon launch, the App or device connects and obtains coordinates, sizes, text, and colors for buttons, sliders, etc., then configures the GUI corresponding to the settings. This makes split-testing, regionalization, and other changes easy without any need to do a software update to the client app. Other devices update their GUI layouts and other configurations via explicit software updates, over which the user often has little or no control. However, users quite often find such updates off-putting, if not completely confusing. The lack of consistency in user interfaces, both across similar devices, and within a device in the presence of software updates, can be highly confusing to users. In the disclosed embodiment, a user who does not want to receive updates of a UI or UX can halt updates so that they will not occur, or can request to only receive updates at scheduled times, such as once a month or when the user clicks on a “refresh version” button. At the same time, the provider may provide safety-related and security-related patches at any time, without user approval, e.g., to address pressing needs.

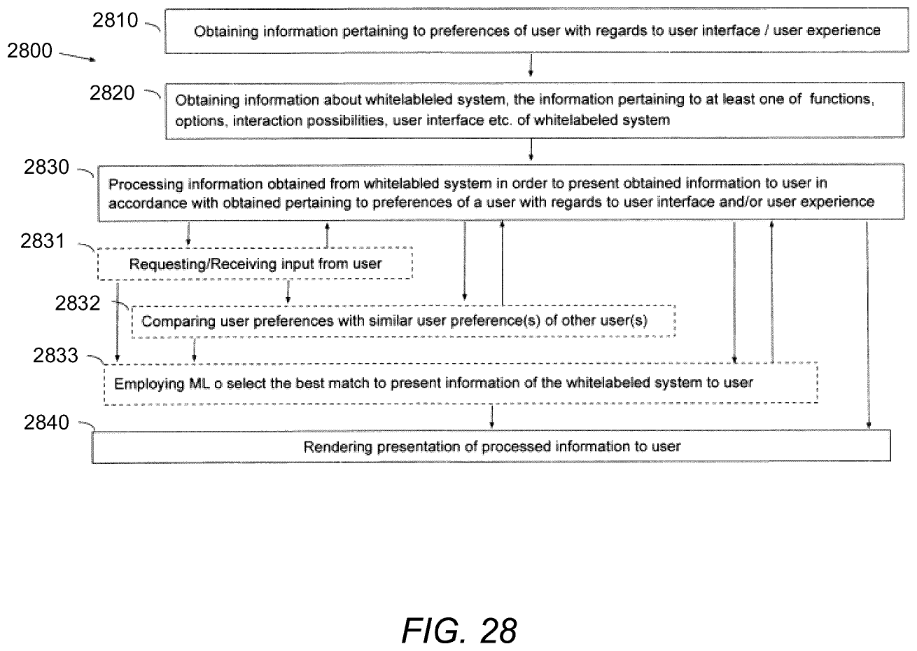

FIG. 28 is a flowchart illustrating an exemplifying embodiment of a method for enabling display of information to a user in accordance with a user preference with regard to a user interface and/or user experience. The method may be performed by a device or a processing arrangement in the device, wherein the device is one or more of a user device, a node in a network, in a cloud server, a target device, and a wallet etc. FIG. 28 illustrates the method comprising, in step 2810 obtaining information pertaining to preferences of a user with regards to user interface and/or user experience; and in step 2820 obtaining information about a whitelableled system, the information pertaining to at least one of functions, options, interaction possibilities, user interface etc. of the whitelabeled system. These two steps may be done without any interference by the user, as has been exemplified in various ways above.

The method may also comprise step 2830: processing the information obtained from the whitelabled system in order to present the obtained information to the user in accordance with the obtained pertaining to preferences of a user with regards to user interface and/or user experience. The processing may comprise different actions taken, many examples are given above, e.g. there may be a one-to-one mapping or one of the user interface and the whitelabled system may have different capabilities, wherein a one-to-one mapping is not possible, wherein different options available for the processing are given in this disclosure.

The method may also comprise rendering the presentation of the processed information to the user, as illustrated by step 2840. FIG. 28 also illustrates different options for when no one-to-one mapping exists between the whitelabelled system and the preferences of the user. In FIG. 28 this is illustrated by dotted boxes 2831, 2832, 2833. It is pointed out that FIG. 28 is an illustrative example, and that steps, or boxes, may be comprised in the above processing step 2830. In short, method (e.g. processing step 2830) may comprise one or more of step 2831: requesting input from the user and thus also receiving requested input; step 2832: comparing the user preferences with similar user preference(s) of other user(s); and step 2833: employing machine learning (ML) technique(s) that compares available capabilities of the whitelabelled system and the user preferences, to select the best match to present information of the whitelabeled system to the user.

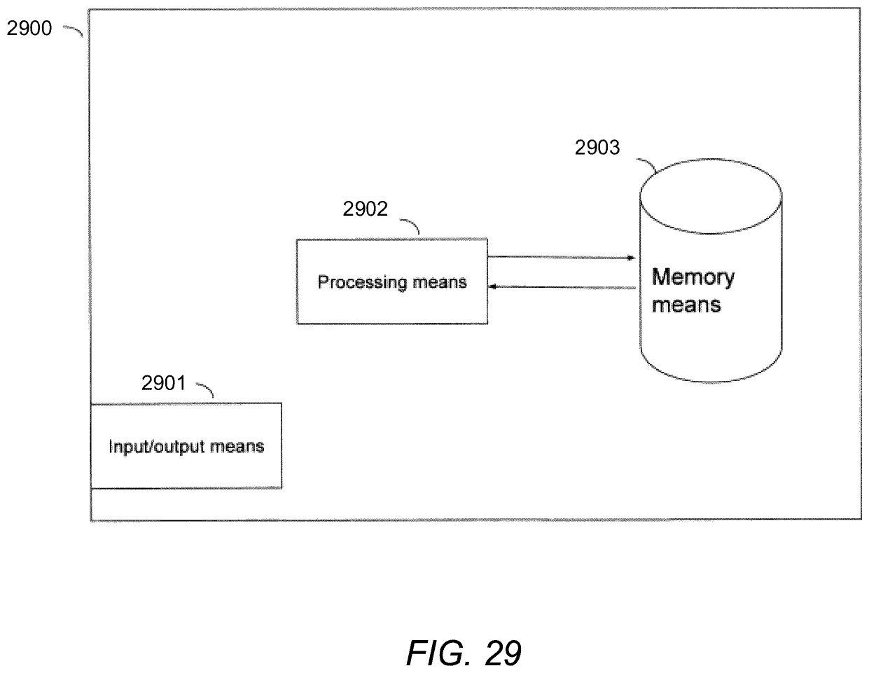

FIG. 29 is an illustration of a device 2900 for enabling display of information to a user in accordance with a user preference with regard to a user interface and/or user experience. The device is illustrated comprising input/output means 2901 by means of which the device may receive information and transmit or provide information to other units, devices and/or entities. FIG. 29 also illustrates the device comprising processing means 2902 and memory means 2903, the memory means 2903 comprising instructions, which when executed by the processing means 2902 causes the device to perform the method described herein.

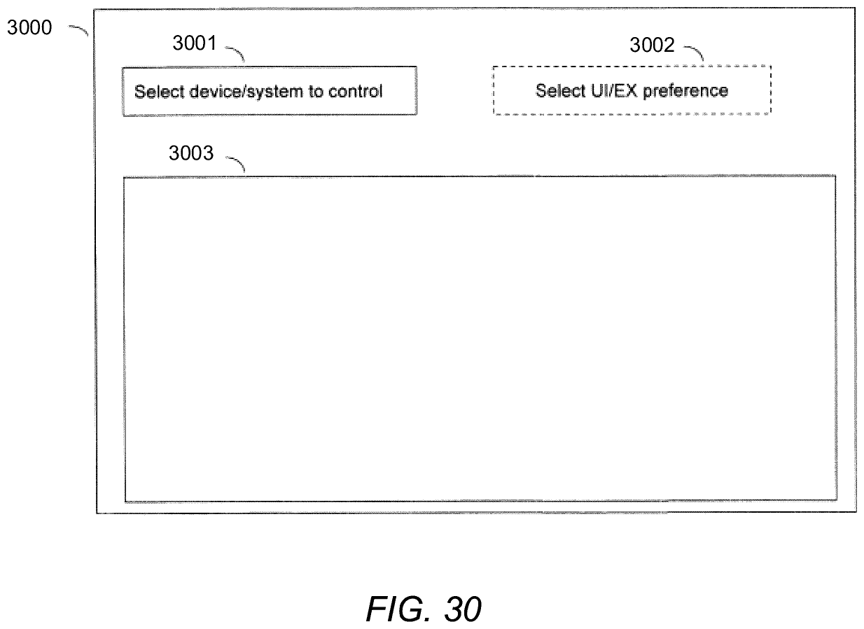

FIG. 30 is a schematic and illustrative example of a device (not shown) comprising a screen 3000 for displaying a UI/UX. The device may be for example a smartphone, a laptop, a personal digital assistant, PDA, or any other portable device carried by a user. As described above, the user may activate an app or go to a website (and optionally also log on) in order to interact or control a whitelabeled system. In this schematic example, a user may enter a hotel room and there may be several items or devices in the hotel room that the user may interact with, e.g., a TV, an air conditioning system, an adjustable bed, room service etc. In this example, the user gets at least one option on the screen, to select what device or system the user wishes to control or interact with. This is illustrated by a box or button 3001. By clicking the button, several devices or system may be made available, e.g., by means of a scroll list listing all available devices that the user may control or interact with. Although not illustrated, once the user clicks on a device in the list, control options for that device are displayed in the area denoted 3003 in FIG. 30. The control options are displayed in accordance with the users preferences as described in detail and by means of several examples above. FIG. 30 also illustrates an optional button or box 3002, which is dotted in order to illustrate that it is optional. This button and box 3002 enables the user to specify specific preferences when it comes to UI/UX. The user may have several preferences and is hereby enabled to select which one to use in order to display the functions/options of the selected device in accordance with the selected preference. It is pointed out that FIG. 30 is merely an illustrative example, and instead of displaying area 3003 to begin with, a new window may appear once the user has selected the device to control or interact with, wherein the new window corresponds to area 3003 of FIG. 30.

### Wallet User Privacy and Permissions Interface

This disclosure relates to, and expands upon U.S. Provisional Patent Application No. 63/280,184 filed Nov. 17, 2021 titled “Wallet User Interface for Management of Interaction” by Markus Jakobsson.

In one embodiment, a cryptographically secure wallet stores, or accesses, at least one type of content. Example content types are user data, including but not limited to financial, medical, genetic, social, or many other types of personal data. The disclosed methods apply particularly where there is a need for many different classes of entities to have different types of access to such data. An embodiment of the disclosed technology would be a user interface which presents data contained within a wallet interface as a set of easily recognizable icons and/or descriptive text. The user can drag and drop the icons and/or text into different permissions regions or folders, or inspect individual data components, and change the permissions and policies via buttons, menus, or other selection means. Various types of permissions can be determined from the form and details of the displayed icons and text. Different types of visibility and permissions for data could include:

Data, represented as icons and/or text descriptions, is displayed as available, with full read/write permissions.

Data is displayed as available, but with “read-only” permissions. This could be made visually clear via the use of a symbol such as an outward arrow, or other means to show that the data can only be accessed for reading.

Data is displayed as available, but with possibly limited read or write permissions. This could be made visually clear via the use of a symbol such as coloring part of the icon and/or in/out arrow(s) as faded grey.

Data is presented as visible, showing that the data exists, but no access is available to the actual details of the data itself. The lack of access could be shown by rendering the 1 entire item(s) in a faded grey, or with an overlay of the standard circle/slash “no access” symbol, or other means. Data would not be shown as visible at all, thus hidden from some types of entities inspecting the wallet contents.

Data is displayed as being available (for read, or read/write), but only for a particular time duration or window. This could be made obvious through the use of an icon such as a clock or hourglass, with a date/time indicating when the data is or will no longer be available.

Data is not directly available for reading, but a computation using the data can be requested, with a result returned.

A user of the wallet may set the classification of the content using a visual user interface disclosed herein. This user interface enables the user to create a visual partition of a space, where a component of such a visual partition may in turn be partitioned into sub-partitions. One example partition of content is into content that is not visible to the outside world vs. content that is visible at least to some extent by the outside world. We may, for denotational simplicity, refer to these two partitions as the invisible partition and the visible partition. The visible partition may be subdivided into two or more partitions, where the first one corresponds to content that can be seen by anybody, the second one to content that can be seen by members of a first group or class, and the third one to content that can be seen by members of a second group or class.

The permissions and display of the data depend on the person or entity trying to access it. For example, a physician might need full access to add (and possibly modify) medical records information, or to change/modify prescriptions, while a pharmacist might have read-only permissions only for prescription data.

A third entity such as an emergency first-responder might need access to known medical conditions and current prescriptions, in order to administer aid without potentially harming a patient further because of a medical condition or possible drug interaction. This could be similar to the MedicAlert(™) bracelets worn by some people, but much more detail would be available via a cryptographic, media-rich wallet. For example, X-ray images or other multimedia content could be stored as part of the data of a medical record in a media-chain wallet.

A user may provide his or her wallet address to his or her physician and/or health care service provider, providing these entities selective access to one storage area of the wallet, such as a directory associated with medical care. They, their physician, or any other authorized entity, can write data to such a location, e.g., by encrypting the data using a hybrid encryption scheme, for example, labeling the ciphertext with an address known to the wallet of the user, and writing the record comprising the ciphertext and the address to a blockchain; this causes the wallet to access the data and add that for the user to view in the UI of the wallet. The user can grant selective permission to service providers to also read such records, independently of what other entity wrote them. For example, service provider A can be granted append-only access relative to a medical directory of a given wallet, while service provider B can be given full write access (i.e., including erasure), and service provider C may be given append-only access as well as read-only access to records written by service providers A and B. One way to do this is for service provider C being given a copy of the decryption key used by the wallet to determine plaintext records from ciphertexts written by service provider A and B. This can also be performed in a selective manner, wherein different encryption keys are used for different purposes, according to different levels of privacy or need-to-know, and then selective service providers may be given access to some of the associated decryption keys. In one embodiment, trusted third parties that may be designated by the owner of a wallet may be given access to decryption keys. These trusted third parties may be distributed, as described in the context of the decryption/re-encryption service providers of U.S. Provisional Patent Application No. 63/305,998 filed Feb. 2, 2022 titled “Policy-Based Time Capsule Technology” by Markus Jakobsson.

Other examples of different access classes and permissions would include financial data, where a lender might need to know assets, liabilities, and income. But such an entity might only need access to such data for a fixed period of time, until the decision to grant {or not) a loan is made. This case motivates the fixed term, or expiring, access described above.

In one embodiment of the disclosed wallet privacy and permissions system, users of various types could interact with the data by dragging cards or icons around various permission/visibility spaces. Standard double clicking gestures could open data files and stores for viewing, or for editing if permissions are set to allow for that access.

In an embodiment of the disclosure, Icons and/or text representing the data are used to show various additional types of visibility:

Display of Function/Type: In one embodiment a data token has a color, icon, or text that shows what it is. Examples include a Caduceus symbol, or Red Cross for medical information, $$ for financial information, etc. Access and visibility could be even more detailed. For example, $$ could have sub categories such as salary, savings, stocks, IRAs, liquid vs. non-liquid, etc.

These could be public or semi-public. So an entity (e.g. doctor, hospital, or mortgage lender) could see what types of information is there, then post a request to see it. The user could then share or not by dragging the information card in question into a region that allows the request to be satisfied, or partially satisfied.

Fixed Term/Expiring: Many types of data, such as a single-use event or approval request, only need to be verified or inspected, then no longer should remain available. For example, the previous example of financial information for a mortgage lender. An entity seeking a loan might wish the lender to be able to see assets, or only enough of them to get the loan. But there is no need for the lender to have access indefinitely. This type of data sharing should be read-once, then revoked. Or it could expire after some fixed term. To make the limited access time obvious, an icon type (a clock or hour-glass if it's expiring, some icon to show that once it's read, it's no longer accessible) or color to show that in the user interface can be employed.

Limited trust or exposure: In another embodiment, there might be some types of limited trust, or partial sharing of necessary fragments. As mentioned in the mortgage case, a borrower might wish the bank to know that there is just enough in assets for the prospective borrower to be granted the loan. The borrower might actually have much more in assets available, but how much more is really none of the lender's business.

Computational Query: In one embodiment, the lender could request the cryptographic wallet to perform calculations and return a result, such as might be the case of a Debt to Income ratio.

For example, the full magnitude of personal (or entity) assets, liabilities, and income might not be necessary for a determination of whether to grant or deny a loan. With the proper trust and assurances in place, a wallet could calculate the necessary amounts and return only the data needed for the lender to make the decision. Rather than absolute amounts, or even an explicit calculation result (such as debt/income), an entity could ask one or more questions of the wallet via the user interface, until a suitable amount of information has been received. For example, “is the debt to income ratio less than 45% ?”.

Another example of limited access could involve data related to genealogy, where family members (even distant ones) might be more willing to enter information if they had some assurances that such information would not be publicly available, or only available to certain family members. For example, a user might discover that they have a previously unknown 5th cousin, and wish to know more about them, but not share too much (yet) of their own information.

On the other hand, stored DNA information should typically not be made publicly available, and should not be modifiable by any entity, but could be used by matching software to determine if, and how, two persons are related. In some cases, perhaps only certain parts of a DNA sequence might be needed. An example of this might be a population genetics survey for disease forecasting, where the only sequence regions of interest are specific markers that indicate a propensity for particular diseases or conditions. With the increase in popularity of genealogy companies such as 23AndMe(™) and Ancestry.com(™), millions of individuals are submitting samples for DNA sequencing. It is critical that this rising sea of personal information has proper controls, and protections against compromise of the information, fraud, and other misuses. Thus, data containers, which may be NFTs with ORM policies, can store such information in an encrypted manner, where only select parties have the capability to decrypt ciphertext data, and only in trusted execution environments, where the select parties may be distributed parties.

Another example of the importance of proper, controlled, access to DNA data is related to the area of gene-specific disease treatment plans. It is becoming increasingly commonplace for treatment of cancer, HIV, neurological conditions, and other diseases, to sequence the DNA of the individual being treated, or even a specific tumor, in order to develop and refine drugs and other therapies for treatment. As the proliferation and growth of sequenced DNA data of individuals becomes more common, there will be increased need for proper management, storage, protection, and access control of this data. The methods and interfaces disclosed herein are suitable for dealing with this important data management area.

Wallet contents can be characterized using survey methods disclosed in U.S. Provisional Patent Application No. 63/256,597 filed Oct. 17, 2021 titled “Token Surveys and Privacy Control Techniques” by Markus Jakobsson, and Stephen C. Gerber. The wallet, when storing content, may simply store a reference to the content, a key to decrypt or access the content, and metadata associated with the content. Example metadata includes but is not limited to a classification of the content. The classification may govern access rights of other parties related to the content, e.g., whether they can determine its association with the wallet; whether they can read summary data associated with the content; whether they have read access to the content; whether they are biometrically authenticated, etc.

A view corresponds to a collection of characterizations of content. One view may correspond to access rights to content, and impact the privacy of the user. A user may have multiple views of his or her wallet. One such view corresponds to the classifications described above, which indicates the actions and interactions others can perform relative to elements.

The user may place content elements, or icons representing these, into the various partitions of the space representing the user wallet, as a way to associate with these content elements access rights governed by rules and policies expressing the access rights of the given partition. The placing of content in a given partition may be performed by a drag-and-drop action performed by the user.

Some content classifications, e.g., placement in a given partition, may be automated, or at least in part automated. A user might be asked, for each automatically classified element, to confirm its placement. Before the user confirms, the element may remain in a queue that corresponds to not being visible to the outside world. If a user declines a given classification, she may be asked whether an alternative classification should be automatically performed for such elements onwards, where the selection of the alternative classification may be based on a manual user classification taking place subsequent to the decline.

One partition may indicate that elements placed in the partitions are visible to users of an indicated group, where this group may correspond to a membership or ownership, to an access control list (ACL) specified by the user, or may correspond to all users. Elements in that partition may be visually clustered to indicate their relationship. For example, any elements that were placed in there using an automation rule, as described above, may be clustered together.

Another cluster may correspond to the placement due to another automation rule. Yet another cluster may correspond to a user selection where there is no automated classification. Such a cluster may be sub-clustered based on the type of content, e.g., video vs. audio, or the usage of the content, e.g., more than once a week vs. less than once a week. A user can move one item, a cluster of items, or a multiplicity of items and clusters and items by selecting items and clusters and performing a drag-and-drop to another partition or to a sub-partition within the current partition. The selection of items can be performed using a lasso approach in which a user circles items or partitions as they are displayed, or by alternative methods for selecting multiple items in a visual interface, as will be appreciated by a person of skill in the art.

Automatic classification of elements can be used to perform associations with partitions or folders, and may be based on machine learning (ML) techniques that base the classification on usage behaviors exhibited by the user relative to the content to be classified, labels associated with the content, e.g., provided by content creators, or other third parties; usage statistics; manual user classifications of related content, and more.

The accompanying figures depict some embodiments and functions of this disclosure, but are not intended to limit the scope of coverage of the relevant concepts of the disclosure.

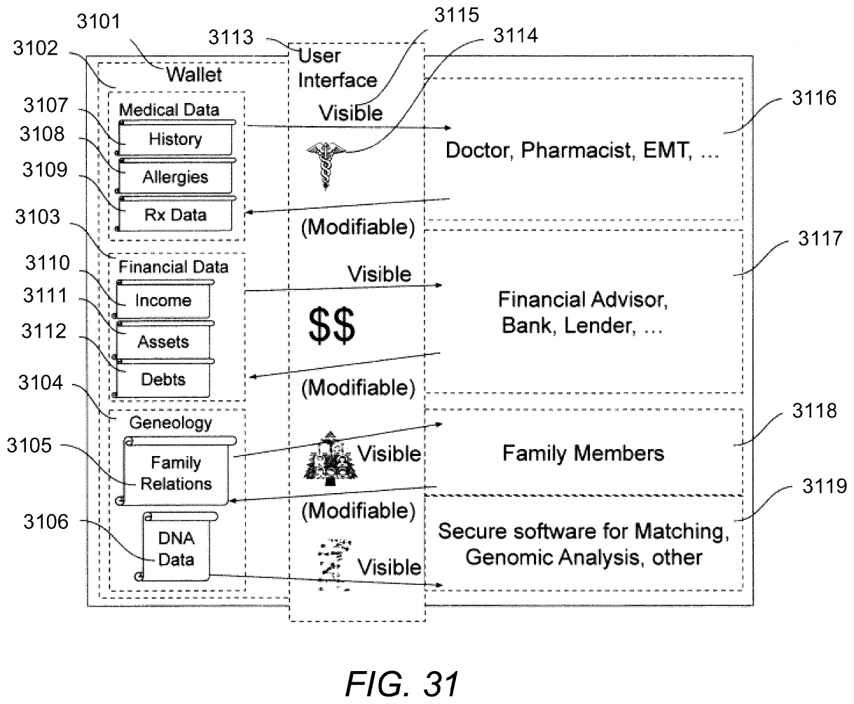

FIG. 31 illustrates an example wallet visual user interface 3101 containing user data, including medical data 3102, banking and/or financial data 3103, and genealogical data 3104, possibly including both family tree relational data 3105 and DNA information 3106. The medical data might include medical history 3107, allergies 3108, and current and past prescriptions 3109. Financial data might include Income 3110, assets 3111, and debts 3112. A graphical user interface 3113 presents the data as various icons 3114 and/or text 3115, showing whether the data is visible, or potentially modifiable, depending on the class of entity requesting access to the data. Different types of individual entities might wish to have access to the data. Medical information 3102 might be accessible to a Physician, Pharmacist, or EMT first responder 3116, but each of these should have a different class of access. Financial information 3110 might be accessible to a Financial advisor, Bank, or potential lender 3117, but each of these should have a different class of access. Some genealogical data 3104 such as family tree relationships 3105 might be accessible to family members 3118, while DNA data might only be available to trusted software analysis systems 3119.

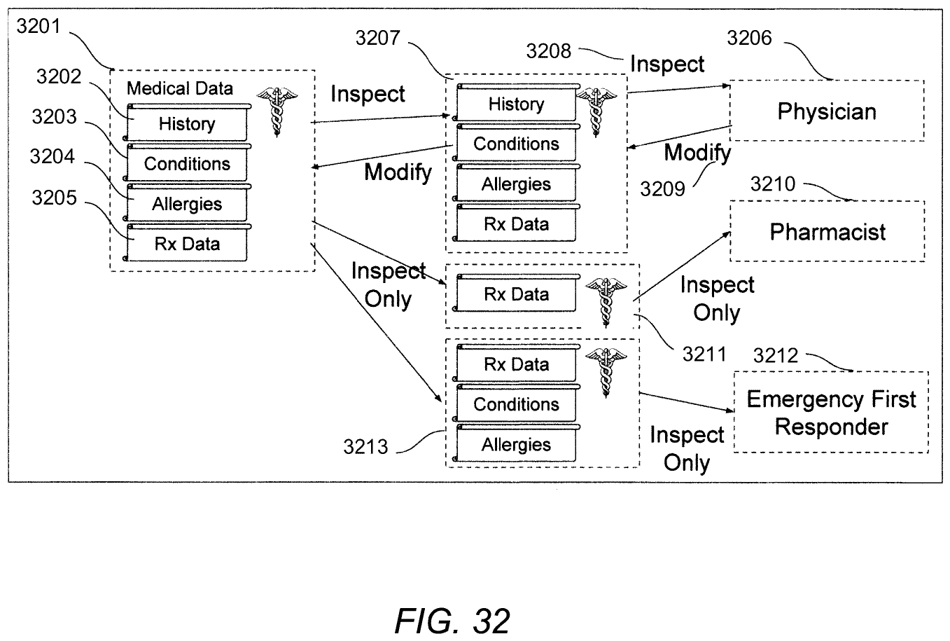

FIG. 32 shows an illustrative wallet visual user interface 3201 for medical data, which includes different components including medical history 3202, current and past medical conditions 3203, allergies 3204, and prescription information 3205. A physician 3206 would be presented with a visual interface 3207 which provides complete read (inspect) 3208 and write (modify) 3209 access to everything in the medical data area. A pharmacist 3210 would be presented with a different interface 3211 which might only provide information on current prescription(s). An emergency medical responder 3212 would receive a yet-different interface 3213, providing information about medical conditions, current prescriptions, and any allergies (latex, antibiotics, etc.) which could be important when providing emergency care.

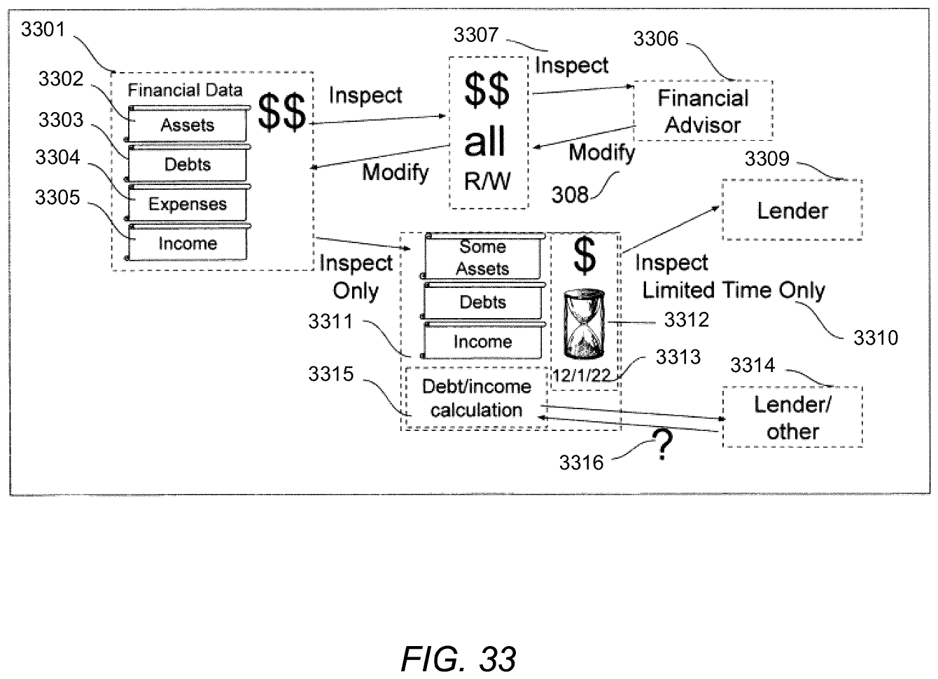

FIG. 33 illustrates a wallet visual user interface containing financial information 3301, including assets 3302, debts 3303, expenses 3304, and income 3305. A financial advisor 3306 might be presented with full read (inspect) 3307 and write (modify) 3308 access to all financial data. A prospective lender 3309, however, might be given only read (inspect) access, for a limited period of time 3310, of only the information necessary 3311 for them to make their decision whether or not to grant the loan. Alternatively, a lender or other entity 3314 might request a calculation, such

as a debt-to-income ratio, to be performed by the wallet and user interface 3315. Rather than absolute amounts, or even an explicit calculation result (such as debUincome), an entity 3314 could ask one or more questions 3316 of the wallet via the user interface, receiving answer(s) to the query(s), until a suitable amount of information has been received. For example, “is the debt to income ratio less than 45% ?”.

### Custodial Wallet Sub-Accounts

One aspect of the disclosed technology is a wallet account with at least two sub-accounts, where each sub-account is associated with an access credential. A user with a valid access credential associated with a sub-account is permitted to transfer ownership of tokens associated with the sub-account, including selling a token, moving a token to another wallet address associated with the user with the valid access credential, gifting a token to another user, lending a token to another user, or listing a token as being for sale or for rent. A party associated with an account having a sub-account may act as a service provider that facilitates the transfer of ownership, or other token actions, as indicated by a party with a valid access credential to the sub-account. We refer to the user with the valid access credential as the “perceived owner”, and the party associated with the account having the sub-accounts as the “actual owner”. Thus, the actual owner will facilitate transactions on behalf of the perceived owner.

Each sub-account will be associated with a capability to reset a credential or to change a credential. This is managed as disclosed in U.S. Provisional Patent Application No. 63/314,293 filed Feb. 25, 2022 titled “Second Factor Improvement Technology” by Markus Jakobsson and Keir Finlow-Bates. A user of the technology will perceive a service provider (which corresponds to the wallet with sub-accounts) to which the user gains access to an account (which corresponds to the sub-account). Thus, the user experience (UX) can be made very similar to a financial service provider, a social media account, or an email service provider, wherein a user provides a user name and a credential to gain access to data and capabilities, and where the service provider may utilize second-factor authentication (2FA) for the purposes of reducing the risks associated with phishing, malware and other types of abuse. The novel approach for 2FA disclosed in “Second Factor Improvement Technology” by Markus Jakobsson and Keir Finlow-Bates is particularly beneficial in contexts such as the one described herein, as it enables a higher degree of protection of the user assets by means of a timing-based protection mechanism that may be policy based and which may be configured based on one or more risk assessments, user preference settings, and contents of the protected sub-account. Whereas the disclosure of “Second Factor Improvement Technology” by Markus Jakobsson and Keir Finlow-Bates discloses protection of accounts as opposed to sub-accounts, the same approach also is applicable to sub-accounts.

Abuse detection methods can be employed to detect risks and to trigger defense techniques, including the delay of access, as disclosed in U.S. Provisional Patent Application No. 63/314,293 filed Feb. 25, 2022 titled “Second Factor Improvement Technology” by Markus Jakobsson and Keir Finlow-Bates, but also to limit access rights to protected resources. In one embodiment, a wallet with sub-accounts identifies attacks on a first set of sub-accounts, e.g., denial of service attacks or dictionary attacks, and applies protective measures to the attacked accounts as well as at least some other accounts that are determined to also be at risk. Such proactive protective measures may include triggering of various defense mechanisms, and can be based on heuristic threat detection methods.

In one embodiment, the minting of an NFT is done in a lazy way, i.e., in response to a purchase request related to a description of the NFT to be minted. The buyer will not need to know that at the time he or she commits to the purchase, the NFT is not yet in existence. This is referred to as lazy-mint. The lazy-mint causes an assignment of the generated NFT to one of a user-designated wallet or the wallet with the at least two sub-accounts, where the latter may be managed by the same entity that performs or initiates the minting of the NFT. This has the benefit of lowering costs. By assigning the ownership to the wallet with the at least two sub-accounts, friction is overcome as users initiating such purchases do not have to first create a wallet to which the generated NFT is to be transferred. In the case where the NFT is already minted, as opposed to lazy-minted, the assignment to a wallet with sub-accounts is also beneficial, for the same reasons.

A user gaining access to a sub-account of a wallet will only gain access to the resources associated with this sub-account, as opposed to all the contents of the wallet. The different sub-accounts may be separated from each other by logical containers, which may be individually encrypted and only be made available to a user after a decryption key is generated from the access credentials used to gain access to the sub-account. In addition, other key information may be utilized to protect the content.

In one embodiment, a service provider operates one or more wallets, each one which comprises one or more sub-accounts, and where each such sub-account is associated with access control mechanisms, such as a stored username and password, a reference to a Google(™) Authenticator(™) profile, an public key used to verify the validity of machine-provided requests received via an API, or one or more phone numbers or email addresses used for transmission of codes used to verify the likely identity of of a particular user requesting access, e.g., based on a user configuration, a risk assessment, or an identified user action, such as the request to add a new access credential or to remove an access credential associated with the sub-account.

In one embodiment, the service provider logs information identifying the assignment of resources and assets, such as NFTs and crypto funds, to an identified sub-account, where this log may be written on a public blockchain for third-party verification of the assignment. The log information may be encrypted, requiring a selective decryption of indicated records, e.g., by the service provider in order to facilitate the verification of the log entry. This encryption may be applied only to a portion of the stored log information, such as an identifier of the sub-account or associated owner, the latter of which may be accomplished using a unique identifier associated with this user. This enables unfettered access to records indicating the assignment of specified resources to accounts that are not publicly verifiable, which has a privacy enhancing effect. The owner of the sub-account may be provided with a zero-knowledge proof that he or she is the indicated owner of a particular resource. This zero-knowledge proof may also be provided to a party demanding tracking information associated with the log, e.g., a law enforcement entity.

By encrypting the identifier of the account using ElGamal encryption or a similar approach, the service provider may generate a proof of knowledge using standard digital signature methods, such as Digital Signature Algorithm (DSA) signatures or Schnorr signatures. In particular, if the identifier is the value I, and the ElGamal encryption of it is {A,B)=(gAr, yAr*I) where all operations are modulo a large prime number p, and Λ denotes exponentiation, then the decryption of the ciphertext (A,B) is 8/AAx, wherein y=gAx modulo p. A proof of knowledge that (A,B) corresponds to the identifier I is a digital signature using 8/1 as a public key and A as a generator, wherein the associated secret key is the value x. This is known by a party designated to decrypt (A,B), e.g., the service provider. It may also be known by a trusted third party, such as a consumer representative.

In one embodiment, a sub-account of a wallet is accessed from an application that we will refer to as a pseudo-wallet. The pseudo-wallet may have the appearance of a wallet, to its user, and present a user interface and a user experience that corresponds to a wallet. However, unlike wallets that store either content references (most commonly) or content, the pseudo-wallet may not, but instead, accesses the sub-account of the wallet using an API. The access may be authenticated using a cryptographic key, e.g., by digitally signing requests or sending requests that are “signed” using message authentication codes. In addition, the communication between the pseudo-wallet and the wallet, which may be performed over the Internet, may be protected using encryption. The pseudo-wallet would typically require authentication of a user to access its resources, where these resources comprise addresses and credentials, such as key material, used to identify and access the sub-account of the wallet where tokens are stored. Such tokens may be NFTs or cryptofunds. The pseudo-wallet may access tokens and their associated content, e.g., in the case of an NFT, where such content may be stored, at least temporarily, on a storage associated with the pseudo-wallet. In addition, the pseudo-wallet may issue commands, prompted by directives provided by a user using a user interface of the pseudo-wallet, where these comments initiate actions on selected tokens. Example actions comprise transfers of ownership, changes of access control rights, e.g., to enable third parties to access selected tokens in pre-specified manners, and more. Thus, the pseudo-wallet does not actually store tokens or even necessarily references to token, and does not have an address with which ownership of the tokens is associated; however, it can access the sub-account of the wallet, where the wallet is associated with the actual ownership and performs actions on behalf of the user accessing the sub-account using the pseudo-wallet. In one embodiment, the pseudo-wallet is protected against abuse, e.g., from malware, by executing in a trusted execution environment (TEE) such as TrustZone. In one embodiment, at least some keys are stored in a secure element (SE) that is conditionally accessible from the pseudo-wallet executable code.

A pseudo-wallet can be used to limit access to content and actions. For example, parents may permit their children to use a pseudo-wallet to access one or more folders, corresponding to sub-accounts, of one or more wallets owned by the parents. For example, in the sub-account accessible by the pseudo-wallet of one child, there may be a pre-set amount of crypto currency that the child can access (i.e., transfer ownership of) using her pseudo-wallet. There may also in this pseudo-account be a collection of NFTs that the child may use, lend out, but not transfer ownership of. Another child may have another pseudo-wallet associated with another sub-account of the parental wallet, where this sub-account may contain no crypto currency, but full access, including transfer of ownership to some collection of NFTs that the child has bought, been given, or earned, e.g., in a game he plays. The parental wallet could be an actual wallet, but it could also be represented by a custodial wallet with sub-accounts.

In one embodiment, a user may upgrade a pseudo-wallet to having capabilities normally associated with a wallet, e.g., to free itself from the reliance on having a third party (the wallet with the sub-accounts) act on its behalf. This can be done by creating a wallet instance, including a public key and an associated private key, wherein the public key is the address of the wallet instance; and to request a transfer of ownership rights from the (sub-account of the) wallet where the are stored to the wallet instance created for the user. In some instances, this may be done without dramatically modifying the user experience of accessing the resources, such as the stored crypto funds and the stored NFTs.

The wallet with the sub-accounts, which we refer to as the custodial wallet, can be implemented on a server with access to the Internet. The server would preferably be well protected against abuse, and could at least in part be running in a TEE. It is beneficial to enable external auditing of the security posture of the server running the custodial wallet and associated services; this can be done using software-based attestation methods. One method of performing software-based attestation is disclosed in M. Jakobsson, “Secure Remote Attestation”, available at https://eprint.iacr.org/2018/031.pdf, also see U.S. Pat. No. 10,747,878. The custodial wallet may also have biometric access restrictions enforced, such as fingerprint and facial recognition commonly implemented in mobile smartphone devices, to prevent unauthorized access to the functions of the described wallet system.

In one embodiment, a user configures the access to his or her sub-account of a custodial wallet to require one or more specified forms of authentication. For example, the user may specify that the sub-account may only be accessed using one of a collection of specified pseudo-wallets, or using a high-security authentication mechanism that requires presenting a physical token to a trusted party in person, e.g., to a notary at a pre-specified bank branch. The user may specify different types of requests, e.g., read access vs. transfer of ownership access, and specify different types of authentication requirements to the sub-account of the custodial wallet for these. A user may set a policy that determines the access requirements based on the contents of the sub-account of the custodial wallet, e.g., increase the protection once the value of the contents of the sub-account exceeds a threshold value, such as $100,000. Such configurations can be performed when the sub-account is first configured, or at subsequent accesses. In some instances, there may be a requirement for a stringent authentication method to relax any form of authentication requirement, but another degree of authentication to tighten the requirements.

Service A may implement a custodial wallet that user B gains access to, whether using a browser or an app, such as an app implementing a pseudo-wallet. In the case of a browser being used to convey a user interface to user B, the user experience may be configured to resemble that which would be provided in a pseudo-wallet. The user may also have an actual wallet, which may be a hardware wallet or a software wallet, or a wallet that is a combination of dedicated hardware and software. Independently of the approach, user B may wish to provide access to the resources user B has access to, or a subset of these, to other users. Users C, D and E may be employees of user B, children of user B, or friends of user B. Users C, D and E may be provided access to some or all of user B's token and data, or some subset of such, as specified by user B. User B may provide different access to users C, D and E. Each of users C, D and E may access the resources they are provided access to by contacting a gatekeeper, using a browser application, a pseudo-wallet, or an actual physical wallet. The gatekeeper may be user B's wallet, or service provider A. If user B provides play access to one particular token to user C, user C may access this token or its associated content by having a computer representing him access the wallet of user B, or a pseudo-wallet of user B. The computer of user C may also directly connect with service provider A, and present a token representing a permission provided by user B to user C, said token identifying the right for user C to access one or more resources, and optionally, a descriptor indicating the manner of access that is permitted.

A user corresponding to user B above may share an access key to two or more users, such as user C, D and E, by breaking the access key up into portions, e.g., using threshold-based polynomial secret sharing methods or by dividing the access key into portions. Each of the users receiving a share will be unable to use the key by themselves, but will be able to collaboratively take an action by a sufficient number of them, represented by a quorum matching a threshold, taking action together or by pooling their respective shares of the secret. Methods for computing on shared data in a distributed setting are well understood, and can be used for this. For example, users C, D and E may receive shares using a (2,3) threshold scheme, meaning any two of them can perform an action that can be taken using knowledge of the key.

This action may be to distributively digitally sign a message, where the collaboration of doing so results in a valid digital signature on an input message that is known to the signers, and which can be verified with a public key corresponding to the key that was being shared between users C, D, and E. A smart contract can be signed in this way. This enables distributed control over the transfer of resources. The access to this functionality can be provided using browsers, pseudo-wallets, wallets or a combination of such. Each user may have a different approach of interacting with the entity holding the resource they distributively control, and this entity may be interacted with using an API using digitally signed requests that enables the verification of the source of the request. They can also be accessed using a browser that implements a log-in page allowing a user to get limited access to a resource accessed using the browser, which may be a storage keeping a share of a key and software to generate a portion of a digital signature from this share, and to facilitate the assembling of multiple such shares to form a digital signature that may be part of a smart contract. A user wallet or pseudo-wallet may be used to automatically generate such approvals of transaction requests of pre-specified types, e.g., using a batch mode.

### Profile-Based Wallet Selection and Use

In this disclosure, we describe automated methods of managing multiple wallets for one and the same user, using one and the same wallet interface. The disclosed technology comprises three main components. A first component is a component to determine, for one or more users, a collection of partitions, wherein a partition corresponds to a functional separation of interest. A second component is a component to classify, based on existing partitions, a given pending transaction and assign it to an existing partition, where applicable. A third component is a user interface component to convey at least one classification of a resource to a user associated with a wallet. To the extent that there are many users of a given collection of resources within one or more components, the user interface component additionally selectively determines what resources to convey to what users, or use to influence the user experience of said users. Examples of resources include but are not limited to tokens, such as non-fungible tokens (NFTs) and fungible tokens; content that is not in the format of a token, such as user-generated content (UGC); and user actions such as preferences and configurations, which may be used to inform the meaning of a prospective respect.

Traditionally, a wallet corresponds to one wallet public key, which identifies the wallet, whether the wallet is software-based or hardware based. Associated with the wallet public key is a wallet private key that is used by the wallet to perform transactions, such as to transfer the ownership of a token belonging to the wallet (by virtue of being assigned to the public key of the wallet) to another wallet. In co-pending application Ser. No. 63/322,265 titled “Escrowed Wallet and Transaction Tracking Technology” by Markus Jakobsson and filed on Mar. 22, 2022, technology is disclosed to permit a user wallet to be associated with multiple public keys, each one of which will appear to the outside world as a distinct wallet; this is done, e.g., for reasons of privacy. One may think of this as one wallet, as seen by a user, that corresponds to multiple apparent wallets, seen from the perspective of the outside world, in spite of these belonging to the same entity. The application further discloses documenting the relationships between these associated apparent wallets, and other wallets as well, by escrowing encrypted relationship indicators between the apparent wallets. Moreover, in co-pending application Ser. No. 63/365,464 titled “Safeguarding Ownership Transfer Against Abuse” by Markus Jakobsson and filed on May 27, 2022, it is also described that ownership of tokens can be assigned to processes; and in co-pending application Ser. No. 63/365,269 titled “Directed Acyclic Token Structure” by Markus Jakobsson and filed on May 23, 2022, it is described that tokens can be assigned to other tokens. Another example of that is disclosed in co-pending application Ser. No. 63/368,869 titled “Blockchain-Based Control and Data Channel Method” by Markus Jakobsson and filed on Jul. 19, 2022.

In the instant invention, we refer to the interface between a user and a set of resources as an “experienced” wallet. Two or more users may be able to access overlapping subsets of resources using two different experienced wallets; for example, a husband and wife set of users may both be able to access some of the same resources, but not necessarily the same resources, using two different experienced wallets. These two different experienced wallets may correspond to different hardware units, or the same; and to different software units, or the same. The users may be distinguished from each other based on login credentials, such as usernames and passwords, or biometrics; or they may be distinguished based on usage, e.g., based on requests that are characteristic of the two different people. Two different experienced wallets may also correspond to two different personae associated with the same physical end user, e.g., the user at work and the user enjoying his or her hobby. Again, the persona may be determined based on differences in the login process or thereafter (e.g., different selections of personae), or may be determined based on persona-specific actions. An example of the latter may be a determination that a user is performing a hobby-related action when searching for “fly fishing NFT”, as opposed to a work-related action, e.g., as determined based on no work related actions relating to fly fishing and many hobby-related actions related to fishing of different types. It can also be tentatively determined, without any persona-specific information, based on common classifications, which may identify fishing as being a common hobby (but one that is different from knitting, which may correspond to another persona), as opposed to a common employment.

Classifications of resources into partitions can be made based on topic-based classification, and by knowledge of context. One example of context includes the actions the user has just performed, and the associated classifications of these. It may also be determined based on the time of the day, e.g., during work hours or during the evening. It may also be informed by recent user-generated classifications or confirmations of such. Thus, a user's requests and resources are classified into one or more partitions, which may be associated with different apparent wallets, e.g., based on an automated classification or by manual selections by the user of a category, or a combination in which a user is asked to confirm an automated classification. The classification can be made using artificial intelligence (AI) methods, machine learning (ML) methods, or rule-based methods.

In one embodiment, one or more partitions comprise a collection of tokens that are assigned to different identifiers. This partition corresponds to elements that have not been conclusively classified as belonging to a specific partition, such as a work partition, a sports partition, an entertainment partition for a first user, or an adult-only partition. We may call this partition the “undetermined” partition. Items may be placed in this partition when a classification has not yet been made, or when it is not clear what user/persona the acquisition of the token corresponds to. This also applies to classification of elements that are not tokens, such as browsing events, reactions to advertisements, or other, where the classification of resource type, persona, or other is not sufficiently conclusive, e.g., has an estimated error estimate that exceeds a threshold. If one of these resources is later conclusively classified, it may be placed in the associated partition at that time and assigned to the associated identifier, such as the apparent wallet public key associated with that partition.

In one embodiment, an advertiser determines a collection of resources associated with a particular apparent wallet public key, i.e., associated with a given partition, and based on this collection, performs a profiling of the persona associated with this partition. The profiling may be performed not only based on current contents of the partition but also based on historical contents thereof; one method of profiling may assign a weight to each element belonging to the set of resources associated with a partition, where elements that are currently in the partition are given a greater weight than elements that are not, and elements that have stayed in the partition for a longer time or seen more associated activity (such as more observed renderings, requests to purchase, etc) are given a greater weight than elements that have less associated activity. The determination of what partition various tokens are can be done by a script running on the wallet, with the permission of the wallet to do so. This script may be included in a token provided by an advertiser, e.g., in a token that comprises content that the user is rendering for free in exchange for allowing the script to be run.

In one embodiment, it is evident to a party such as an advertiser what resources belong to a given partition, at least as far as tokens that are recorded on a blockchain and associated with a public key associated with the partition. However, the advertiser does not know to whom it belongs, and also does not know whether two particular partitions are associated with the same user (e.g., different personae of this user), to related users (e.g., different family members) or to unrelated users. Therefore, having a great insight into the behavior of one person (such as a colleague) does not allow a person to determine other, unrelated behaviors of the same user (such as the colleague's hobbies).

In another embodiment, a user does not wish for everybody to be able to determine that two elements associated with one and the same partition are associated with one and the same persona. This may be motivated by a wish not to get targeted product advice, which not all users appreciate. Such a user may still want to configure his or her experienced wallet to partition resources, but only to selectively reveal whether two elements are in the same partition to select entities (which may be trusted advertisers, consumer ombudsmen, etc). The user may configure his experienced wallet to assign each different token to a different public key, and then provide the select entities with information that allows them to determine that two public keys belong to the same partition. The most straightforward way of doing this is to provide a list of all the public keys associated with the partition to this select entity. Another approach is to use a probabilistic storage method such as a Bloom filter to represent the collection of public keys associated with one given partition. Updates to the Bloom filter can be sent intermittently to the select parties that the user wishes to be able to perform the clustering corresponding to partitions. In one embodiment, a user may provide such information, which we may call the clustering information, to an entity in response to this entity providing the user with a desired benefit, such as a discount, one or more tokens, a service, a membership, etc. An entity can determine, given any token, whether it could belong to a given partition or not by verifying whether it is encoded by an associated Bloom filter.

Non-token activity and data can be represented in a manner that is accessible and associated with one or more partitions, e.g., by representing the associated information as tokens and assigning the tokens to the appropriate wallets. Another option is to represent such activity and data as entries in another Bloom filter, to which one or more entities are given access. For example, the Bloom filter may comprise the set of URLs to which a user, in a given persona setting, has navigated. An entity with access to the Bloom filter can determine whether a given URL has likely been visited or not by verifying the Bloom filter encoding. Other probabilistic storage methods can also be used, as will be readily evident to a person of skill in the art.

Another way of selectively revealing the partition content to a select party is by the experienced wallet generating a sequence of pseudo-random numbers from a seed, where this seed is given to the select party, and then use consecutive segments of this sequence as public keys in an identity-based encryption (IBE) scheme, one of which was disclosed in the 2001 publication “Identity-Based Encryption from the Weil Pairing” by Dan Boneh and Matt Franklin, available at https://crypto.stanford.edu/˜dabo/papers/bfibe.pdf.

Traditionally, the ownership of a token is assigned to an entity associated with a public key by generating a digital signature, using a private key associated with the token, on the public key of the new owner, thereby making the private key associated with this public key of the new owner the new private key with which ownership is transferred. The digitally signed messages, comprising the public key that is signed and the digital signature that transfers ownership, are typically recorded on a blockchain in order to memorialize the transfer. The entry on the blockchain therefore can be described as a value that comprises (m, dig_sig(m, sk_sender) where m is the message signed and which comprises pk_receiver, where pk_receiver corresponds to the public key of the recipient of the token, and where sk_sender is the secret key (or private key) of the sender of the token, i.e., the party who transfers the token, or parts thereof, to the owner of pk_receiver, where this ownership can later be evidenced by use of secret (or private) key sk_receiver to sign messages. A fungible token can be transferred in part, in which case m may comprise indications of portions of the coin and public keys to which such portions should be associated. In one embodiment of the disclosed technology, the message m comprises a condition or a time limit, indicating the condition under which the transfer is to be performed, or the time period during which the transfer is valid before the token returns to the sender or another designated party. The message m may also indicate a process P that is to be provided with joint ownership, along with another party, both this party and P being indicated by public keys, and both having to generate a digital signature (whether jointly or independently of each other) in order to transfer out the token. In some systems, the recipient needs to sign an agreement to receive a token, using a private key associated with the receiving public key pk_receiver, and this digitally signed value must be incorporated in the message m for the transfer to be valid. This guards against unwanted transfers of tokens, such as NFT spam, and against what is referred to as “dusting”.

In one embodiment, m comprises instead of a plaintext representation of pk_receiver, an encryption of the value pk_receiver, where the encryption scheme is deterministic, in which case it is possible to perform hypothesis testing whether a given token is assigned to a given apparent wallet, using the public key of the apparent wallet. For example, the message m may comprise (R, E_{pk_receiver}(R,pk_receiver)), which means that the encryption scheme E uses the public key pk_receiver to encrypt the value R, which is a nonce, and pk_receiver. A party wishing to determine whether a given token was assigned to a candidate public key p can determine whether element (R, E_{pk_receiver}(R,pk_receiver)) matches (R,E_p(R,p)). This is possible when E is a deterministic encryption scheme. An example deterministic encryption scheme is the RSA encryption scheme.

In another embodiment, m comprises instead of a plaintext representation of pk_receiver, an encryption of the value pk_receiver, where the encryption scheme is probabilistic. An example probabilistic encryption scheme is the ElGamal encryption scheme, which takes a plaintext input val and a nonce R that is not made public, as well as a public key pk_receiver, and generates a ciphertext (a,b) from val and R. To decrypt this, one must either have the secret (or private) key sk_recipient that corresponds to pk_receiver, or one must have R. However, in this embodiment, R is not made available to the public. The message m comprises (E_{pk_receiver}(R,pk_receiver)) where E is the probabilistic encryption scheme, and where the encrypted value val is the public key pk_receiver. The legitimate recipient, who is a holder of sk_recipient, can verify that the transfer is correct, but other parties cannot; in fact, other parties cannot even determine what entity is assigned as the recipient. To transfer out such a token, at least two approaches are possible. The first approach involves publishing a proof that pk_receiver is the valid plaintext associated with the ciphertext (E_{pk_receiver}(R,pk_receiver)), which can be performed using standard zero-knowledge proofs. In the case where (a,b)=(g\hat{ }R, y\hat{ }R*val) and y=pk_receiver, \hat{ } modular exponentiation, and * modular multiplication, we know that a\hat{ }x=b, where x=sk_recipient. Thus, using a proof of equality of discrete logarithms corresponding to log_a b=log_g y, a verifier will be convinced that the ciphertext (a,b) corresponds to the plaintext value val=pk_receiver. A DSA signature or a Schnorr signature can be used to perform such a proof, or a challenge-response method can be utilized. This first approach reveals, as the recipient transfers out the token, the identity of the recipient (namely pk_receiver, which may be independent of the user identity, and unrelated to other items in the wallet or the partition; or which may be a public key associated with the partition or with the wallet. This approach can be combined with the condition-based or time-based ownership assignment described above.

In another version of the above embodiment, the recipient of the token wishes to hide the information corresponding to pk_receiver both upon receiving the incoming transfer and upon transferring it out. Instead of proving that the contents of the ciphertext in m corresponds to pk_receiver, and then using the associated key sk_recipient to transfer the token out, the recipient instead uses a zero-knowledge proof of knowledge to prove knowledge of a private key corresponding to the encrypted public key, but without disclosing either of these keys; this can be done, for example, using a cut-and-choose approach, as will be appreciated by a person of skill in the art. This approach, too, can be combined with the conditional and time-limited ownership. We refer to the three embodiments in which an ownership transfer is done relative to an encrypted public key as being privacy enhancing. The encryption of the public key may be performed by the sender of the token, who knows where the token is to be transferred but agrees to obfuscate that to the public; it can also be done by the recipient of the token, so that the sender (the original holder of the token, who will transfer the token away) does not know to what public key it is transferring the token.

In some embodiments, escrow methods are added to prevent abuse. For example, where ElGamal encryption is used to encrypt a public key of a recipient, using a nonce R, the same nonce R can be encrypted using the public key of a trusted third party, allowing this party to probe whether a given transfer is going to a particular recipient or not. Alternatively, the value val=pk_receiver can be encrypted both using pk_receiver and pk_escrow, where the latter is a public key of an escrow authority that is trusted. This would then be accompanied by a zero-knowledge proof that these two ciphertexts correspond to the same plaintext value (namely pk_receiver) in a manner that does not disclose pk_receiver to the verifier. This can be done using methods disclosed in co-pending Ser. No. 63/322,265 titled “Escrowed Wallet and Transaction Tracking Technology” by Markus Jakobsson and filed on Mar. 22, 2022. Doing so enables this one or more trusted authorities, which may be distributed using threshold-sharing methods, to track any anonymized transfers, whether of fungible or non-fungible tokens. Thus, privacy-enhancing methods can be combined with protective measures to avoid abuse, by means of tracking. The tracking may disclose the public keys of the wallets, and apparent wallets, but may also be used to disclose real-world identities, by associating the apparent wallet addresses with real-world identities, e.g., in a law enforcement database.

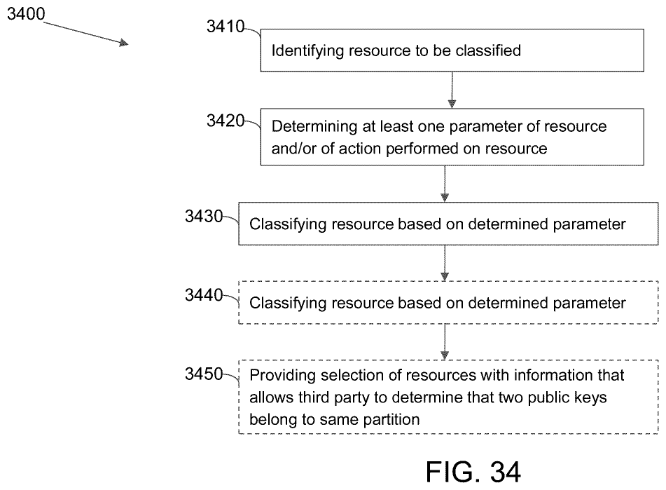

FIG. 34 is a flowchart of an exemplifying embodiment of a method performed by an entity, such as a wallet, for classifying a resource of the wallet, thereby assigning the resource to a partition of the wallet. The wallet comprises at least two partitions, wherein the at least two partitions are associated with at least one respective/individual classification, wherein each individual partition of the wallet is associated with an individual public key. FIG. 34 illustrates the method 3400 comprising a step 3410 of identifying the resource to be classified, and a step 3420 of determining at least one parameter of the resource and/or of an action performed on the resource. The method 3400 is illustrated comprising a step 3430 of classifying the resource based on the determined parameter.

FIG. 34 also illustrates the method 3400 comprising an optional step 3440 of assigning different resources to respective different public keys, and an optional step 3450 of providing a selection of resources with information that allows a third party to determine that two public keys belong to the same partition.

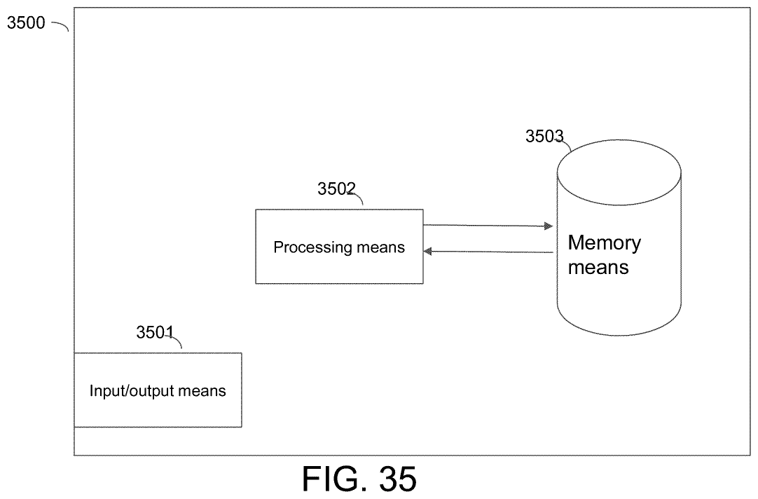

FIG. 35 is a block diagram of an exemplifying embodiment of an entity 3500, such as a wallet, configured for classifying a resource of the wallet, thereby assigning the resource to a partition of the wallet. The wallet comprises at least two partitions, wherein the at least two partitions are associated with at least one respective/individual classification, wherein each individual partition of the wallet is associated with an individual public key. The entity 3500 is illustrated comprising input/output means 3501 by means of which the entity 3500 may receive information and transmit or provide information to other units, devices and/or entities. FIG. 35 also illustrates the entity 3500 comprising processing means 3502 and memory means 3503, the memory means 3503 comprising instructions, which when executed by the processing means 3502 causes the entity 3500 to perform the method described herein. The entity 3500 may for example be a server, a computer, a cloud server or any entity or arrangement comprising processing means for executing the method.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

1. (canceled)

2. A method for displaying configuration data, the method comprising:
generating a path value, wherein the path value is generated using a pseudo-random number generator based at least in part on a seed value;
accessing an address for a storage location based on the path value, wherein accessing the address for the storage location comprises concatenating the path value with a domain value that indicates a storage provider associated with the storage location;
recovering a configuration file from the storage location, wherein:
the configuration file comprises a configuration value; and
the configuration value is specific to an individual user interface configuration; and
applying the individual user interface configuration to a specific user interface.

3. The method of claim 1, wherein the pseudo-random number generator comprises a cryptographic hash function.

4. The method of claim 1, wherein the storage location is a particular digital wallet.

5. The method of claim 4, wherein the address comprises a filename, wherein the filename:
identifies the particular digital wallet as having a specific classification; and
is created independently both of the seed value and of an owner of the particular digital wallet.

6. The method of claim 5, wherein:
the specific classification corresponds to a set of digital wallets that implement a particular digital rights management (DRM) system; and
the particular digital wallet is compatible with all other digital wallets that implement the particular DRM system.

7. The method of claim 6, wherein the set of digital wallets each store an identification list comprising:
a particular storage provider that services each wallet of the set of digital wallets; and
a particular domain value of the particular storage provider that services the each wallet of the set of digital wallets.

8. The method of claim 1, wherein the configuration value comprises:
content associated with the token; and
an access control list associated with the token.

9. The method of claim 8, wherein the configuration value is encrypted, at least in part, based on an encrypting value that is generated from the seed value.

10. The method of claim 1, wherein the configuration file further comprises an identification of at least one of:
a set of hardware that is relevant to the individual user interface configuration;
a set of software that is relevant to the individual user interface configuration; or
a DRM system configuration that is relevant to the individual user interface configuration.

11. The method of claim 1, further comprising generating a new storage instance based on the configuration file, wherein the new storage instance is accessed using the specific user interface.

12. A non-transitory computer-readable medium comprising instructions that, when executed, are configured to cause a processor to perform a process for displaying configuration data, the process comprising:
generating a path value, wherein the path value is generated using a pseudo-random number generator based at least in part on a seed value;
accessing an address for a storage location based on the path value, wherein accessing the address for the storage location comprises concatenating the path value with a domain value that indicates a storage provider associated with the storage location;
recovering a configuration file from the storage location, wherein:
the configuration file comprises a configuration value; and
the configuration value is specific to an individual user interface configuration; and
applying the individual user interface configuration to a specific user interface.

13. The non-transitory computer-readable medium of claim 12, wherein the pseudo-random number generator comprises a cryptographic hash function.

14. The non-transitory computer-readable medium of claim 12, wherein the storage location is a particular digital wallet.

15. The non-transitory computer-readable medium of claim 14, wherein the address comprises a filename, wherein the filename:
identifies the particular digital wallet as having a specific classification; and
is created independently both of the seed value and of an owner of the particular digital wallet.

16. The non-transitory computer-readable medium of claim 15, wherein:
the specific classification corresponds to a set of digital wallets that implement a particular digital rights management (DRM) system; and
the particular digital wallet is compatible with all other digital wallets that implement the particular DRM system.

17. The non-transitory computer-readable medium of claim 16, wherein the set of digital wallets each store an identification list comprising:
a particular storage provider that services each wallet of the set of digital wallets; and
a particular domain value of the particular storage provider that services the each wallet of the set of digital wallets.

18. The non-transitory computer-readable medium of claim 12, wherein the configuration value comprises:
content associated with the token; and
an access control list associated with the token.

19. The non-transitory computer-readable medium of claim 18, wherein the configuration value is encrypted, at least in part, based on an encrypting value that is generated from the seed value.

20. The non-transitory computer-readable medium of claim 12, wherein the configuration file further comprises an identification of at least one of:
a set of hardware that is relevant to the individual user interface configuration;
a set of software that is relevant to the individual user interface configuration; or
a DRM system configuration that is relevant to the individual user interface configuration.

21. The non-transitory computer-readable medium of claim 12, wherein:
the processor is further configured to generate a new storage instance based on the configuration file; and
the new storage instance is accessed using the specific user interface.
